(19) United States
(12) Patent Application Publication
(10) Pub. No.: US 2023/0205503 A1
(43) Pub. Date: Jun. 29, 2023

(54) METHOD FOR DYNAMICALLY INTEGRATING APPLICATION PROGRAMS, AND SOFTWARE SYSTEM AND MACHINE USING THE SAME

(71) Applicant: LIN, Chun-hsiao, New Taipei City (TW)

(72) Inventor: CHUN-HSIAO LIN, New Taipei City (TW)

(21) Appl. No.: 18/008,322

(22) PCT Filed: Jun. 4, 2021
(86) PCT No.: PCT/CN2021/098402

§ 371 Date: Dec. 5, 2022

Related U.S. Application Data
(60) Provisional application No. 63/035,009, filed on Jun. 5, 2020.

(51) Int. Cl. G06F 8/61; G06F 9/445

(52) U.S. Cl. CPC G06F 8/61; G06F 9/445

(57) ABSTRACT

A method for dynamically integrating application programs in a software system is provided. Firstly, an installation module is provided in the software system, and an introducing flow is started when the installation module receives a dynamic installation request from an auto-provisioning engine. Then, an import module is provided in the software system. When the import module receives an executable state from the application program, an operable object bound to the executable state is stored in a management module. When the executable object or the executable state is executed or triggered, a corresponding execution request is issued, and a startup module dynamically loads and runs a corresponding volatile application program to complete the execution request.

### FIELD OF THE INVENTION

The present invention relates to a method for dynamically integrating application programs and a software system and a machine using the method, and more particularly to an effective method for dynamically installing a volatile application program and dynamically loading and running the volatile application program in a software system, dynamically importing an operation process of the volatile application program, and dynamically generating a super app and/or an operating environment of the Internet of Things (IoT) control center without the need of pre-installing or importing the volatile application program in the software system, and also relates to a software system and a machine using the method.

### BACKGROUND OF THE INVENTION

With the development of the computer science, regardless of whether a software platform, an operating system or any kind of software system that can be extended by a program is adopted, software developers have become accustomed to using application programming interfaces (API) and software development kits (SDK) to perform various tasks of system integration. In accordance with a well-known method, software developers have to follow the rules defined by the application programming interfaces and the software development kits to complete the development of various dynamic-link libraries, software components or application programs (App), and then install or import them into a software system. Consequently, during the execution of the software system, the dynamic-link libraries, the software components or the application programs can be loaded to the operating environment that is generated by the software system. In this way, even if the original program of the software system is not changed, the computing services provided by the dynamic-link libraries, the software components or the application programs can be extended to the software system in order to achieve the purpose of system integration.

As for the development of the information technology industry, the application ecology is mainly promoted by two different types of software companies according to the product types. One type of the software companies is a system vendor whose main business is to provide operating systems and/or software platforms, and the other type of the software companies is a service provider whose main business is to provide application programs (App).

The operating system and/or the software platform provided by the “system vendor” is like a portal, and thus users can manage and operate different data and tools through the portal. Take the Android operating system for example. After the Android operating system is previously installed in the mobile phone by the mobile phone supplier, the mobile phone is sold to the user. After the mobile phone is turned on, an operating environment provided by the Android operating system will be projected on the screen. Through the interface of the operating environment, the user can manage and operate the files that are stored in the built-in memory or the memory card and manage and operate the application programs that are installed in the operating environment. WeChat is another typical example. Firstly, the development of WeChat starts from an application program (App) that provides instant messaging services. After the needs of the instant messaging services become popular and the instant messaging services are deeply rooted in the daily life of each user, mini programs start to be introduced. As the instant messaging services are developed towards a software platform, a super app is generated. When WeChat is executed, an operating environment will be projected on the screen. Through the interface of the operating environment, the user can manage and operate the data in the instant messaging service and also manage and operate mini programs that are introduced into the operating environment. The mini program itself is also an application program. The behavior of introducing the mini program into the user's WeChat operating environment can also be regarded as an installation behavior.

The application programs provided by the “service provider” are used as tools, and each application program is used to help users access and operate the computing services in a specific field. For the user, each application program also provides a corresponding operating environment on the screen during the runt time. The operating environment provided by the application program and the operating environments provided by the operating system and the software platform are distinguished. For example, the operating environment provided by the operating system and the software platform is a universal environment, and the operating environment provided by the application program is a limited environment. For the operating system and the software platform, the main design goal is to help users manage, access, drive and operate a variety of different resources in the same operating environment, wherein the resources include a variety of different data and a variety of different application programs (tools). For the application program, the main design goal is to provide the computing service and/or the operation process with a specific purpose in order to meet the specific needs of users.

In the process of promoting the application ecology, the relationship between the system vendor and the service provider is usually a cooperative relationship. The system vendors provide a variety of application programming interfaces and software development kits on operating systems and software platforms. Consequently, the service providers can quickly develop and complete various application programs for specific purposes. Since the service providers in all walks of life develop a large number of application programs for various fields and purposes, the functions of the operating systems and the software platforms can be greatly expanded through the installation of the application programs, and the users can also manage and operate a large number of different materials and tools in the operating systems and/or the software platforms to provide the work efficiency. Consequently, a development cycle of the application ecology is formed.

The vigorous development of the application ecology is a win-win-win result for system vendors, service providers and users. However, the current system integration method has many limitations, and there are still many technical challenges to be overcome.

Firstly, in order to protect users from being attacked by malicious applications, the system vendors give a limitation that the application programs provided by the service providers can only be installed after the user's consent and the user's authorization. The main reason is that the malicious applications after installation can exist in the operating system and/or the software platform for a long time and become resident programs to leak the user data. In other words, this limitation is mainly based on the information security considerations. However, because of this limitation, the service providers lack the service ability to provide auto-provision of application programs for users. In real life and in many different situations, when a service provider releases an application program, the information security considerations can be ignored. For example, a service provider develops an attendance management system for its global employees. After the attendance management system is deployed, the importance of the popularity and the utilization rate of the attendance management system will be much higher than the information security consideration for the information department of the service provider. In the case of technical feasibility, the service provider hopes that the attendance management system can be dynamically installed in the operating environments of the office desktop computers, mobile phones or laptops that are used by its employees worldwide and the auto-provision can be completed as soon as the deployment of the attendance management system is completed. That is, the service provider hopes that an executable object capable of executing the attendance management system can be automatically added to the operating environment used by each employee. In addition, the service provider hopes to actively configure the application state, which is required by each employee to execute the attendance management system, in the executable object, and so that each employee can execute the attendance management system by directly launching the executable object on the user interface. This method is distinguished from the conventional method. In accordance with the conventional method, the information department sends an easily ignored email to each employee's email mailbox. This email is used to notify the employee that the attendance management system is online and ask the employee to install the attendance management system passively.

The executable object refers to an executable entity that can be installed in an operating system and/or a software platform. The executable object is generated according to a data model of an application program unit. After the executable object is installed in the operating system and/or the software platform, the executable object will become an executable entity compatible with the operating system and/or the software platform. The operating system and/or the software platform can effectively recognize that the executable entity as an application program (App). Therefore, the operating system and/or the software platform can provide the executable entity with a process management mechanism, a memory management mechanism, a storage management mechanism and any authorization management mechanism that is designed for the application program (App) resources.

According to the operating mode, application programs can be divided into two different types. One type can be regarded as a non-volatile application program. The other type can be regarded as a volatile application program.

In accordance with the operating mode of a non-volatile application program, the executable program block of the application program is completely stored in the storage space corresponding to the operating system and/or the software platform. When the operating system and/or the software platform needs to execute the application program, the executable program block of the application program (i.e., the startup program of the non-volatile application program) is directly loaded from the corresponding storage space of the operating system and/or the software platform to an OS process and executed in the OS process. After the execution is completed, the executable program block of the application program is continuously stored in the storage space. For example, the non-volatile application program is represented by a native application, and the startup program is its related executable program block.

In accordance with the operation mode of the volatile application program, the executable program block of the application program is stored in an external machine. The external machine and the machine running the operating system and/or the software platform are different machines. When the operating system and/or the software platform needs to execute the application program, the executable program block of the application program (i.e., the startup program of the volatile application program) is loaded from the external machine to an OS process and executed in the OS process. After the execution is completed, the executable program block of the application program will be directly eliminated with the end of the OS process. In a preferred embodiment, a portion of the executable program block of the application program will be temporarily stored in a cache in order to be used to improve the dynamic loading efficiency during the next execution. For example, the volatile application program is represented by a Web front-end application, a progressive web application or an instant application (Instant App), and the startup program is its related executable program block.

For the operating system and/or the software platform, volatile application programs are much more secure than non-volatile application programs. The main reason is that the volatile application program does not need to store a complete executable program block in the storage space of the operating system and/or the software platform. In other words, the volatile application program is not easy to run in the system background secretly. However, although the volatile application program essentially reduces the information security concerns, there are still some drawbacks. For example, since the executable program block of the volatile application program is mainly deployed in the external machine and unable to be installed in the operating environment of each employee, it is difficult to effectively implement the auto-provision of the volatile application programs.

The Web front-end application, the progressive web application and the instant application (Instant App) are examples of the “volatile application programs” which are described in this context.

For the Web front-end application, the operating environment of any operating system and/or software platform can dynamically load and run the Web front-end application through a browser or a WebView. However, the service provider cannot dynamically install an executable object in the operating environment for the Web front-end application in order for the user to operate.

Moreover, the instant application (Instant App) is a volatile application program that is developed according to the technical framework of a native application. For example, the Android Instant App is an implementation example of the instant application. Each Android instant application corresponds to a network address. After the service provider shares the network address to the user's Android operating environment, the Android instant application can be dynamically loaded to run in the Android operating environment by clicking the network address. However, like the Web front-end application, the service provider cannot dynamically install an executable object for the Android instant application in the Android operating environment for the user to operate. The technical contents of the Android Instant App can be referred to the webpage at https://heartbeat.fritz.ai/create-an-instant-app-using-android-app-bundle-e36d321dcd56.

The progressive web application (Progressive Web App) is another implementation example of the volatile application program. The progressive web application itself is also a Web front-end application. Under the joint support of the operating system and the browser, a progressive web application can be installed in the operating environment of the operating system through the browser or an online application store with the user's consent, and an executable object is provided in the operating environment for the user to operate. However, in the existing architecture of the progressive web application, its dynamic installation can only passively rely on the execution of a third-party software. In accordance with one method, after the user dynamically loads and runs a progressive web application through a browser (i.e., a third-party software) in the operating environment of an operating system, the browser provides an executable object for the progressive web application and installs the executable object in the operating environment of the operating system. In accordance with another method, after the user searches the progressive web application through the online application store, the executable object of the progressive web application is downloaded from the online application store and installed in the operating environment of the operating system. In case that the user does not launch or search the progressive web application through the browser or online application store, the service provider cannot actively and dynamically install the progressive web application into the operating system through any method. That is, the service provider is unable to provide an executable object to the operating environment of the operating system for the progressive web application. Furthermore, it is impossible to actively provision the customized application state in the executable object. The technical contents of the progressive web application can be referred to the webpage at https://vaadin.com/learn/tutorials/learn-pwa/turn-web site-into-a-pwa.

The lack of an automatic dynamic installation method makes it difficult for the service provider to independently control the release of volatile application program. Moreover, the lack of an automatic dynamic installation method also makes it impossible to implement the auto-provision of the volatile application program.

In the technical field of the application ecology, there is no existing method for dynamically installing the volatile application program and no software system using the method. That is, there is no effective method and no software system using the method to automatically provision the volatile application program in an operating system and/or a software platform. Therefore, there is a need of providing the method and the software system.

Secondly, the operating environment of the system vendor and the application program of the service provider, in the system integration of most operation processes, can only be independently developed. The operation process of the application program cannot be dynamically imported into the operating environment of the operating system and/or the software platform. In addition, the operating environment of the operating system and/or the software platform cannot be effectively implemented as a driving environment of an application state engine. Consequently, each service provider has to repeatedly develop many identical or equal management tools for the same or similar operation process in the application program that is provided by the service provider. In addition, each user has to be forced to operate the same or equal operation process in different application programs. Furthermore, this also makes the data collection difficult to be implemented effectively. The main reason is that even if the user operates the same or equal operation process, the data generated is scattered in different application programs and cannot be gathered in a unified operating environment.

For example, with the development of the internet, the huge demand for internet calls has stimulated the development of a large number of network communication software applications. However, for each call service, there is at least a basic but common operation process. That is, when a voice call is received, the user can first answer the voice call; and when the voice call ends, the user can use the call log of the voice call to call back the caller of the voice call. For those who are familiar with this technology, in order to realize the operation process, each network communication software application needs to have the design of “having the ability to answer the incoming call”, “having the ability to generate the call log” and “having the ability to call back via the call log”, and each has to design a management tool for storing, managing and operating the call logs. Consequently, the operation process can be realized. However, under this circumstance, even if the network communication software applications are installed in the same mobile phone operating environment, users often need to enter various network communication software applications to find the corresponding call logs to call back. Moreover, the network communication software application is also an implementation example of an application program.

In the operating environment of the modern smart phone operating system, a built-in management tool is used for storing, managing and operating call logs. Moreover, in the user interface of the management tool, a callback design has been provided for the user interface of each call log. However, since the operating environment of the mobile phone and the application program are separated for the system integration of the operation process, the management tool can only manage the call logs generated by the telecommunications network or the SIP network, and the operation process of each third-party call service cannot be imported into the management tool. Especially, when the third-party call service itself is a volatile application program, or the third-party call service has not been integrated with the operating environment in any form for the callback function, or even the third-party call service is basically completed by a customized communication protocol, some problems occur. For example, in case that any form of integration has not been made, the communication protocols are incompatible and/or the third-party communication service is a volatile application program, the operation process of the third-party communication service cannot be dynamically imported into the operating environment of the mobile phone.

In the technical field of the application ecology, there is no existing method for dynamically importing the operation process and no software system using the method. That is, there is no effective method and no software system for allowing an operation process of an application program to be dynamically imported into an operating system and/or a software platform and allowing the operating system and/or the software platform to become the driving environment of an application state engine. Therefore, there is a need of providing the method and the software system.

Various technical challenges of the application ecology have been introduced as above. These technical challenges also affect the development of different technical fields. Take the Internet of Things (IoT) for example. As the technical development of the Internet of Things is fueled by the market, different companies, organizations and institutions have formulated many different standards. However, the only thing lacking is that no standard is a truly unified standard. Consequently, the completion of the overall application ecology of the Internet of Things has to rely on a large amount of system integration. Different types of connected devices have different software controllers. Even if the connected devices have the same nature, the technical architectures of software controllers may be different because the device providers are different. In order to allow users to manage and monitor the corresponding connected devices, some software controllers are developed based on the technical framework of native applications, and some software controllers are provided to users in the form of Web front-end applications. However, due to non-unified standards, different connected devices, different device providers and different technical frameworks of the applications, the software controllers have many different types and all bring challenges to the work of the system integration. Consequently, even if the Internet of Things has been developed until now, users are still unable to complete the provision task of the software controllers on the same operating system and/or software platform for the IoT devices that are provided by different manufacturers in the surrounding complex environment and have different technical architectures.

For example, a user is in a certain environment, and all connected devices in the environment are designed by the same device provider. Generally, the user can quickly complete the provision of the connected devices in the surrounding environment through the management platform of the device provider. However, if the connected devices in the environment are designed by different device providers and the integration is completed through different technical standards, the user has to use the management platforms provided by different device providers in his (her) mobile phone or computer to complete all provision tasks. Even if the connected devices have the same nature, the managing task, the monitoring task and/or the task of driving the operation process are dispersed in different management platforms because the device providers are different.

The IoT device providers cannot provide effective dynamic installation and/or auto-provision services for the software controllers in the operating system and/or software platform that is provided by the system vendor. The operation processes of the same nature cannot be dynamically imported into the same operating environment. This is a major challenge for the IoT application ecology in the development of super apps and/or IoT control centers.

From the above descriptions, in the technical field of the application ecology, it is the direction of development for system vendors, service providers and users to continuously construct perfect application programming interfaces and software development kits. More importantly, there is no method for dynamically integrating an application program and no software system using the method. That is, there is a need of providing a method for dynamically installing a volatile application program and dynamically loading and running the volatile application program in a software system, dynamically importing an operation process of the volatile application program, and dynamically generating a super app and/or an operating environment of the Internet of Things control center without the need of pre-installing or importing the volatile application program in the software system, and also providing a software system using the method.

### SUMMARY OF THE INVENTION

An object of the present invention provides a method for dynamically integrating application programs and a software system and a machine using the method. The software system and/or the machine can dynamically install the volatile application program, dynamically load and run the volatile application program, dynamically import an operation process of the volatile application program, and dynamically generate a super app and/or an operating environment of the Internet of Things control center without the need of pre-installing or importing the volatile application program in the software system and/or the machine.

In an embodiment, the present invention provides a method for dynamically installing a volatile application program in a software system. Firstly, an installation module is provided in the software system. When the installation module receives a dynamic installation request from an auto-provisioning engine, an introducing flow is started. During the operation of the introducing flow, an executable object for a user to execute is installed in the software system. There is a binding relationship between the executable object and the volatile application program. The binding relationship is established by binding a metadata of the volatile application program and/or an access link of the metadata to the executable object. When the software system receives an execution request for the executable object from the user, the volatile application program is dynamically loaded to run in the software system. Moreover, a location of a startup program of the volatile application program is identified (located) according to at least one content of the metadata.

In an embodiment, the volatile application program is a Web system, a native application or any software service that can be dynamically loaded to run. The dynamic loading and running operation of the volatile application program is completed by dynamically loading and running a startup program of the volatile application program.

In an embodiment, the at least one content of the metadata of the volatile application program contains a network address and a content of the network address contains the location of the startup program of the volatile application program, and/or the at least one content of the metadata of the volatile application program contains at least one code that is used to identify (locate) the location of the startup program of the volatile application program.

In an embodiment, a content of the dynamic installation request contains the executable object, an access link of the executable object, the metadata and/or the access link of the metadata. Moreover, the access link of the executable object and the access link of the metadata are in a form of a uniform resource identifier or an application programming interface.

In an embodiment, the executable object is a pre-generated executable object, or the executable object is an executable object dynamically generated during the run time of the software system and the installation module.

In an embodiment, the dynamic installation request is issued by the auto-provisioning engine to drive the installation module to complete an auto-provision task for the volatile application program. Moreover, the auto-provisioning engine is a network service, a detection program, an application program, or a projected workspace. The network service is an external network service running on a different machine from the software system. The detection program is a software module executed in the software system. The application program is a volatile application program required to be dynamically loaded to run in the software system. The projected workspace is a projectable workspace that is dynamically loaded to run in the software system.

In an embodiment, a bound content related to the executable object contains an original content of the metadata, a partial content of the metadata or a content that is obtained after the original content of the metadata is rearranged. Moreover, the binding relationship is established by binding the bound content and/or an access link of the bound content to the executable object. In the binding relationship, the bound content represents a data reference of the metadata.

In an embodiment, the executable object is generated according to a data model of an application program unit. After the executable object is installed in the software system, the executable object becomes an executable entity compatible with the software system. During the runt time of the software system, the executable entity is displayed on a user interface for the user to launch. When the user launches the executable entity, the execution request is triggered, so that the volatile application program corresponding to the executable entity is dynamically loaded to run.

In an embodiment, a content of the execution request contains the bound content and/or the access link of the bound content, and the volatile application program is dynamically loaded to run through a startup module according to the content of the execution request. The startup module is an independently running application program or a software component that can dynamically load and run a heterogeneous system.

In an embodiment, if the volatile application program is incompatible with an operating environment of the software system, the volatile application program is driven by an adapter. The adapter provides an interface implementation compatible with the operating environment of the software system. The adapter is provided by the executable object, the startup module, the software system and/or another software module that is triggered and executed by the startup module.

In an embodiment, when the volatile application program is dynamically loaded to run, a state setting is transmitted to the volatile application program in a form of a parameter. The volatile application program adjusts the internal application state according to the state setting during the run time. The state setting is a system environment configuration, an application configuration and/or a customized application state.

In accordance with another aspect of the present invention, a method of dynamically importing an operation process in a software system is provided. The method includes the following steps:
(a) providing a startup module in the software system, and executing an application program according to a content of an execution request when the startup module receives the execution request, wherein the application program is a native application installed in the software system, or the application program is a volatile application program required to be dynamically loaded to run;
(b) providing an import module in the software system, and starting a dynamic importing flow when the import module receives an executable state from the application program, wherein during an operation of the dynamic importing flow, an operable object for a user to operate is stored in a management module, and a binding relationship between the executable state and an executable event of the operable object is established; and
(c) when the executable event is triggered by the user, an additional execution request for executing the executable state is issued, and a corresponding volatile application program is dynamically loaded to run, so that the executable state is executed by the corresponding volatile application program.

In an embodiment, if the application program is a volatile application program, at least one content of a metadata of the volatile application program contains a network address and a content of the network address contains a location of a startup program of the volatile application program, and/or the at least one content of the metadata of the volatile application program contains at least one code that is used to identify (locate) the location of the startup program of the volatile application program.

In an embodiment, if the execution request is issued when an executable object is launched, the application program is a volatile application program.

In an embodiment, if the execution request is issued when an executable state is execution, the application program is a volatile application program. Moreover, a content of the execution request is generated according to a content of the executable state. The content of the executable state contains a bound content and/or an access link of the bound content. The bound content contains an original content of a metadata of the volatile application program, a partial content of the metadata or a content that is obtained after the original content of the metadata is rearranged. Moreover, the startup module identifies (locates) the location of the startup program of the volatile application program according to the content of the execution request and dynamically loads and runs the volatile application program according to the location of the startup program.

In an embodiment, the operable object is generated according to a data model of an information unit. After the operable object is stored in the management module, the operable object becomes an operable entity that is compatible with the software system or at least one software module in the software system. During the run time of the software system or the at least one software module, the operable entity is displayed on a user interface for the user to operate. When the user triggers the executable event that is bound to the executable state, the corresponding volatile application program is dynamically loaded to run. The import module dynamically imports the operation process by importing at least one executable state.

In an embodiment, the binding relationship between the executable state and the executable event is established by binding at least one content of the executable state to the operable object or executable event. When the executable event is triggered, the additional execution request is issued according to the content of the executable state, so that the corresponding volatile application program is dynamically loaded to execute the executable state. The executable event is dynamically added to the operable entity according to at least one information of the executable state.

In an embodiment, when the corresponding volatile application program is dynamically loaded to run, a state setting is transmitted to the corresponding volatile application program in a form of a parameter. The corresponding volatile application program adjusts the internal application state according to the state setting during the run time. The state setting is a system environment configuration, an application configuration and/or a customized application state.

In accordance with another aspect of the present invention, a software system is provided. The software system uses a method of dynamically integrating application programs to allow volatile application programs from plural different information sources and operation processes supported by the volatile application programs from plural different information sources to be dynamically installed and dynamically imported in the software system. The software system comprises:

an installation module, wherein when the installation module receives a dynamic installation request from an auto-provisioning engine, an executable object is installed in the software system; and/or

an import module, wherein when the import module receives an executable state from an application program, an operable object bound to the executable state is stored in a management module,

wherein when the executable object or the executable state is executed or triggered, a corresponding execution request is issued to a startup module, and the startup module dynamically loads and runs a corresponding volatile application program to complete the execution request.

In an embodiment, volatile application programs from plural different information sources are dynamically installed in the software system through the installation module. Moreover, the volatile application programs are dynamically installed through a process of installing at least one executable object.

The application program is a volatile application program required to be dynamically loaded to run.

In an embodiment, different operation processes supported by at least one volatile application program are dynamically imported into the software system through the import module. Moreover, the different operation processes are dynamically imported through a process of importing at least one executable state.

In accordance with another aspect of the present invention, a machine for dynamically integrating application programs is provided. The machine comprises:

an auto-provisioning engine for detecting at least one connected device in a network, and allowing at least one executable object corresponding to the at least one connected device to be deployed to a software system, wherein the software system displays the at least one executable object on a user interface for the user to operate, wherein when the user launches an executable object corresponding to a connected device on the user interface, a volatile application program bound to the executable object is dynamically loaded to run, and the volatile application program provides services for managing, operating, monitoring and/or controlling the connected device; and/or

an import module for receiving an executable state from an application program, and allowing an operable object bound to the executable state to be stored in a management module, wherein the import module is used to dynamically import an operation process for at least one application program.

In an embodiment, the connected device is an Internet of Things (IoT) device, a commercial software application and/or any hardware appliance or software appliance with capabilities of providing information services.

In an embodiment, there is a binding relationship between the connected device and the executable object, and the binding relationship is established by binding at least one content of a metadata of the connected device to the executable object. The at least one content of the metadata of the connected device contains a product name, a brand name, a domain name and/or an IP address of the connected device.

In an embodiment, there is a binding relationship between the volatile application program and the executable object, and the binding relationship is established by binding at least one content of a metadata of the volatile application program to the executable object. The at least one content of the metadata of the volatile application program contains an APP name, an APP icon, a function description, a location of the startup program, a domain name and/or a provider information of the volatile application program.

In an embodiment, the volatile application program is a software controller in the connected device. The volatile application program is dynamically installed through a process of installing the executable object.

In an embodiment, the operation process is dynamically imported through a process of importing at least one executable state.

In an embodiment, the machine is a user device, and the software system runs on the user device.

In an embodiment, the volatile application program is a software controller in the connected device. After the software controller is dynamically loaded to run in the user device, at least one control instruction of the software controller for the connected device is directly transmitted from the user device to the connected device.

In an embodiment, the machine is a server, the software system runs on a user device, and the software system has ability to connect to the server and send instructions or requests to the server.

In an embodiment, the volatile application program is a software controller in the connected device. After the software controller is dynamically loaded to run in the user device, at least one control instruction for the connected device is transmitted to the server and then the at least one control instruction is forwarded by the server to the connected device according to a communication protocol compatible with the connected device, or the at least one control instruction is directly transmitted from the user device to the connected device.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the structure of a metadata of a volatile application program;

FIG. 2 is a diagram illustrating the operating concept of dynamically loading and running a volatile application program;

FIG. 3 schematically illustrates a basic operation process of a startup module;

FIG. 4 schematically illustrates the operating concept of a startup module;

FIG. 5 schematically illustrates a basic operation process of an executable object and an operable object;

FIG. 6 schematically illustrates the structure of an executable state of a volatile application program;

FIG. 7 schematically illustrates the binding relationship between the metadata/executable state of a volatile application program and an executable object and an operable object;

FIG. 8 schematically illustrates the operating concepts of an executable object and an operable object;

FIG. 9 schematically illustrates the operating concept of a metadata conversion program;

FIG. 10 is a flowchart illustrating a method for dynamically installing a volatile application program in a software system;

FIG. 11 schematically illustrates a resource allocation diagram of a volatile application program;

FIG. 12 schematically illustrates the operating concept of the path of a dynamic installation process of a volatile application program;

FIG. 13 schematically illustrates the network configuration for dynamically installing a volatile application program;

FIG. 14 is a flowchart of a method of dynamically importing an operation process in a software system according to an embodiment of the present invention;

FIG. 15 is a flowchart of an operation process of a voice communication according to an embodiment of the present invention;

FIG. 16 schematically illustrates the concept of the operating path of a dynamic importing process of an operation process according to an embodiment of the present invention;

FIG. 17 schematically illustrates an operating concept of a software system for dynamically integrating the volatile application program according to an embodiment of the present invention;

FIG. 18 schematically illustrates the operating concept of a machine for dynamically integrating the software controllers of different connected devices according to an embodiment of the present invention; and

FIG. 19 schematically illustrates the operating concept of the path of dynamically importing an executable state of a connected device according to an embodiment of the present invention.

### DETAILED DESCRIPTION OF THE PREFERRED EMBODIMENT

The present invention is more fully appreciated by reference to the following description, including the following glossary of terms and the concluding examples. For the sake of brevity, the disclosures of the publications, including patents, cited in this specification are herein incorporated by reference.

The following embodiments of the present invention are non-limiting embodiments, and only represent various aspects and features of the present invention. In the most restrictive technical sense, the term “volatile application program” used herein is also an application program, which includes a Web front-end application, a progressive web application, an instant application (Instant App), or any software service that can be dynamically loaded to run. Moreover, the term “software system” used herein includes a software platform, an operating system or any software system that can be extended by programs. Moreover, the term “software module” used herein includes a class library, an object entity, a software component, a software agent, an application program or any program block that can be built, installed, introduced, generated, expanded and/or dynamically loaded to run in the software system. Moreover, the term “metadata of the volatile application program” used herein includes an object entity that is generated by using a markup language and/or generated according to a structured protocol, and the markup language and/or the structured protocol is used to describe at least one attribute of a volatile application program. The at least one attribute contains the APP name, the APP icon, the function description, location of the startup program, the domain name and/or the provider information of the volatile application program. The object entity includes an HTTP Header, a JSON object entity, an XML object entity, or an XML file. It is noted that the examples of the volatile application program, the software system, the software module and the metadata of the volatile application program are not restricted.

In this context, the term “connected device” includes an Internet of Things (IoT) device, a commercial software application, a virtual appliance and/or any hardware appliance or software appliance with capabilities of providing information services. The associated technical contents of the IoT device can be referred to the webpage at https://www.arm.com/glossary/iot-devices. The associated technical contents of the software appliance can be referred to the webpage at https://en.wikipedia.org/wiki/Software_appliance. In this context, the term “volatile application program” indicates a software service that can be dynamically loaded to run through a network address. The software service can be a software service that is not integrated with the external system and is able to operate independently. The software service can also be a software service for managing, operating, monitoring and/or controlling the service of a connected device, a network communication system or a workflow management system, but it is not limited thereto. The software service is deployed, stored or published in an external server. The external server can be a Web server, a cloud storage server, an online application store server, or any other appropriate computing device, IoT device or software appliance with the networking capabilities. The external server and the machines for running the “software system” and the “software module” described herein are different computing devices. Before the volatile application program is dynamically installed and dynamically loaded, it is not necessary to pre-install or import the startup program of the volatile application program to the machine running the “software system” and the “software module” described herein. Moreover, in case that the services of the volatile application program need to be executed, after the volatile application program is dynamically loaded to run from the external server through the network address, the services that are provided by the volatile application program can be operated. For increasing the dynamic loading efficiency, the volatile application program can be stored in a cache. In the subsequent dynamic loading process, the volatile application program can be dynamically loaded from the storage medium of the cache, so that the dynamic loading efficiency is enhanced. The associated technical contents of the cache design can be referred to the webpage at https://en.wikipedia.org/wiki/Cache_(computing). The startup program of the volatile application program is its executable program block. In this context, the task of “dynamically loading and running a volatile application program” denotes the task of “dynamically loading and running the executable program block of the volatile application program and launching the executable program block to execute the volatile application program”.

In this context, the term “executable object” denotes an executable entity that can be installed in a software system. The executable object is generated according to a data model of an application program unit that is supported by the software system. After the executable object is installed in the software system, the executable object will become an executable entity compatible with the software system. The software system can effectively recognize the resource type of the executable entity according to the data model of the application program unit. Consequently, the executable entity can be recognized as an application program (App), and associated management system for it can be provided. For example, the software system will provide the executable entity with a process management mechanism, a memory management mechanism, a storage management mechanism and/or any kind of resource management mechanism that is designed for application programs (App). During the runt time of the software system, the executable entity is displayed on the user interface in a form of an application program (App) for the user to launch. When the user launches the executable entity, a volatile application program corresponding to the executable entity is dynamically loaded to run. In case that the volatile application program is incompatible with an operating environment of the software system, the volatile application program is driven through an adapter in response to the execution of the executable entity. The data model of the application program unit is a general data model, wherein the general data model can be applied to controllers of connected devices, portals of network communication activities, a client software of a cloud services, or any software application that provides computing services. The executable object is an App configuration file, an App configuration object, or an App executable that can be installed in the software system. The executable entity is an executable unit that is generated on the user interface by the software system according to the content of the executable object after the executable object is loaded. It is noted that the example of the executable object is not restricted.

In this context, the term “operable object” is an operable entity that can be stored to a management module. The management module is a software module in a software system. The operable object is generated according to a data model of an information unit that is supported by the management module. After the operable object is stored in the management module, the operable object becomes an operable entity that is compatible with the software system or at least one software module in the software system. During the runt time of the software system or the at least one software module, the operable entity is displayed on a user interface for the user to operate. When the user triggers an executable event of the operable object, the executable state bound to the executable event is driven. Consequently, a volatile application program corresponding to the executable state is dynamically loaded to run. In case that the volatile application program is incompatible with an operating environment of the software system, the volatile application program is driven through an adapter in response to the execution of the executable state. The information unit is a call log of a network communication activity, a monitoring record of a connected device, an activity reservation of a cloud service, or any information unit used to save the state of an operation process. The executable state is bound to the operable object in the form of an Event configuration file or an Event configuration object. The operable object is an information unit that can be stored to the management module. The operable entity is an operable unit that is generated on the user interface by the software system or at least one software module in the software system according to the content of the operable object after the operable object is loaded. It is noted that the example of the operable object is not restricted.

In this context, the term “OS process” used herein indicates the process that is used for loading, driving, starting and/or executing a program by the operating system. The associated technical contents of the OS process can be referred to the webpage at “https://en.wikipedia.org/wiki/Process_(computing)”.

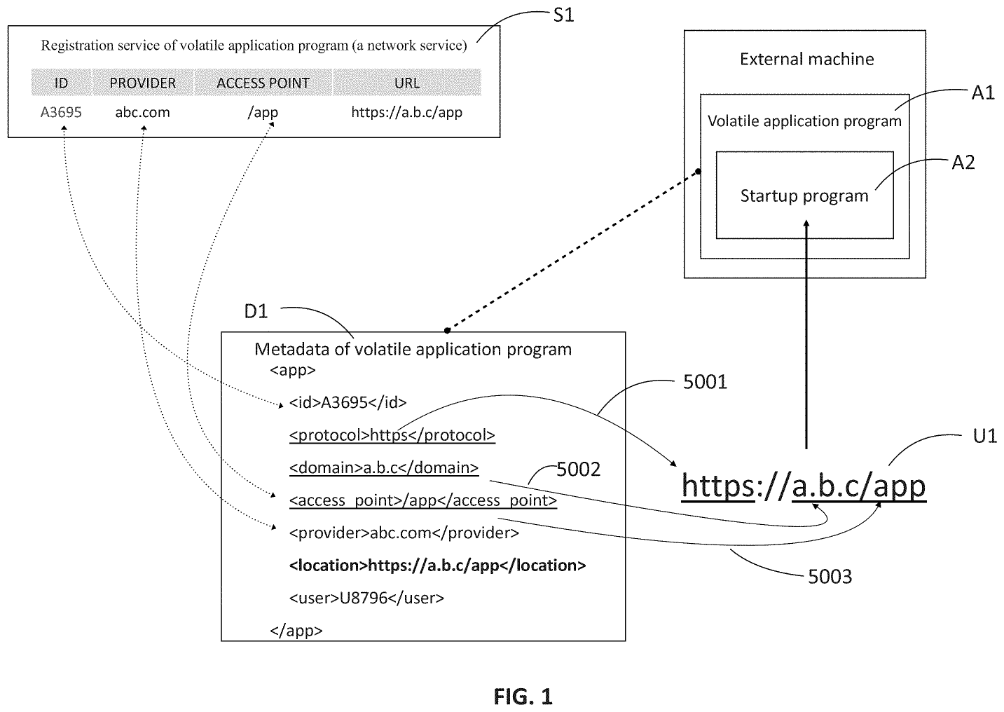

FIG. 1 schematically illustrates the structure of a metadata of a volatile application program. For example, a volatile application program A1 is deployed in an external machine. According to a structured protocol, the basic attributes of the volatile application program A1 can be combined and generated as a metadata D1. The structured protocol is a data structure defined by an XML markup language. The metadata D1 is an XML object entity that is generated based on the data structure. The structured protocol defines five basic attributes for “volatile application programs”. These five basic attributes include a communication protocol <protocol>, a domain <domain>, an access point <access_point>, a provider <provider> and a location <location> of a startup program A2 of the volatile application program A1. As shown in FIG. 1, the communication protocol of the volatile application program A1 is “https”, the domain is “a.b.c”, the access point is “/app”, and the location of the startup program A2 is “https://a.b.c/app”. In accordance with the function of the metadata D1, when any software module receives the content of the metadata D1, the content of the metadata D1 can be read according to the specifications of the structured protocol, and the network address for dynamically loading and running the volatile application program A1 can be identified (located) according to the content of the metadata D1. In this embodiment, the network address U1 is “https://a.b.c/app”, i.e., the location of the startup program A2 in the internet.

It is noted that the above method of using the XML data structure as the structured protocol of the metadata is only a non-limiting example of the present invention. The method of defining the data structure for the content of the metadata is not restricted. That is, those skilled in the art can make any equal design changes based on actual application requirements.

When a software module receives the metadata content of a volatile application program, some following different methods can be adopted to determine (locate) the network address that can be used to dynamically load and run the volatile application program.

Firstly, if the metadata content contains the <location> attribute, the network address U1 can be directly identified (located) according to the content of the <location> attribute because the content of the <location> attribute itself points to the network address that can be used to dynamically load and run the volatile application program.

Secondly, if the <location> attribute is not filled in the metadata content, the software module can assemble the network address for loading and running the volatile application program according to the contents of the <protocol>, <domain> and <access_point> attributes in the metadata. The contents including <protocol>, <domain> and <access_point> are all codes that can be used to assemble the network address. Take the metadata D1 as shown in FIG. 1 for example. By using the assembling method as shown in FIG. 1, the network address U1 that can be used to dynamically load and run the volatile application program A1 can be identified (located). That is, the content of <protocol> is the composition 5001 of the communication protocol in the network address U1, the content of <domain> is the composition 5002 of the domain in the network address U1, and the content of <access_point> is the composition 5003 of the resource access point in the network address U1. It is noted that the example of the assembling method is not restricted. In addition, those skilled in the art can make any equal design changes based on actual application requirements.

Thirdly, if the contents of the metadata contain only the identification code <id> and/or the attribute contents of the provider <provider> and the access point <access_point>, at least one of the contents can be used as at least one code of a query parameter. That is, the combination of the at least one code can be used to perform a query operation. The query operation can be used to determine (locate) the network address that can be used to dynamically load and run the volatile application program. For example, please refer to FIG. 1. In a network server that provides global public uses, a registration service S1 for registering the volatile application program is provided. The network addresses of the volatile application programs provided by different service providers can be registered in the registration service S1 by the service providers. When a service provider registers a volatile application program, it is necessary to provide the data that at least contains the name of the service provider, the name of the access point of the volatile application program and the network address for dynamically loading and running the volatile application program. After the registration is completed, the registration service S1 will provide an identification code <id> for the volatile application program. The registration service S1 provides an application programming interface (API). In addition, any software module can query the registration service S1 through the API. During the querying process, only the identification code <id> and/or the name of the service provider and the name of the access point of the volatile application program need to be transmitted. After the query operation is completed, the registration service S1 will return the network address of the volatile application program to the software module that issues the query request. The registration service S1 is implemented by a HTTP server or any kind of server that can be used for resource registration. With the support of the registration service S1, the identification code <id>, and/or the name of the service provider <provider> and the name of the access point <access_point> of the volatile application program can be used to as codes for querying the registration service S1. When the software module reads the identification code <id> and/or the attribute contents of the provider <provider> and the access point <access_point> from the content of the metadata D1, the software module can determine (locate) the network address U1 that can be used to dynamically load and run the volatile application program A1 through the query to the registration service S1.

Fourthly, if the metadata content contains a REST URL provided by the registration service S1, the REST URL is an application programming interface for returning the network address U1. Consequently, it means that the software module can submit an HTTP GET request to the REST URL to get the network address U1 for dynamically loading and running the volatile application program A1 from the response of the registration service S1. It is known by those skilled in the art that the REST URL is also an implementation example of a unified resource identifier and regarded as a REST API for performing a resource reading operation.

It is noted that the above method of determining (locating) the network address of the volatile application program according to the content of the metadata is only a non-limiting example of the present invention. The method of identifying (locating) the network address of the volatile application program according to the content of the metadata is not restricted. That is, those skilled in the art can make any equal design changes based on actual application requirements.

In an embodiment, a service provider of a volatile application program can store the metadata of the volatile application program in a file system or a database system that is connected to an HTTP Server. In addition, the HTTP Server provides an access link for the metadata in the form of URI (Uniform Resource Identifier). When a software program issues a HTTP GET request to the access link, the HTTP server uses the content of the metadata as the response data. Consequently, any software program can read the metadata via the access link. Take FIG. 1 for example. When the service provider of the volatile application program A1 registers the network address of the volatile application program A1 in the registration service S1, the service provider of the volatile application program A1 can also register the metadata D1 of the volatile application program A1 in the registration service S1. In addition, registration service S1 provides the metadata D1 with an access link “https://volatile.apps/A3695” for reading the metadata D1, wherein “volatile.apps” is the domain of the registration service S1 in the access link, and “A3695” is an identification code provided by the registration service S1 for the volatile application program A1. The access link has the following benefits. When the service provider publishes and/or transmits the metadata D1, it is not necessary to directly publish and/or transmit the complete content of the metadata D1. Instead, it is only necessary to publish and/or transmit the access link. After receiving the access link, any software module can read the complete content of the metadata D1 of the volatile application program A1 from the registration service S1 through the access link.

It is noted that the above methods of publishing and/or transmitting the metadata of the volatile application program via the access link are only non-limiting examples. The implementation examples of the access link are not restricted. The technical methods of publishing a data in a form of a resource to the internet and providing the access mechanism of the resource via a URI (uniform resource identifier) and/or API (application programming interface) (e.g., REST API or Web Server) are very popular. That is, those skilled in the art can make any equal design changes based on actual application requirements.

Different types of software systems use different methods to dynamically load and run a volatile application program according to their different technical architectures. For example, a Web software platform that uses Web front-end technology to implement its operating environment, in its operating environment, can dynamically load and run a volatile application program published from an external domain through an HTML5 inline frame (iFrame), e.g., the Web front-end application and/or the progressive web application. A software platform that uses the Android application technology to implement its operating environment, in its operating environment, can dynamically load and run a Web front-end application, a progressive web application or an Android instant application through a WebView, a browser or an Instant App driver. Different types of software systems may have similarities and differences in their support for the user interface, the application programming interface and/or the application binary interface. Generally, the service providers usually provide different compatible versions of volatile application programs for a software service. Consequently, the software service can be dynamically loaded to run in all different types of software systems.

Please refer to FIG. 1 again. In an embodiment, the service provider of the volatile application program A1 can provide various compatible versions of the volatile application program for the software services of the volatile application program A1 in different machines and/or different domains of the network according to different types of browsers, software platforms or operating systems. Each version is pointed to by its own network address. Under this circumstance, the network address that is published by the service provider of the volatile application program A1 for dynamically loading and running the volatile application program A1 via the metadata D1 can be a network address pointing to a proxy server. When the software service of the volatile application program A1 needs to be dynamically loaded into a software system, the software system will trigger a browser, a WebView or an instant application driver to submit an access request for the network address (e.g., a HTTP GET request containing information related to the software system) to the proxy server in order to dynamically load the executable program block (i.e., the startup program of the volatile application program) that is pointed by the network address. When the proxy server receives the access request, the proxy server can decide whether to redirect to another network address according to the information contained in the access request (e.g., the information related to the software system). For example, the network address of the most compatible volatile application is pointed. Consequently, the most compatible volatile application program can be dynamically load to run. If the volatile application program pointed by the network address is already the most compatible version, the network address does not need to be redirected.

In another embodiment, the startup program A2 of the volatile application program A1 can also be published in different machines on the network according to the load balancing requirements. That is, the executable program block of the same version is published in different machines and pointed by different network addresses. The network address is determined (located) according to the content of the metadata D1 firstly points to a proxy server, and then the proxy server determines which network address (another network address) should be redirected according to the realized load information. Consequently, the startup program A2 of the volatile application program A1 can be loaded to run via another network address, and the associated service can be provided by the machine with a lower load. If the service corresponding to the network address has been provided by the machine with a low load, the network address does not need to be redirected.

In another embodiment, regardless of the network address identified (located) according to the metadata D1 or another network address redirected by the proxy server, the startup program A2 of the volatile application program A1 can be stored in a storage medium as a cache during the dynamic loading process. In addition, the cache corresponds to the network address and/or another network address used to dynamically load the startup program A2. Consequently, the dynamic loading efficiency of the volatile application program A1 is increased. In the subsequent dynamic loading process, the startup program A2 of the volatile application program A1 can be dynamically loaded from the cache, so that the dynamic loading efficiency is enhanced. The methods of increasing the dynamic loading efficiency of the volatile application program from various caches (including local cache, remote cache and/or distributed cache) can be referred to the following webpage at “https://medium.com/capital-one-tech/caches-are-key-to-scaling-da2749adc6c9”.

It is noted that the above methods of redirecting the network address and increasing the dynamic loading efficiency for the volatile application program are only non-limiting examples. The methods of redirecting the network address and increasing the dynamic loading efficiency for the volatile application program are not restricted. That is, those skilled in the art can make any equal design changes based on actual application requirements.

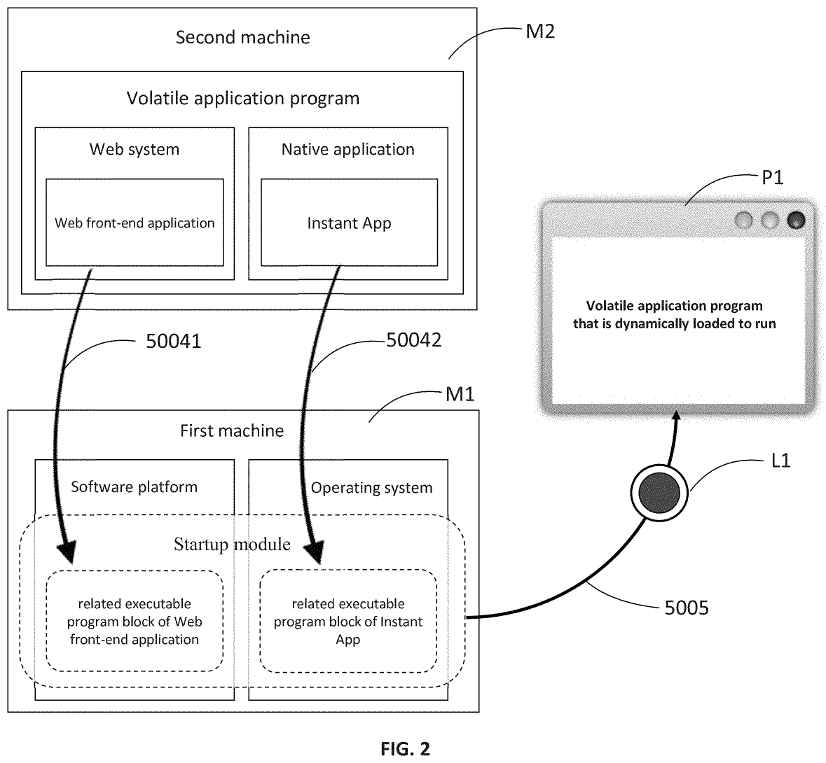

FIG. 2 is a diagram illustrating the operating concept of dynamically loading and running a volatile application program. In accordance with the basic operation process of dynamically loading and running a volatile application program, a software system in one machine M1 (e. g., a first machine M1) loads a startup program of the volatile application program from another machine M2 (e.g., a second machine M2), and then launches and runs the service provided by the volatile application program in an OS process P1 on the machine M1. After the procedure of running the service of the volatile application program is completed, the startup program of the volatile application program will be eliminated directly with the end of the OS process P1. In a preferred embodiment, a partial content of the startup program is stored into a cache, so that the next time the volatile application program is dynamically loaded and run, the cache can be used to improve the dynamic loading efficiency. The startup program includes a related executable program block of a Web front-end application and/or a progressive web application, a related executable program block of an Android Instant App, or any program block that can be used to activate the software service of the volatile application program.

As shown in FIG. 2, L1 is a software module for dynamically loading and running the volatile application program. The software module including a browser a WebView, a HTML5 inline (iFrame) or an Instant App driver is an implementation example of the software module L1. It is noted that the software module for dynamically loading and running the volatile application program is not restricted. That is, those skilled in the art can make any equal design changes based on actual application requirements.

The software module L1 for dynamically loading and running the volatile application program dynamically loads a startup program of a volatile application program from the second machine M2 to the first machine M1 through connection lines 50041 and 50042, and then the software module L1 performs a driving operation 5005 on the startup program of the volatile application program. Consequently, the volatile application program is launched.

Some examples of the method for dynamically loading and running a volatile application program (including the Web front-end application and the instant application) will be described as follows.

The first method is a method of dynamically loading a Web system. Take the Web front-end application for example. The Web front-end application is developed according to HTML/CSS/Javascript technologies. The Web front-end application is deployed in a Web server. The Web front-end application is a volatile application program. The related executable program block of the Web front-end application is the startup program (e.g., a program code including multimedia resource, HTML, CSS and/or Javascript) of the volatile application program. After the network address of the Web front-end application is set as “https://a.b.c/app”, the network address is used as the dynamic loading location of the Web front-end application. Then, in any software system that can drive a HTML5 inline frame (iFrame), a WebView or a browser, the Web front-end application corresponding to the network address “https://a.b.c/app” can be dynamically loaded to run through the use of the HTML5 inline frame (iFrame), the WebView or the browser. The HTML5 inline frame, the WebView and the browser are implementation examples of the software module L1 for dynamically and running the Web front-end application. In the implementations of the HTML5 inline frame, the WebView and the browser, they all have the function of driving an HTML/CSS/Javascript software engine. Moreover, they can even share the same HTML/CSS/Javascript software engine in the same software system (e.g., a terminal operating system).

The HTML5 inline frame is an object entity generated by the Web technology in the execution environment of the HTML/CSS/Javascript software engine itself. The browser is installed in a terminal operating system in the form of an independent application. The WebView is embedded in a man-machine interface of a native application in the form of a software component in order to provide the ability to dynamically load and run the Web front-end application for the native application. For the terminal operating system and the native application, the browser and the WebView are both adapters. In the operating environments of the terminal operating system and the native application (or referred as operating environments), they can be used to dynamically load and run applications and software components of a heterogeneous systems (e.g., a Web system). The adapter for dynamically loading and running the heterogeneous system (e.g., as the browser or the WebView) can be directly provided by the terminal operating system and built into the terminal operating system. Alternatively, the adapter is integrated into an executable object and/or a startup module and provided by the executable object and/or the startup module itself. Alternatively, the adapter is a plug-and-play adapter that is manually installed in the terminal operating system by the user. The interface adaptation between the Web front-end application and the terminal operating system/native application and the adoption of the browser and WebView in the present invention are non-limiting examples of the adapter of the present invention. For the operating environment provided by the software system, the software platform and/or the operating system described herein, the function of the adapter is mainly to adapt the application program with incompatible interface implementation to the operating environment. In accordance with an approach, the incompatible interface implementation is wrapped with the interface implementation designed or supported by the operating environment. Consequently, the application programs with incompatible and compatible interface implementations can be used to manage, drive, execute, and/or operate on the operating environment with the same or equivalent interface. The transformation of the interface implementation refers to the adaptation of the user interface, the application program interface and/or application binary interface.

The system vendor of a software platform or an operating system can use the cross-platform Java programming language to develop an application program in the operating environment of the software platform or the operating system provided by the system vendor, wherein the application program is used as the startup module of volatile application programs. The startup module can implement an interface for data transmission connection in the operating environment. Consequently, when other software modules, application programs or any executable program block in the software platform or operating system need to dynamically load and run the Web-front application, the interface can be triggered, and an execution request can be imported to the startup module through the interface. According to the content of the execution request, the startup module dynamically load and run the Web-front application in the operating environment of the software platform or the operating system. Various implementation examples of the “trigger” and the “data transmission connection” between different program blocks will be described later.

When the startup module receives the execution request, the startup module needs to firstly determine (locate) the network address “https://a.b.c/app” that can be used to dynamically load and run the Web front-end application from the content of the execution request. If the content of the execution request itself already contains the network address, the startup module can directly retrieve the network address from the content of the execution request. If the content of the execution request is a configuration and the content of the configuration contains the metadata of the Web front-end application, the startup module can determine (locate) the network address “https://a.b.c/app” according to metadata of the Web front-end application by referring to the method of FIG. 1. If the content of the execution request is an access link pointing to the metadata of the Web front-end application, after the access link is retrieved from the execution request, the startup module can firstly obtain the metadata of the Web front-end application and then determine (locate) the network address “https://a.b.c/app” according to metadata of the Web front-end application. Then, after the network address “https://a.b.c/app” that is used to dynamically load and run the Web front-end application is retrieved, the startup module launches a browser by calling java.awt.Desktop.browse (“https://a.b.c/app”) and the network address is imported to the browser. Consequently, the browser generates a sandbox, the Web front-end application is dynamically loaded to run in the sandbox.

In another embodiment, the startup module can embed a WebView in its own application window. After the startup module receives the execution request and determines (locates) the network address “https://a.b.c/app”, transmits the network address to the WebView. The WebView generates a sandbox, and the Web front-end application is dynamically loaded to run in the sandbox.

In another embodiment, the startup module itself can also be directly integrated into a browser in the form of a software component or an executable program block. Then, after the browser is installed on the software platform or the operating system, the browser itself becomes the startup module of volatile application programs for the software platform and the operating system. After the browser receives the execution request and determines (locates) the network address “https://a.b.c/app”, the browser itself generates a sandbox environment directly, and the Web front-end application is dynamically loaded to run in the sandbox.

The second method is a method of dynamically loading a native application. Take the instant application (Instant App) of an Android operating system for example. The Instant App of the Android operating system is a technology promoted by Google. This technology is designed to provide the dynamic loading and running capabilities for the Android native application. Consequently, the Android instant application can become a volatile application program. Firstly, the service provider uses an Android application technology to develop an Android native application. The related executable program block of the Android native application is prepared to be used as a startup program of a volatile application program and released in the form of an Android instant application. After the Android native application is developed and the service provider releases the Android native application on the online application store, the service provider can set a network address for the relevant executable program block and as its dynamic loading location. After the release is completed, the software service provided by the Android native application becomes an Android instant application that can be dynamically loaded to run. The associated technical contents of the Android instant application can be referred to the webpage at https://developer.android.com/topic/instant-apps/index.html.

The system vendor of Android phones can also use the Java programming language to develop a startup module in the mobile phone operating system provided by the system vendor. The startup module can also implement an interface for receiving execution requests in the operating environment of the mobile phone operating system. After the startup module receives an execution request for dynamically loading and running the Android instant application and determines (locates) the network address for dynamically loading and running the Android instant application from the content of the execution request, the adb tool can be driven directly to activate the network address by executing the command line instruction. Consequently, a sandbox environment (sandbox) can be generated in the operating environment of the Android operating system, and the Android instant application corresponding to the network address can be dynamically loaded to run in the sandbox environment. The adb tool is used as the driver of Android Instant App. In an embodiment, the adb tool is an implementation example of the software module L1 for dynamically loading and running the Android Instant App. The command line instruction of driving the adb tool to activate the Android instant application can be referred to the literature: adb shell am start—a android.intent.action.VIEW\—d “The dynamic loading location of the Android instant application”. The method of executing the command line instruction can be performed by calling java.lang.Runtime.getRunTime( ).exec (i.e., the common line instruction).

It is noted that the above methods of dynamically loading and running the volatile application program are only non-limiting examples. The methods of dynamically loading and running the volatile application program from the external machine are not restricted. That is, those skilled in the art can make any equal design changes based on actual application requirements.

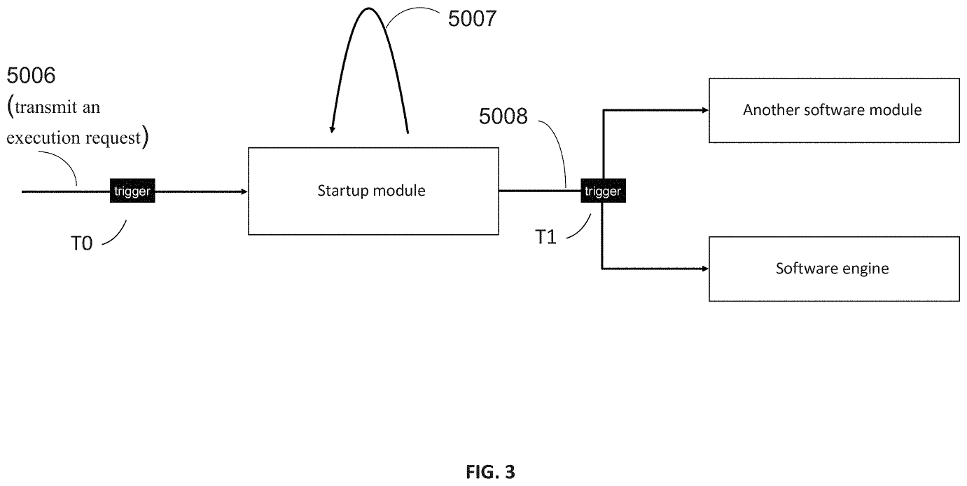

FIG. 3 schematically illustrates a basic operation process of a startup module. In this context, the “startup module” performs the following procedures in the basic operation process of dynamically loading and running a volatile application program. Firstly, a trigger T0 is issued to the startup module to submit a request 5006. The purpose of the request is to transmit an execution request. After the startup module obtains the content of the execution request through a data transmission connection, a computing process 5007 is performed. In the computing process, the startup module identifies (locates) a network address for dynamically loading and running the volatile application program according to the content of the execution request. Then, the startup module issues another request 5008 through another trigger T1. The purpose of the request 5008 is to transmit the network address to another software module or a software engine in order to drive another software module or the software engine to dynamically load and run the volatile application program in it. The technical contents about the “trigger” and the “data transmission connection” will be described later.

The startup module receives the notification of the trigger T0 and the content of the execution request by implementing an interface of data transmission connection. The trigger T0 and the execution request can be issued from different sources. The examples of some different sources will be described as follows.

Firstly, the execution request is issued when an executable event of an operable object is triggered by a user. The operable object is displayed on a user interface in the form of an operable entity in order to be operated by the user. When the user operates the operable entity and an executable event bound to the operable object is triggered, a program block responsible for processing the executable event can issue the trigger T0 and transmit the execution request into the startup module through the interface provided by the startup module. According to the content of the execution request, the startup module is driven to dynamically load and run the volatile application program corresponding to the execution request.

Secondly, the execution request is issued when a certain executable object is launched by a user. The executable object is displayed on a user interface in the form of an executable entity in order to be launched by the user. When the user launches the executable entity, a program block that is responsible for processing the startup event can issue the trigger T0 and transmits the execution request to the startup module through the interface provided by the startup module. According to the content of the execution request, the startup module is driven to dynamically load and run the volatile application program corresponding to the execution request.

Thirdly, the execution request is issued when a user inputs or clicks a network address of a specified volatile application program on the user interface provided by the startup module itself. For example, the startup module is a Windows application. On a user interface displayed by the startup module, a text input element is provided or a network address list is shown for the user to operate. Consequently, the user can input or select the network address to launch the network address. After the startup module wraps the network address into the execution request, the startup module sends the execution request to a program block that is responsible for receiving the execution request for execution. According to the content of the execution request, the program block is driven to dynamically load and run the volatile application program corresponding to the execution request.

In an embodiment, the network address for the startup module to dynamically load and run the volatile application program is imported into the startup module via the execution request. If at least one content of the execution request already contains the network address, the startup module can directly read the network address from the execution request. If the at least one content of the execution request is at least one content of the metadata of the volatile application program, the startup module can determine (locate) the network address for dynamically loading and running the volatile application program according to the at least one content by referring to the various methods as shown in FIG. 1. Alternatively, if the execution request contains an access link of the metadata of the volatile application program, the startup module can obtain the metadata of the volatile application program through the access link and then determine (locate) the network address of the volatile application program according to the content of the metadata.

In an embodiment, the operation process of the startup module is quite fixed. Consequently, if the data structure of the execution request is a standard structure and the trigger T0 used to receive the execution request and another trigger T1 used to drive another software module or software engine are completed through standard interfaces, the startup module can be a universal startup module that can dynamically load and run all volatile application programs and directly built in the software platform or the operating system provided by the system vendor. Alternatively, the startup module can be automatically generated for each volatile application program through a code generator.

It is noted that the above implementation methods of issuing execution requests, analyzing execution requests and determining (locating) the network address of the volatile application program are only non-limiting examples. That is, those skilled in the art can make any equal design changes based on actual application requirements.

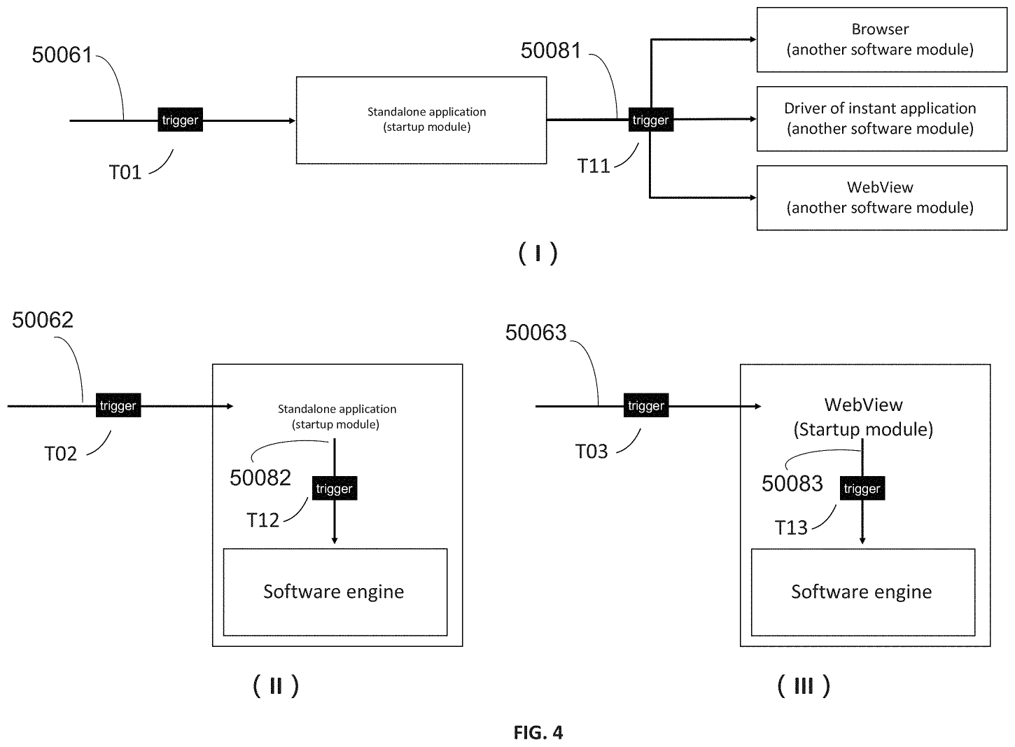

FIG. 4 schematically illustrates the operating concept of a startup module. The triggers T01, T02 and T03 as shown in FIG. 4 and the trigger T0 as shown in FIG. 3 are the same or equal triggers. The requests 50061, 50062 and 50063 as shown in FIG. 4 and the request 5006 as shown in FIG. 3 are the same or equal requests. In addition, the triggers T11, T12 and T13 as shown in FIG. 4 and the trigger T1 as shown in FIG. 3 are the same or equal triggers. The requests 50081, 50082 and 5083 as shown in FIG. 4 and the request 5008 as shown in FIG. 3 are the same or equal requests. The term “startup module” used herein can be implemented in many different ways. Some implementation examples of the startup module will be described as follows.

Firstly, the startup module itself is an application program that runs independently on a software platform or an operating system. After the application program receives an execution request through the trigger T01, the application program can activate an additional software module through another trigger T11. Consequently, a volatile application program pointed by the execution request is dynamically loaded to run in the additional software module. The additional software module can be a browser, a WebView, an instant application (Instant App) driver. If the additional software module is a browser or an Instant App driver, the additional software module is an additional application program independent of the startup module. If the additional software module is a WebView, the additional software module can be embedded in the startup module, and the additional software module and the startup module belong to the same application program.

Secondly, the startup module itself is a browser independently running on a software platform or operating system. After the browser receives an execution request through a trigger T02, the browser can drive a software engine provided by itself through another trigger T12. Consequently, a volatile application program pointed by the execution request is dynamically loaded to run in the software engine. The software engine is an HTML/CSS/Javascript software engine.

Thirdly, the startup module itself is a software component (such as WebView) that can be embedded in an application program in the operating system and used to dynamically load and run a heterogeneous system. After the software component receives an execution request through a trigger T03, the software component can drive a software engine provided by itself through another trigger T13. Consequently, a volatile application program pointed by the execution request is dynamically loaded to run in the software engine.

In addition to the above various implementation methods, the startup module itself can also be a software module in a Web software system. After the software module receives an execution request, the software component can launch a HTML5 inline frame (iFrame). Consequently, a volatile application program pointed by the execution request is dynamically loaded to run in the HTML5 inline frame.

It is noted that the above implementation methods of the startup module are only non-limiting examples. The implementation methods of the startup module are not restricted. That is, those skilled in the art can make any equal design changes based on actual application requirements.

In FIGS. 3 and 4, the execution of the “triggers T0, T1, T01, T11, T02, T12, T03 and T13” indicates that one program block drives another program block to submit a request to another program block. For example, the requests 5061, 5062 and 5063 are requests submitted by the triggers T01, T02 and T03. The purpose of each of these requests is to transmit an execution request. The requests 5081, 5082 and 5083 are requests submitted by the triggers T11, T12 and T13. The purpose of these requests is to dynamically load and run a volatile application program. Each of the “triggers T0, T01, T02 and T03” is issued when an executable object is launched by the user or an executable event of an operable object is operated by the user. In addition, these triggers used to send an execution request to a startup module and drive the startup module to provide services to the execution request. Each of “the triggers T1, T11, T12 and T13” is issued after the startup module receives the execution request. In addition, these triggers are used to drive the additional software module or a software engine to dynamically load and run a volatile application program.

In FIGS. 3 and 4 and in various embodiments of the present invention, the term “trigger” indicates that one program block drives an additional program block. Through the trigger, the program block drives the additional program block to perform a process of data transmission connection, execute an instruction and/or the combination thereof. The implementation of the “trigger” can be achieved according to various methods or the combination thereof. Some methods will be described as follows.

Firstly, the “program code of the additional program block” is directly imported into the “program code of the program block”, and the triggering action of the program block to the additional program block is implemented by directly executing the additional program block in the program block. That is, the trigger is executed in the same OS process, and the program block and the additional program block belong to the program blocks of the same software module.

Secondly, the driving method of the additional program block is wrapped as a function, and the additional program block is triggered by the program block when the program block executes the function in a synchronized function call manner. The function and the program block can be executed in the same OS process. Alternatively, the function and the program block can be executed in different OS processes or in different machines. For example, if the function and the program block are executed in different OS processes or in different machines, an interface of the function for the Remote Procedure Call can be provided for the program block to call.

Thirdly, the triggering action of the program block to the additional program block is completed in an asynchronous event-driven manner. That is, the program block issues an event to notify a listener program of the event, and the “additional program block” is executed by the listener program. The listener program and the program block can be executed in the same OS process. Alternatively, the listener program and the program block can be executed in different OS processes or in different machines. For example, if the listener program and the program block are executed in different OS processes or in different machines, the event can be received through an interprocess communication or a socket connection. Moreover, after the event is received, the additional program block is executed.

It is noted that the method of performing the triggering action of the program block to the additional program block is not restricted. The methods of integrating function calls and event interactions between various executable program blocks are very popular. In addition, those skilled in the art can make any equal design changes based on actual application requirements.

In this context, the term “data transmission connection” used herein denotes an implementation process of transmitting a data from a software system, a software module and/or a program block to an additional software system, an additional software module and/or an additional program block. When a program block triggers an additional program block, it is often necessary to simultaneously perform the data transmission connection for data transfer. Consequently, the additional program block can obtain sufficient data for execution. For example, when a program block triggers the startup module and drives the startup module to provide services for an execution request, the program block needs to be able to send the execution request to the startup module via the trigger. When the startup module triggers the additional software module or the software engine to drive the additional software module or the software engine to dynamically load and run a volatile application program, the startup module must also be able to transmit the network address for dynamically loading and running the volatile application program to the additional software module or the software engine via the trigger.

There are many different methods for performing the data transmission connection. Hereinafter, only some methods of performing the data transmission connection between one program block and an additional program block when the program block triggers the additional program block will be described.

Firstly, if the additional program block is wrapped as a function and the program block triggers the additional program block to execute a task by calling the function, the data required for executing the task can be transmitted from the program block to the additional program block by using the method of passing parameters to the function.

Secondly, if the program code of the additional program block is directly introduced into the program code of the program block, when the program block directly executes the program code of the additional program block to trigger the additional program block to perform a task, the data required for executing the task can be directly stored in a memory space by the program block, and the data required for executing the task can be directly retrieved from the memory space by the additional program block.

Thirdly, the program block provides a function for reading data, and then triggers an event to notify the additional program block to execute task in an event-driven manner. After the additional program block receives the notification, the additional program block calls the function to receive the data that is required for executing the task.

It is noted that the above methods can be implemented on different software systems, software modules, and/or program blocks. However, the methods of performing the data transmission connection between different software systems, software modules and/or program blocks during the runt time are not restricted. Various data transmission connection technologies have become very popular. In addition, those skilled in the art can make any equal design changes based on actual application requirements.

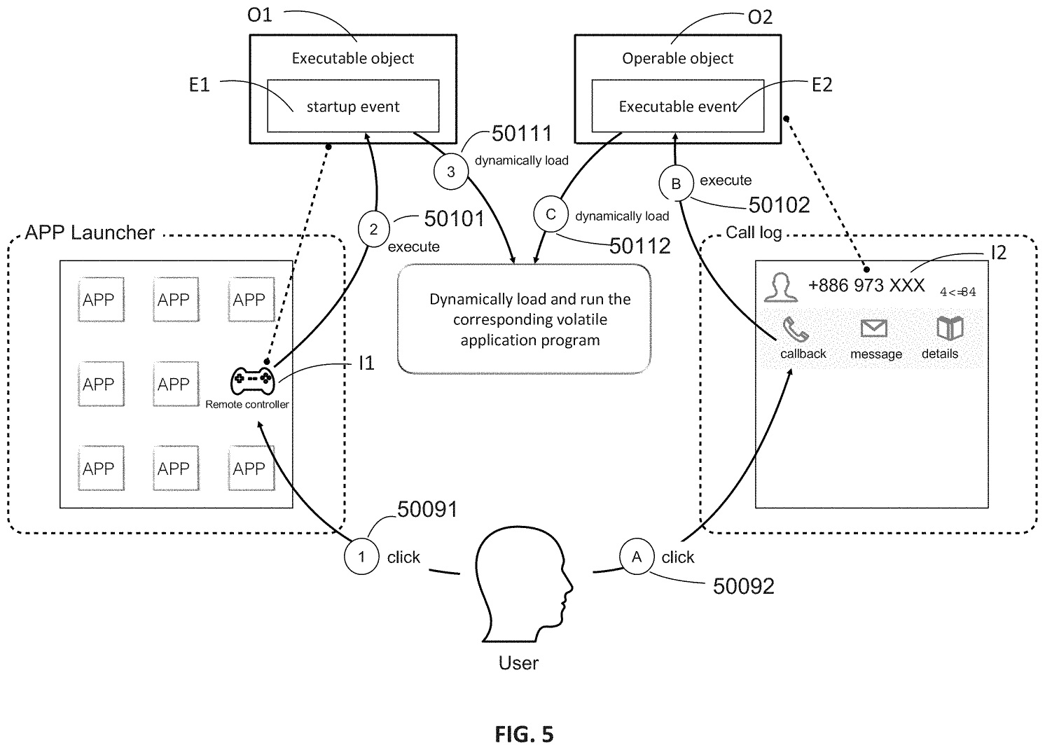

FIG. 5 schematically illustrates a basic operation process of an executable object and an operable object. The term “executable object” used herein denotes a volatile application program that can be installed, introduced and/or automatically provisioned into a software system. As shown in FIG. 5, the executable object is a volatile application program named “remote controller”. The executable object O1 is generated according to a data model of an application program unit. After the executable object O1 is installed, introduced and/or automatically provisioned into a software system, the executable object O1 will become an executable entity I1 (i.e., a remote controller App) compatible with the software system. During the runt time of the software system, the executable entity I1 is displayed on a user interface for the user to launch. The user interface is an App launcher. The user can open the executable entity I1 through a click 50091 on the App launcher, and then load and run the executable program block of the remote controller App. Firstly, in response to the click 50091, the App launcher submits a trigger 50101 to a startup event E1 of the remote controller App. After receiving the trigger 50101, the program block responsible for processing the startup event E1 will dynamically load and run the operation flow of the volatile application program and perform a corresponding processing operation 50111. The processing operation 50111 is performed to issue a corresponding execution request. Consequently, the volatile application program corresponding to the executable object O1 is dynamically loaded to run, and the volatile application program provides the user with a “remote controller” software service. The methods of dynamically loading and running the operation flow of the volatile application program can be referred to the embodiment of FIG. 3 and/or the embodiment of FIG. 4. That is, those skilled in the art can make any equal design changes based on actual application requirements.

In an embodiment, the executable object O1 has various implementation aspects. Some implementation aspects of the executable object O1 will be described as follows.

Firstly, the executable object O1 itself is an application program that can be installed and activated on the software system. For example, the executable object O1 is an Android App. Its icon and name are set according to the App icon and the App name of the volatile application program. The metadata of the volatile application program is provided in the configuration file of the executable object O1 in the form of a configuration or an access link. The software system can be an Android operating system. After the executable object O1 is installed, introduced and/or automatically provisioned into the software system, the software system will generate a corresponding executable entity I1 according to its icon and name, and display the executable entity I1 on the desktop of the mobile phone for the user to click. After the user clicks the executable entity I1 corresponding to the executable object O1 on the desktop, the software system will firstly load and execute the executable program block of the executable object O1 itself (i.e., the program block of the Android App), and then the software system can notify the executable object O1 to launch through a standard application programming interface (e.g., an Android Activity application programming interface). That is, under this circumstance, the startup event E1 of the executable object O1 is processed by a program block of the executable object O1 itself. In accordance with the main task of the program block, the content (e.g., the configuration or the access link) set in the content of the executable object O1 is encapsulated as an execution request, and then the execution request is transmitted to a startup module through a data transmission connection. The startup module processes the execution request, and dynamically loads and runs the volatile application program in the software system. Moreover, the technical contents of the Android Activity can be referred to the webpage at “https://developer.android.com/reference/android/app/Activity”. The action of the software system to call the onStart function of the executable object O1 can be regarded as the trigger of a startup event. Those skilled in the art know that when the executable object O1 (Android App) is installed in the software system, it is not necessary to download the volatile application program that can provide the “remote controller” service to the software system.

In an embodiment, the installation and startup flow of the executable object O1 is a universal operation flow. Consequently, the executable object O1 can be automatically generated through a code generator, and the system vendor or the service provider can provide the code generator in the software system. The code generator is an implementation example of the “metadata conversion program” of the present invention.

In an embodiment, the code generator has the ability to parse the metadata of the volatile application program. The code generator can load various information from the metadata according to the data structure of the metadata. An operation process of the code generator will be described as follows. When the code generator receives the metadata of the volatile application program, the loading location of an App icon and an App name, the code generator creates a folder in a storage space that it can access. Moreover, relevant subfolders for storing AndroidManifest.xml, Java source code file, image resources (drawable resource) and profiles (values) are created in the folder. Consequently, an Android App project is automatically generated for the volatile application program. The code generator uses the Android App project to generate an Android App, and the Android App is used as an executable object of the volatile application program. After the Android App project is automatically generated, the code generator performs the following steps to complete the implementation of the Android App project: (1) The App icon is loaded from the loading location of the App icon and saved in the subfolder for storing the image resources. (2) A configuration file is generated in the subfolder that is used for storing the profile, and the content of the metadata is written into the configuration file. (3) A Java source file to be used for writing an Android Activity code is generated and saved in a subfolder for storing the Java source file, wherein the Android Activity is used as the entrance to the Android App, wherein when the user clicks the Android App on the desktop of a mobile phone, an onStart function of the Android Activity is responsible for processing the launch task of the Android App, wherein the Package name and the Activity name of the Android Activity are provided and set by the code generator. (4) The basic structure of the Android Activity code is written into the Java source file, wherein for the Android App, the program code of each Android Activity must follow the Android application framework to complete the implementation, so that the basic structure of the program code is identical and can be automatically generated by the code generator. (5) The program code for reading the configuration file is automatically written into the onStart function, wherein the name and the location of the configuration file are determined by the code generator itself and the program code read from the content of a file is basically identical, so that the “the program code for reading the configuration file” can be automatically generated by the code generator. (6) A program code for parsing the configuration file is automatically written to the position under the program code that is generated in the previous step, wherein the code generator has the ability to parse the metadata content in the configuration file and has a full understanding of the data structure of the metadata content, and the program code for parsing the metadata content according to the data structure of the metadata content is basically fixed, so that “the program code for parsing the configuration file” can be automatically generated by the code generator. (7) A program code for determining (locating) a network address is automatically written to the position under the program code that is generated in the previous step, wherein as mentioned in FIG. 1 and the related embodiments, the relevant program code for determining (locating) the network address according to the content of the metadata is basically fixed, so that the program code for determining (locating) the network address can be automatically generated by the code generator. (8) A program code for driving a Web front-end application or an Android instant application is automatically written to the position under the program code that is generated in the previous step according to the type of the volatile application program, so that the implementation of the Android Activity is completed, wherein as mentioned in FIG. 2 and the related embodiments, the program code for driving the Web front-end application or the Android instant application is basically fixed, so that the program code for driving the Web front-end application or the Android instant application can be automatically generated by the code generator, wherein the type of the volatile application program can be set in the metadata content, or pre-defined by the code generator itself. (9) After implementation of the Android Activity is completed, an AndroidManifest.xml is automatically generated and various resources including the Android Activity, the App icon, App name and the related information of the configuration file are automatically set to the content of AndroidManifest.xml to complete the construction of the Android App project, wherein the App icon and the App name can also be set by the metadata content. (10) After the construction of the Android App project is automatically constructed, the code generator can compile the Android App project, generate an Android App (executable object) for the volatile application program, and generate an installation file for the Android App, wherein if the code generator itself has the permission to install the Android App, the Android App (executable object) can be directly installed in the mobile phone operating system.

In another embodiment, the code generator has the following operation process. When the code generator receives an access link of the metadata of the volatile application program, the loading location of an App icon and the name of an App, the code generator firstly obtains the metadata content of the volatile application program via the access link, and then performs the above steps to automatically generate the Android App (executable object) for installation.

In another embodiment, the code generator has the following operation process. If a browser, a WebView or an Android instant application driver has the ability to analyze the metadata content of the volatile application program and provides an interface for data transmission connection to receive the content of the configuration file, it is not necessary for the code generator to write the program code for parsing the configuration file into the program code of the Android Activity. Instead, after the step (5) is completed, a program code is directly written to complete the implementation of the Android Activity. That is, it is not necessary to perform the steps (6), (7) and (8). The function of the program code is to directly transmit the content of the configuration file to the browser, the WebView or the driver of the Android instant application through the interface, and then drive the browser, the WebView or the driver of the Android instant application to parse and process the content of the configuration file to dynamically load and run the volatile application program.

In another embodiment, the code generator has the following operation process. When the code generator receives an access link of the metadata of the volatile application program, the loading location of an App icon and the name of an App, the code generator only needs to set the access link in the content of the configuration file. Under this circumstance, when the content of the configuration file is transmitted to the browser, the WebView or the driver of the Android instant application through the interface, the browser, the WebView or the driver of the Android instant application can acquires the access link from the content of the configuration file. After the browser, the WebView or the driver of the Android instant application obtains the metadata of the volatile application program via the access link, the browser, the WebView or the driver of the Android instant application parses and determines (locates) the network address for dynamically loading and running the volatile application program. Consequently, the volatile application program can be loaded to run in it. Through this operation process, it is not necessary for the code generator and the Android App generated by the code generator to perform any form of computing or processing operation on the metadata of the volatile application program. As long as the code generator obtains the access link of the metadata of the volatile application program, the code generator can automatically generate an executable object for the volatile application program.

In an embodiment, the Android App (i.e., the executable object O1) generated by the code generator is a startup module. After the Android App is installed in an Android operating system (i.e., the software system), the user can click on the desktop that is provided by the Android operating system to activate the Android App. After the startup event of the Android App (i.e., the onStart function) is triggered, the Android App can generate an execution request, and the content contained in the configuration file (e.g., the metadata of the volatile application program or its access link) can be filled in the execution request. In this way, the execution request can then be transmitted to a browser, an Android instant application driver, or a WebView embedded in the Android Activity through a data transmission connection. Consequently, the volatile application program can be dynamically loaded to run in the Android operating system. If the Android App and the Android operating system are provided by the same enterprise, under controllable security conditions, the Android operating system can transmit the identity data (or the account data) of the user to the Android App while the Android App is activated. When the Android App generates the execution request, the identity data (or the account data) of the user can be filled into the execution request. When the volatile application program is dynamically loaded to run, directly login to the services that are provided by the volatile application program. Moreover, during the run time of the volatile application program, the access authority of the user is identified (located) according to the identity data of the user.

Secondly, the executable object O1 itself is a data entity that can be managed by the software system. For example, the executable object Q1 is an App configuration file that is supported by the software system. That App configuration file at least contains an App icon, an App name, and a metadata of the volatile application program or an access link of the metadata. When the software system is activated, all App configuration files in its storage space are firstly read. After the App icon and App name of each App configuration file are loaded, the corresponding executable entity for each App configuration file can be generated on the user interface of the software system. In this way, the executable entity I1 corresponding to the executable object O1 is also included on the user interface for the user to click. Then, when the user clicks the executable entity I1 on the user interface, the software system can directly read the App configuration file corresponding to the executable object O1 and encapsulate the content (including the metadata of the volatile application program or its access link) as an executable request. Then, the executable request is transmitted to a startup module through a data transmission connection. The executable request is processed by the startup module, and the volatile application program is dynamically loaded to run onto the software system. Under this circumstance, the startup event E1 of the executable object O1 can be processed by a program block of the software system itself. Those skilled in the art know that when the executable object O1 (App configuration file) is installed in the software system, it is not necessary to download the volatile application program that can provide the “remote controller” service to the software system.

In an embodiment, the App icon and the App name can also be designated by the content of the metadata. After the content of the metadata is parsed, the App icon and the App name are loaded and displayed on the user interface by the software system. If the content of the App configuration file only contains the access link of the metadata, after the software system obtains the content of the metadata via the access link, the software system parses the content of the metadata to load the App icon and the App name.

In an embodiment, the executable object O1 can be automatically generated by the App configuration generator. When the App configuration generator receives the metadata of a volatile application program or its access link, an App configuration file can be newly generated. Following the data structure of the App configuration file, the content of the metadata or the access link can be written into the App configuration file and saved into the storage space of the software system to complete the installation of the App configuration file (i.e., the executable object). The App configuration generator is an implementation example of the “metadata conversion program” described in this context.

In the descriptions of the above embodiments, the code generator and the App configuration generator can be integrated into any software module and/or application program in the form of a software component so as to be provided in the software system. As long as the service provider of the volatile application program can transmit the metadata of the volatile application program to the software module and/or the application program in the form of a configuration or an access link, the executable object (e.g., the App configuration file or the Android App) of the volatile application program can be automatically generated by the software module and/or the application program and automatically installed in the software system. Moreover, the service provider of the volatile application program can directly provide the account information of the user in the metadata of the volatile application program and allow each user to have their own unique metadata. In this way, when the metadata or its access link of a user is transmitted to a startup module to dynamically load and run the volatile application program, the volatile application program can complete the login task according to the account information. Consequently, the dynamic installation and/or auto-provision task can be completed.

It is noted that the examples of the executable object and the implementation examples of the code generator/App configuration generator are only non-limiting examples. That is, those skilled in the art can make any equal design changes based on actual application requirements.

Moreover, the term “operable object” used herein denotes an operable entity that can be stored into a management module. As shown in FIG. 5, an executable object O2 is a call log, and the executable object O2 is managed by a management tool that is responsible for managing call logs. The executable object O2 is generated according to a data model of an information unit. After the executable object O2 is stored into the management tool, the executable object O2 become an operable entity I2 compatible with the management tool. Moreover, during the runt time of the management tool, the operable entity I2 is displayed on a user interface to be operated by the user. As shown in FIG. 5, the user interface is a call log list. The user can call back the call log represented by the operable entity I2 through a click 50092 on the call log list. In response to the click 50092, the user interface submits a trigger 50092 to an executable event E2 of the call log list. After receiving the trigger 50092, the program block responsible for processing the executable event E2 will dynamically load and run the operation flow of the volatile application program and perform a corresponding processing operation 50112. The processing operation 50112 is performed to issue the corresponding execution request to a startup module to dynamically load and run a volatile application program corresponding to the executable event E2. In addition, the volatile application program provides a “callback” application service for the executable event E2. It is noted that any information unit that can be used to save the state of an operation process can be used as an operable object. The examples of the operable object are not restricted. The methods of dynamically loading and running the operation flow of the volatile application program can be referred to the embodiment of FIG. 3 and/or the embodiment of FIG. 4. That is, those skilled in the art can make any equal design changes based on actual application requirements.

In an embodiment, the executable event E2 is bound to an Event configuration file. The Event configuration file contains at least the metadata of a volatile application program or an access link pointing to the metadata. When the management tool generates an operable entity for the operable object O2, the management tool can load all the Event configuration files of the operable object O2 from the storage space at the same time, so as to grasp all the binding relationships between each executable event of the operable object O2 and the Event configuration files. When the user clicks “callback” on the user interface of the call log, the management tool can correctly read the Event configuration file corresponding to the executable event E2, and then dynamically load and run the volatile application program corresponding to the Event configuration file. Under this circumstance, the action of driving the executable event E2 is handled by a program block of the management tool. The Event configuration file is an implementation example of an executable state. Those skilled in the art know that when the operable object O2 (e.g., the call log) is stored in the management tool, it is not necessary to download the volatile application program that can provide the “callback” service.

In an embodiment, the Event configuration file can be automatically generated through an Event configuration generator. When the Event configuration generator receives an executable state of a volatile application program, the Event configuration generator firstly creates an Event configuration file, and then the content of the executable state is written into the Event configuration file according to the data structure of the Event configuration file. Then, the Event configuration file and the operable object are stored into the storage space of the management tool, and the at least one executable event and the Event configuration file are bound to the physical content of the operable object. For example, an event table is created in the physical content of the operable object. The Event configuration file corresponding to each executable event is recorded in the event table. Consequently, when the at least one executable event is triggered, the Event configuration file can be correctly driven to complete the work required by the user through the querying action on the event table. The Event configuration generator is an implementation example of the “metadata conversion program” of the present invention.

In the descriptions of the above embodiments, the Event configuration generator can be integrated into any software module and/or application program in the form of a software component so as to be provided in the software system. As long as the service provider of the volatile application program can transmit the metadata of the volatile application program to the software module and/or the application program in the form of a configuration or an access link, a corresponding Event configuration file can be automatically generated by the software module and/or the application program. After binding the Event configuration file to an operable object, it can be stored in the management tool. In this way, the task of dynamically importing an operation process is completed.

It is noted that the above aspects of the operable object and the implementation method of the Event configuration generator are non-limiting examples of the present invention. The aspects of the operable objects and the implementation method of the Event configuration generator are not restricted. That is, those skilled in the art can make any equal design changes based on actual application requirements.

Please refer to FIG. 5. In an embodiment, the Event configuration file bound to an executable event of the operable object actually represents the executable state of a volatile application program. As shown in FIG. 5, when the user clicks the callback button for a call log, the user's needs are not limited to the requirement of dynamically loading and running a volatile application program that can provide a “callback” service. Instead, when the callback button is clicked, not only the purpose of dynamically loading and running the volatile application program but also the purpose of directly making a phone call to the other party of the call log to complete the callback work can be achieved. That is, in this embodiment, the Event configuration file actually represents the executable state of the call operation process. In the executable state, not only the metadata of the volatile application program that can provide the call service or its access link but also an application state related to the call operation process needs to be recorded.

For example, the application state in the content of the Event configuration file linked by the executable event E2 at least contain a call ID and a user ID that can be used to represent the user's identity. The application state is a state setting that can be transmitted from the startup module to the volatile application program. After the volatile application program (e.g., the call service) is dynamically loaded to run, during the runt time, the internal application state thereof is adjusted according to the content of the state setting and then the callback task is performed. The volatile application program uses the call ID to find the user ID of an additional user who participates in the call activity and sends a new dial request to the additional user. Consequently, the volatile application program creates a new call activity for the user and the additional user.

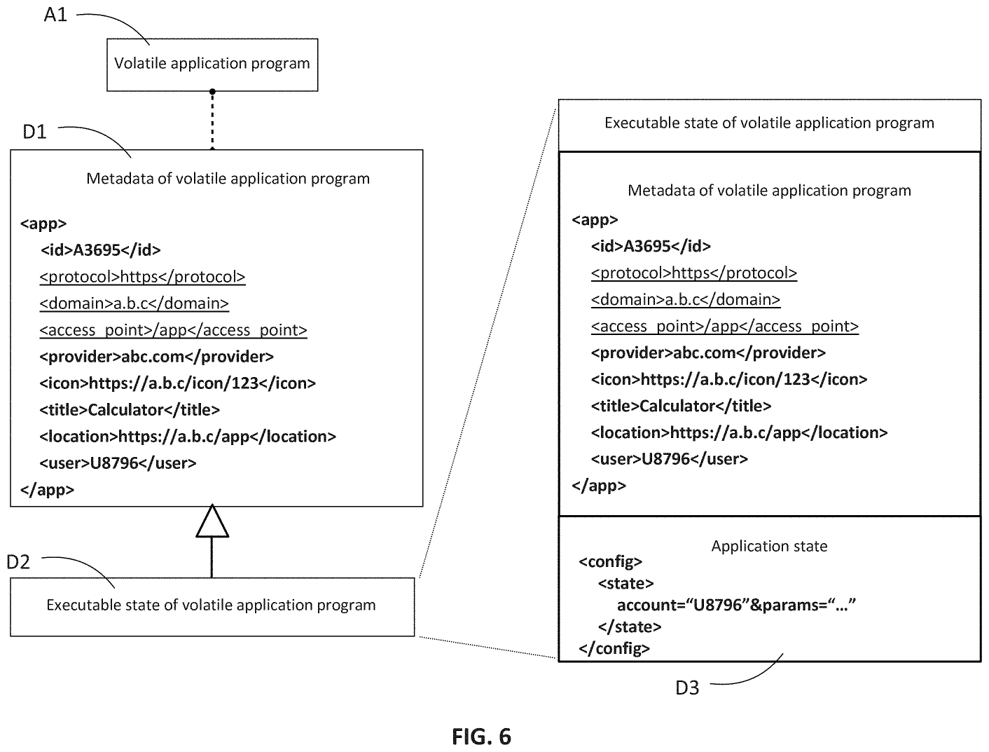

FIG. 6 schematically illustrates the structure of an executable state of a volatile application program. The volatile application program A1 as shown in FIG. 6 and the volatile application program A1 as shown in FIG. 1 are the same or equal volatile application programs. The metadata D1 as shown in FIG. 6 and the metadata D1 as shown in FIG. 1 are the same or equal metadata. The executable state D2 of the volatile application program A1 itself can be regarded as another implementation example of the metadata D1 of the volatile application program A1. In addition to the metadata D1 of the volatile application program A1, the content of the executable state D2 itself also contains an application state D3. In accordance with the use purpose of the application state D3, after the volatile application program A1 is dynamically loaded to run, the volatile application program A1 can adjust the internal application state to the executable state that best meets the needs of the user according to its state setting.

Please refer to the executable state D2 as shown in FIG. 6. Since the implementation examples of the volatile application program A1 have different types, the startup module can transmit the application state D3 in the executable state D2 to the volatile application program A1 in the form of a parameter through different methods. Some examples of the methods will be described as follows.

Firstly, the volatile application program A1 is a Web front-end application, and the startup module is developed using Android native application technology. The startup module receives an execution request that is triggered for the executable state D2. When the execution request is issued, the entire of the content of the executable state D2 can be filled into the execution request. After the startup module receives the execution request, the startup module obtains the network address for dynamically loading and running the Web front-end application according to the content of the metadata D1 contained in the execution request. That is, the network address is “https://a.b.c/app” pointed by <location>. Moreover, the application state D3 contained in the execution request can be added to the network address in the form of URL Query Parameter, i.e., “https://a.b.c/app?account=“U8796”&params= . . . ”. Then, the startup module drives a browser or a WebView to launch the network address, and the Web front-end application (i.e., the volatile application program) pointed by the network address is dynamically loaded to run in it. After the Web front-end application is dynamically loaded to run, the URL network address “https://a.b.c/app? account=“U8796”&params= . . . ” transmitted to the Web front-end application can be parsed. After the state setting contained in the URL network address is obtained, the internal application state thereof can be adjusted to execute the corresponding service for the user according to the content of the state setting. The technical contents of the URL Query Parameter (URL Query String) can be referred to the webpage at https://en.wikipedia.org/wiki/Query_string. The use of the startup module to drive the browser or the WebView to launch the network address may be regard as a method of “triggering” the Web front-end application by the startup module. The method of the transmitting the state setting to the Web front-end application through the URL Query Parameter may be regarded as the “data transmission connection” for the Web front-end application.

Secondly, the volatile application program A1 is an Android instant application (Instant App), and the startup module is developed using Android native application technology. The startup module receives an execution request that is triggered for the executable state D2. When the execution request is issued, the entire of the content of the executable state D2 can be filled into the execution request. After the startup module receives the execution request, the startup module obtains the network address for dynamically loading and running the Android instant application according to the content of the metadata D1 contained in the execution request. That is, the network address is “https://a.b.c/app” pointed by <location>. Moreover, the application state D3 contained in the execution request can be added to the network address in the form of URL Query Parameter, i.e., “https://a.b.c/app?account=“U8796”&params= . . . ”. Then, the startup module launches the network address through an adb tool, and thus dynamically loads and runs the Android instant application corresponding to the network address. During the runt time of the Android instant application, the URL Query Parameter (i.e., the state setting) embedded in the network address can be obtained by using the method of calling android.app.Activity.getIntent( ).getData( ).getQueryParameter( . . . ). Moreover, the internal application state thereof can be adjusted to execute the corresponding service for the user according to the content of the state setting. The use of the startup module to launch the network address through the adb tool may be regard as a method of “triggering” the Android instant application by the startup module. The method of the transmitting the state setting to the Android instant application through the URL Query Parameter may be regarded as the “data transmission connection” for the Android instant application.

In an embodiment, when the volatile application program is dynamically loaded to run, the URL Query Parameter method can also be used to provide the user's identity data (or account data) to the volatile application program in the form of parameters. Consequently, during the runt time of the volatile application program, the access authority of the user can be identified (located) through the identity data (or account data).

It is noted that various methods of transmitting the state setting to a volatile application program are only non-limiting examples. The methods of transmitting the state setting to a volatile application program that is dynamically loaded to run are not restricted. Those skilled in the art can make any equal design changes based on actual application requirements.

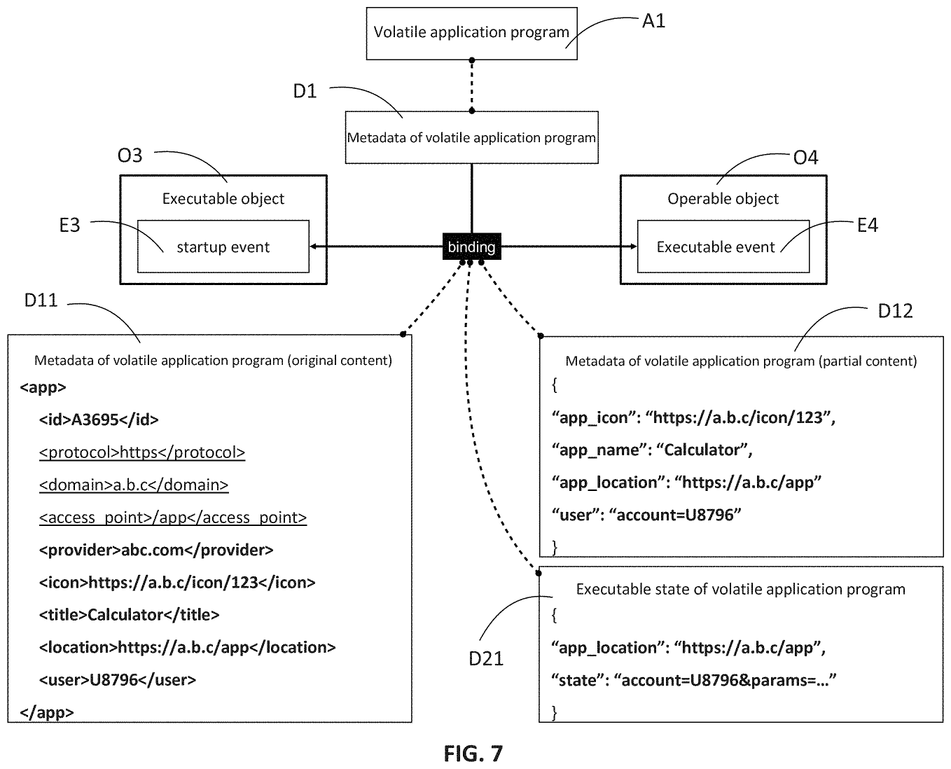

FIG. 7 schematically illustrates the binding relationship between the metadata/executable state of a volatile application program and an executable object and an operable object. The volatile application program A1 as shown in FIG. 7 and the volatile application program A1 as shown in FIG. 6 are the same or equal volatile application programs. The metadata D1, D11 as shown in FIG. 7 and the metadata D1 as shown in FIG. 6 are the same or equal metadata. The metadata D12 as shown in FIG. 7 and the metadata D1 as shown in FIG. 6 are the same or equal metadata. The metadata D12 is a data entity that is obtained by re-organizing the partial content of the metadata D1 with a data model. The executable state D21 as shown in FIG. 7 and the executable state D2 as shown in FIG. 6 are the same or equal executable states. The executable state D21 is an executable state after the executable state D2 is re-organized with a data model.

There is a binding relationship between the content of the metadata D1 of the volatile application program A1 and the executable object O3 and the operable object O4. Through the connection of the binding relationship, the task of dynamically loading and running the volatile application program A1 can be correctly completed when the executable object O3 is launched or an executable event of the operable object O4 is triggered. Preferably but not exclusively, the binding relationship is completed through a configuration file. If the executable object is an executable application program, the configuration file can be set in a profile of the executable object. The configuration file itself can be an App configuration file (executable object). The App configuration file is an identifiable file type and stored in a directory designated by a software system. The software system can read, load and drive the App configuration file from the directory. The configuration file can also be an Event configuration file, which is set in the storage space of the operable object. In the physical content of the operable object, there is a linking relationship between the Event configuration file and an executable event. The App configuration file or the Event configuration file can not only be stored as a file, but also stored in a database in the form of a data entity.

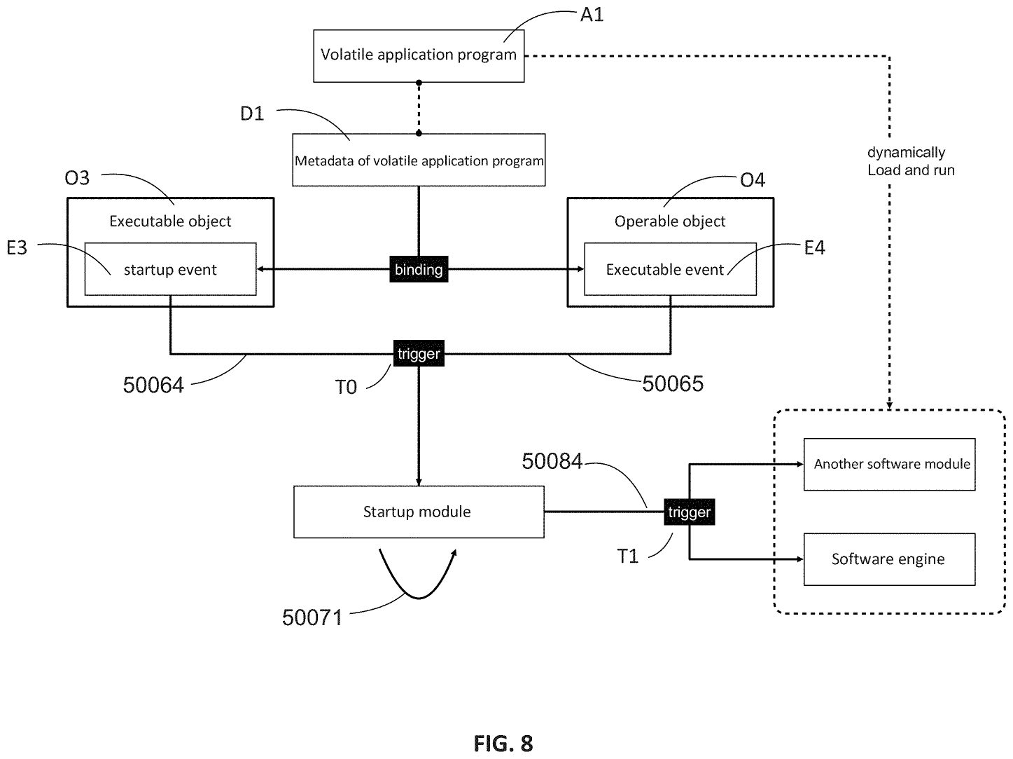

FIG. 8 schematically illustrates the operating concepts of an executable object and an operable object. Please also refer to FIG. 7 and FIG. 3. The volatile application program A1 as shown in FIG. 8 and the volatile application program A1 as shown in FIG. 7 are the same or equal volatile application programs. The metadata D1 as shown in FIG. 8 and the metadata D1 as shown in FIG. 7 are the same or equal metadata. The executable object O3 as shown in FIG. 8 and the executable object O3 are shown in FIG. 7 are the same or equal executable objects. The operable object O4 as shown in FIG. 8 and the operable object O4 as shown in FIG. 7 are the same or equal operable objects. The startup event E3 as shown in FIG. 8 and the startup event E3 as shown in FIG. 7 are the same or equal startup events. The executable event E4 as shown in FIG. 8 and the executable event E4 as shown in FIG. 7 are the same or equal executable events. The triggers T0 and T01 as shown in FIG. 8 and the triggers T0 and T1 as shown in FIG. 3 are the same or equal triggers. The requests 50064 and 50065 as shown in FIG. 8 and the request 5006 as shown in FIG. 3 are the same or equal requests. In addition, the computing process 50071 as shown in FIG. 8 and the computing process 5007 as shown in FIG. 3 are the same or equal computing processes. The request 50084 as shown in FIG. 8 and the request 5008 as shown in FIG. 3 are the same or equal requests.

In an embodiment, the metadata D1 represents the implementation example of the metadata of the volatile application program A1. The configuration file content bound to the executable object O3 can be the original content D11 of the metadata D1, the partial content D12 of the metadata D1, or an access link pointing to the original content D11 or the partial content D12. The executable state D21 represents an implementation example of an executable state of the volatile application program A1. The configuration file content bound to the operable object O4 can be an executable state D21 of the volatile application program A1 or an access link pointing to the executable state D21.

In an embodiment, regardless of the original content D11, the partial content D12 and the executable state D21, they can all be registered in the registration service S1 as shown in FIG. 1. The registration service S1 generates a corresponding access link for the original content D11, the partial content D12 or the executable state D21. Binding the access link to the executable object O3 and the operable object O4 can prevent writing the complete content of the original content D11, the partial content D12 and the executable state D21 into the configuration file contents of the executable object O3 and the operable object O4. That is, the duplicates of the original content D11, the partial content D12 and the executable state D21 are prevented from being written into the configuration file contents of the executable object O3 and the operable object O4. If the duplicates are written into the configuration file content, once the metadata D1 needs to be amended, a lot of additional costs is required to complete the synchronous update of the data. The binding relationship established through the access link only needs to maintain the latest data in the registration service S1. Consequently, cost of data synchronization can be largely reduced.

In an embodiment, when the binding relationship is established in the form of an access link, the access link will be set in the App configuration file of the executable object O3 or the Event configuration file of the operable object O4. After the program block responsible for processing the startup event E3 and the executable event E4 receives the access link from the App configuration file or the Event configuration file, the program block can receive the complete content of the original content D11, the partial content D12 or the executable state D21 from the registration service S1 via the access link and fills the complete content into an execution request, and then the execution request is transmitted to a startup module via a trigger T0. After receiving the executable request, the startup module can read the executable request to obtain the complete content of the original content D11, the partial content D12 or the executable state D21 from the executable request. After the network address for dynamically loading and running the volatile application program A1 is determined (located) according to the content of the executable request, the volatile application program A1 is dynamically loaded to run in another software module (e.g., a browser/WebView/instant application driver) or software engine (e.g., HTML/CSS/Javascript software engine).

In another embodiment, before the trigger T0 is executed, the program block responsible for processing the startup event E3 and the executable event E4 firstly determines (locates) the network address for dynamically loading and running the volatile application program A1 according to the content of the original content D11, the partial content D12 or the executable state D21. Then, after the network address is filled into the executable request, the executable request is transmitted to the startup module through the trigger T0. In this way, as long as the startup module receiving the executable request, the startup module can obtain the network address by reading the content of the executable request and dynamically load and run the volatile application program A1 directly.

In an embodiment, the program block responsible for processing the startup event E3 and the executable event E4 can directly fill the access link into the execution request. Then, the trigger T0 is executed, and the execution request is transmitted to the startup module. In this way, the startup module receiving the executable request needs to firstly acquire the complete content of the original content D11, the partial content D12 or the executable state D21 via the access link, and then determine (locate) the network address for dynamically loading and running the volatile application program A1. Consequently, the volatile application program A1 is dynamically loaded to run.

In another embodiment, when the volatile application program A1 is dynamically loaded to run, the state setting (the account information or the application state) that is automatically provisioned to the original content D11, the partial content D12 and the executable state D21 can be transmitted to the volatile application program A1 in the form of parameters. Consequently, the volatile application program A1 adjusts the internal application state during the runt time according to the state setting. The method of the transmitting the state setting to the volatile application program through the startup module in the form of the parameters can be referred to the above examples of the URL Query Parameter.

As mentioned above, the binding relationship between “the executable object and the operable object” and a volatile application program is established by binding “a bound content and/or the access link of the bound content” to the executable object and the operable object (e.g., an App configuration file or an Event configuration file). In the binding relationship, the bound content represents a data reference of the metadata of the volatile application program. During the data processing process, the content of the metadata of the volatile application program can be obtained, recovered or inquired according to the content of the data reference. Consequently, the bound content itself can be used to represent the metadata of the volatile application program.

It is noted that the binding/driving methods between the metadata and the executable object and between the executable state and the operable object are only non-limiting examples and not restricted. That is, those skilled in the art can make any equal design changes based on actual application requirements.

There is a standard data model between the “executable object” and the “software system” of the present invention for driving the executable object. That is, the reason why the software system can display the executable object on the user interface for the user to click and then launch the executable object is because the executable object is generated according to the format of the standard data model, allowing the software system to identify, manage, and drive the executable object. Similarly, there is an additional standard data model between the “executable state” and the “management tool” of the present invention for driving the executable state. That is, the executable state is generated according to the format of the additional standard data model. Consequently, when the user triggers an executable event of an operable object on the user interface of the management tool, the management tool can correctly read and drive the executable state bound to the executable event according to the standard data model. The “standard data model” used herein can be regarded as a “unified data model” that is supported by the software system and the management tool for the “executable objects” and the “executable state”.

In an embodiment, when the standard data model supported by the software system for the “executable object” and the data model of the “metadata of the volatile application program” itself are the same or equal data models (i.e., the compatible data models), or when the software system launches the “executable object”, the configuration content of the “executable object” has no needs to be parsed. That is, it is only necessary to encapsulate its configuration content into an execution request and then transmit the execution request to the startup module. The task of parsing the configuration content is executed by the startup module. In any of the above situations, it means that the “metadata of the volatile application program” can be directly used as the App configuration content of an executable object and installed in the software system without the need of undergoing any data format conversion. The “metadata of the volatile application program” without the need of undergoing any data format conversion indicates that it is not necessary to re-organize the content of the “metadata of the volatile application program” with other data models and model the content into a data entity in another format.

In an embodiment, when the management tool receives an executable state of a volatile application program, if the data model of the executable state and the standard data model supported by the management tool for the “executable state” are the same or equal data models (i.e., the compatible data models), or when the management tool drives the “executable state”, the content of the “executable state” has no needs to be parsed. That is, it is only necessary to encapsulate its content into an execution request and then transmit the execution request to the startup module. The task of parsing the executable state is executed by the startup module. In any of the above situations, it means that the “executable state” can be directly used as the Event configuration content of an operable object and importing into the management tool without the need of undergoing any data format conversion. The “executable state” without the need of undergoing any data format conversion indicates that it is not necessary to re-organize the content of the executable state with other data models and model the content into a data entity in another format.

In an embodiment, when the data model used to generate the “metadata of the volatile application program” and the standard data model supported by the software system for the “executable object” are not the same and equal data model, and when the software system drives the executable object, it is necessary to parse the configuration content of the executable object. Under this circumstance, the “metadata of the volatile application program” can be processed through a metadata conversion program first. After the data format conversion is completed, it can be bound to an executable object.

In an embodiment, when the data model used to generate “the executable state of the volatile application program” and the standard data model supported by the software system for the “executable state” are not the same and equal data models, and when the management tool drives the executable state, it is necessary to parse the configuration content of the executable state. Under this circumstance, the “executable state of the volatile application program” can also be processed through a metadata conversion program first. After the data format conversion is completed, it can be bound to an executable event of an operable object.

In an embodiment, the configuration content bound to the executable object is generated by a metadata conversion program. The metadata conversion program uses a unified data model (i.e., a standard data model) to model the original content of the metadata of the volatile application program. Consequently, the metadata of the volatile application program is modeled as the at least one content bound to the executable object. In case that the data model of the metadata of the volatile application program and the unified data model are compatible data models, the at least one content is directly obtained from the original content of the metadata of the volatile application program. In case that the data model of the metadata of the volatile application program and the unified data model are incompatible data models, the at least one content is obtained indirectly by re-organizing the original content of the metadata of the volatile application program.

In an embodiment, the content bound to an executable event of an operable object is generated by a metadata conversion program. The metadata conversion program uses a unified data model (i.e., a standard data model) to model the original content of the executable state of a volatile application program. Consequently, the executable state of the volatile application program is modeled as the content that can be bound to the executable event of the operable object. In case that the data model of the executable object of the volatile application program and the unified data model are compatible data models, the content can be directly obtained from the original content of the executable state of the volatile application program. In case that the data model of the executable state of the volatile application program and the unified data model are incompatible data models, the content is obtained indirectly by re-organizing the original content of the executable state of the volatile application program.

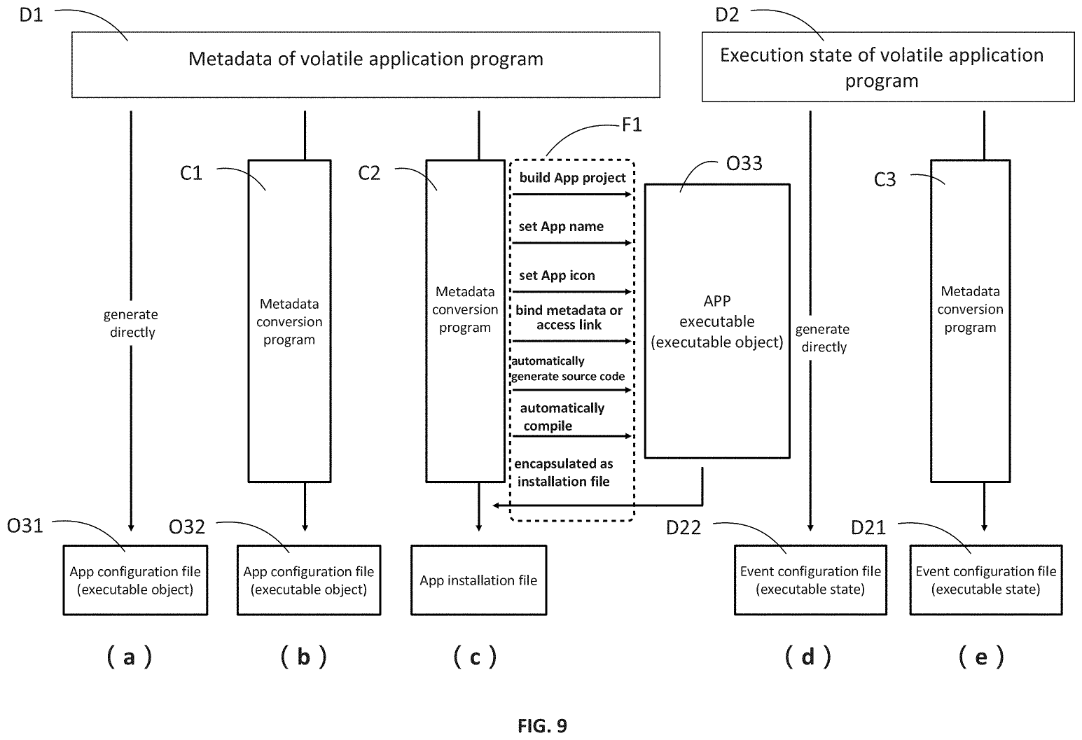

FIG. 9 schematically illustrates the operating concept of a metadata conversion program. The metadata D1 as shown in FIG. 9 and the metadata D1 as shown in FIG. 6 are the same or equal metadata. The executable state D2 as shown in FIG. 9 and the executable state D2 as shown in FIG. 6 are the same or equal executable states. In this context, the dynamic installation and/or the auto-provision in general situations can be completed without the need of using a “metadata conversion program”. However, in some other situations, the “metadata conversion program” is needed to assist in the data format conversion, so that the dynamic installation and/or the auto-provision is completed. Some exemplary methods of automatically generating the executable object and the operable state according to the requirements of the dynamic installation and/or the auto-provision in different situations and the implementation examples of various corresponding metadata conversion programs will be described as follows.

Firstly, please refer to the situation (a) of FIG. 9. An executable object O31 is provided to a software system in the form of an App configuration file, and the data models to generate the App configuration file and the metadata D1 are the same or equal data models. In this situation, the content of the metadata D1 can be directly written into the App configuration file without the need of performing any data format conversion. The App configuration file becomes the executable object O31 that can be launched by the software system. The executable object O31 can also be an App configuration object. Generally, the App configuration file is stored in the file system that is connected to the software system in the form of a file. In contrast, the App configuration object is stored in the database that is connected to the software system in the form of an object. The software system can read the App configuration object from the database and display it on the user interface for the user to execute.

Secondly, please refer to the situation (b) of FIG. 9. An executable object O32 is provided to a software system in the form of an App configuration file, and the data models to generate the App configuration file and the metadata D1 are different (incompatible) data models. In this situation, it is necessary for a metadata conversion program C1 to convert the data format of the metadata D1. Consequently, the executable object O32 to be provided to the software system can be generated. Firstly, the metadata conversion program C1 re-organizes the content of the metadata D1 according to the data model of the App configuration file, and models the content of the metadata D1 to the content of the App configuration file. Then, the modeled content is written into the App configuration file and saved into a file system. The software system can read, manage and launch the App configuration file according to the data model of the App configuration file. The executable object O32 can also be an App configuration object that is stored in the database.

Thirdly, please refer to the situation (c) of FIG. 9. An executable object O33 is provided to a software system in the form of an App executable (i.e., an executable application). In this situation, it is necessary for a metadata conversion program C2 to generate the executable application. As mentioned above, the operation process of the executable object itself is quite fixed. Consequently, the metadata conversion program C2 can be a code generator. After the App executable O33 compatible with the software system is generated automatically through an operation flow F1, the App executable O33 is encapsulated as an App installation file and provided to the software system for installation. Consequently, the executable object O33 can be launched by the software system immediately. It is noted that the implementation examples of the operation flow F1 are only non-limiting examples. The technologies of automatically generating a program with a fixed operation flow through a code generator are very popular. That is, those skilled in the art can make any equal design changes based on actual application requirements.

Fourthly, please refer to the situation (d) of FIG. 9. An executable state D22 is provided to the management tool in the form of an Event configuration file, and the data models to generate the Event configuration file and the executable state D2 are the same or equal data models. In this situation, the executable state D2 can be directly filled in the Event configuration file without the need of performing any data format conversion. The Event configuration file becomes the executable state D22 that can be driven by the management tool. The executable state D22 can also be an Event configuration object. Generally, the Event configuration file is stored in the file system that is connected to the management tool in the form of a file. In contrast, the Event configuration object is stored in the database that is connected to the management tool in the form of an object. The management tool can read the Event configuration object from the database. In addition, when the user executes a corresponding executable event, the Event configuration object is driven by the management tool.

Fifthly, please refer to the situation (e) of FIG. 9. The executable state D21 is provided to the management tool in the form of an Event configuration file. However, the data models of the Event configuration file and the executable state D2 are different (incompatible) data models. In this situation, it is necessary for a metadata conversion program C3 to convert the data format of the executable state D2. Consequently, the executable state D21 to be provided to the management tool can be generated. Firstly, the metadata conversion program C3 re-organizes the content of the executable state D2 according to the data model of the Event configuration file, and models the content of the executable state D2 to the content that matches the data model of the Event configuration file, i.e., the executable state D21. Then, the modeled content (i.e., the executable state D21) is written into the Event configuration file and saved into a file system that is connected to the management tool. Consequently, the management tool can load the Event configuration file from the file system, and read, manage and drive the Event configuration file according to the data model of the Event configuration file. The executable state D21 can also be an Event configuration object that is stored in a database, depending on whether the storage space connected with the management tool is based on the file system or the database.

In this context, the metadata conversion program can be integrated into any software module and/or application program in the form of a software component so as to be provided in the software system. As long as the service provider of the volatile application program can transmit the metadata of the volatile application program to the software module and/or the executable state in the form of a configuration or an access link, a corresponding App configuration file or an Event configuration file can be automatically generated by the software module and/or the application program. After binding an executable object or an operable object with the App configuration file or the Event configuration file, the task of dynamic installation and/or automatic provision of a volatile application program can be completed through the executable object or the task of the dynamic import of an operation process can be completed through the operable object.

It is noted that the implementation methods of the App configuration file, the App installation file, the Event configuration file and the metadata conversion programs are only non-limiting examples and not restricted. Those skilled in the art can make any equal design changes based on actual application requirements.

The present invention provides a method for dynamically installing a volatile application program for allowing a service provider to publish the volatile application program in an auto-provision manner so as to dynamically install the volatile application program in an operating system and/or a software platform. The operations of the method will be described as follows.

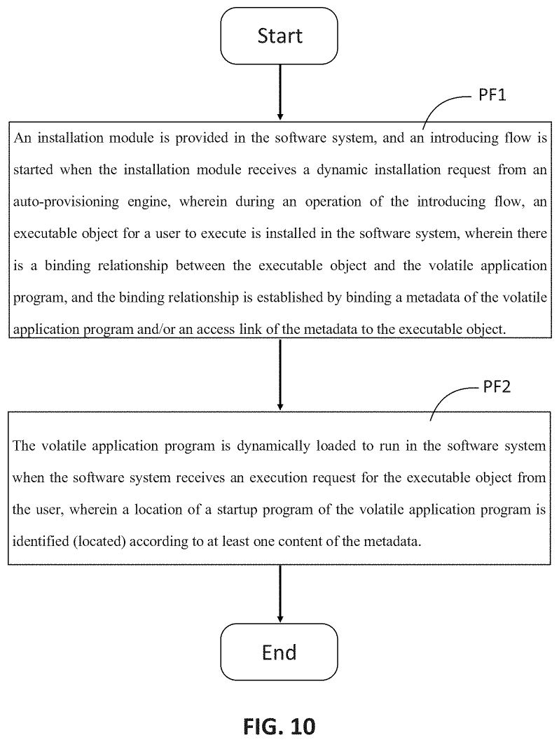

FIG. 10 is a flowchart illustrating a method for dynamically installing a volatile application program in a software system. The method for dynamically installing the volatile application program comprises the following steps.

Step PF1: providing an installation module in the software system, and starting an introducing flow when the installation module receives a dynamic installation request from an auto-provisioning engine, wherein during an operation of the introducing flow, an executable object for a user to execute is installed in the software system, wherein there is a binding relationship between the executable object and the volatile application program, and the binding relationship is established by binding a metadata of the volatile application program and/or an access link of the metadata to the executable object; and

Step PF2: dynamically loading and running the volatile application program in the software system when the software system receives an execution request for the executable object from the user, wherein a location of a startup program of the volatile application program is identified (located) according to at least one content of the metadata.

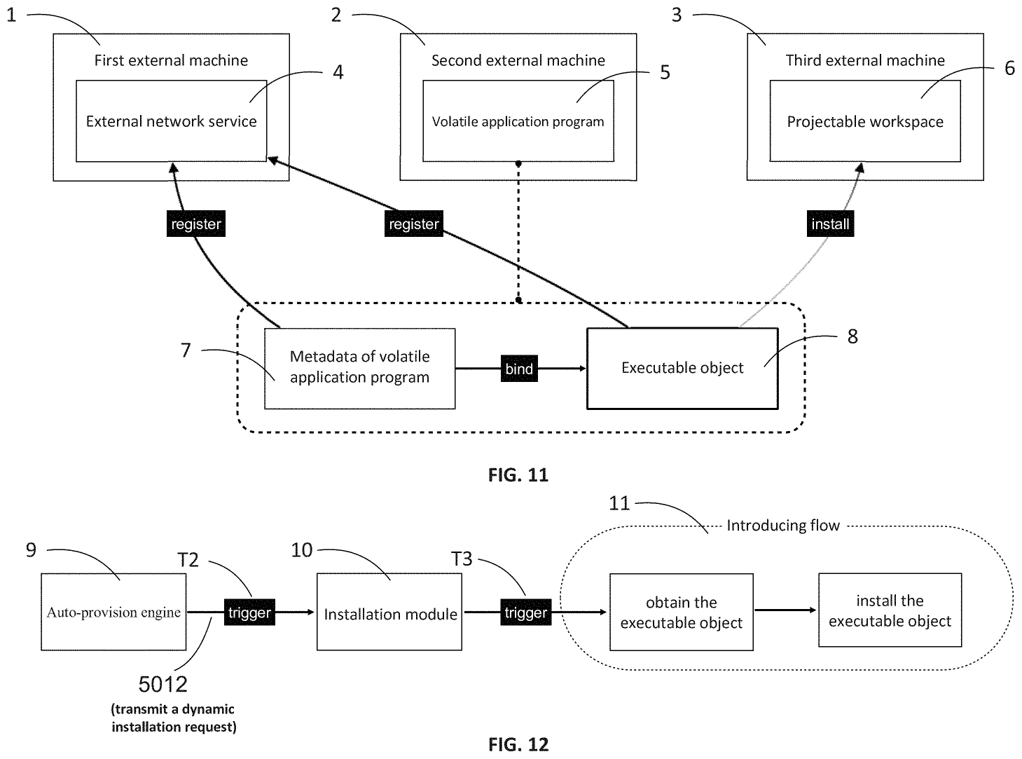

FIG. 11 schematically illustrates a resource allocation diagram of a volatile application program. A volatile application program 5 is deployed in the second external machine 2. The volatile application program 5 is a VoIP application designed by a service provider and is ready to deploy to provide Internet voice calls to its global employees. The volatile application program can be developed with the technical framework of a Web front-end application, a progressive web application or an instant application (Instant App). After the service provider completes the deployment of the volatile application program 5, the service provider completes the registration of the metadata 7 of the volatile application 5 in an external network service 4 (registration service) of the first external machine 1. In addition, the external network service 4 provides an access link for querying the metadata 7. The service provider is also a system vendor for its global employees. The service provider provides many software systems that are used in daily office work for its global employees. After the deployment of the volatile application program 5 is completed, the service provider also prepares an executable object 8 in advance and binds the executable object 8 to the metadata 7 of the volatile application program. In this embodiment, the executable object 8 is a pre-generated App configuration file, and the App configuration file can be installed or introduced into any software system that is provided to the employees around the world by the service provider. The software system can be an operating system, an application program or a projectable workspace. The service provider can also complete the registration for the executable object 8 in the external network service 4, and the external network service 4 provides an access link that can be used to obtain the executable object 8. The App configuration file is only a non-limiting embodiment of the executable object. That is, those skilled in the art can make any equal design changes based on actual application requirements after referring to the technologies of the present invention. The service provider can also install the executable object 8 into the projectable workspace 6 that is deployed in the third external machine 3. The projectable workspace 6 is a workspace that can be dynamically loaded to run. The data model of the unified tool in the projectable workspace 6 and the data model of the executable object 8 (i.e., the App configuration file) are the same or equal data models. Consequently, the executable object 8 is directly installed and configured in the workspace in the form of a unified tool.

In this embodiment, the “technologies of the projectable workspace and the unified tool” used herein may be referred to U.S. patent application Ser. No. 14/324,069, entitled “A METHOD OF UNIFYING INFORMATION AND TOOL FROM A PLURALITY OF INFORMATION SOURCES” and U.S. patent application Ser. No. 14/577,772, entitled “METHOD OF PROJECTING A WORKSPACE AND SYSTEM USING THE SAME”.

It is noted that the above methods of providing the access link for the App configuration file (e.g., a pre-generated executable object) through the external network service are only non-limiting examples. The implementation examples of providing the access link for the executable object are not restricted. The technical methods of publishing a configuration, an object and/or a file in a form of a resource to the internet and providing the access mechanism of the resource via a URI (uniform resource identifier) and/or API (application programming interface) (e.g., REST API or Web Server) are very popular. That is, those skilled in the art can make any equal design changes based on actual application requirements.

FIG. 12 schematically illustrates the operating concept of the path of a dynamic installation process of a volatile application program. In this context, the “introducing flow” is an operation process. The operation process starts from a procedure of “allowing an installation module to trigger the execution of a program block to dynamically install a volatile application program” and ends with a procedure of “installing and/or introducing an executable object to a storage space connected to the software system”. In the embodiment of FIG. 11, the service provider of the volatile application program 5 has implemented a variety of software systems to help its global employees to complete daily tasks more efficiently and manage them effectively. The software systems are served as the entrance for the global employees to access the enterprise resources. The software systems include the following aspects. Firstly, the service provider provides a customized mobile phone operating system based on the Android operating system for the mobile devices that are used by employees around the world. Secondly, the service provider provides a Windows application for the desktop computer devices that are used by employees around the world. Thirdly, the service provider provides a projectable workspace based on the Web technology architecture for the global employees, so that the global employees can dynamically load and run the projectable workspace in different devices in a cross-platform manner. When the customized mobile phone operating system, the Windows application and the projectable workspace run on a computing device, an operating environment will be provided. Consequently, the employees can access various resources of the enterprise through the operating interface that is constructed by the operating environment.

In the past, when the service provider completes a brand-new tool (e.g., an application program) for the global employees, the service provider had to implement the brand-new tool as a non-volatile application program. Then, the employee downloads and installs the brand-new tool into the customized mobile phone operating system through continuous notifications. Alternatively, the service provider integrates the operating interface of the brand-new tool into the Windows application through system integration in the form of a software component, and then the makes its global employees update the Windows application or the software component library of the Windows application. Alternatively, the service provider installs and introduces the brand-new tool into the projectable workspace in the form of a unified tool, and the global employees are only permitted to operate the brand-new tool through the projected workspace, which is dynamically loaded and activated from the projectable workspace. Regardless of whether the release of non-volatile application program, the update of the software component or the Windows application, or the centralized management of the projectable workspace, there are bottlenecks in cost and benefit.

In an embodiment, the present invention provides the following method. Firstly, the service provider can design the brand-new tool as a volatile application program. The volatile application 5 in FIG. 11 is an example. Then, the service provider can apply the method of the present invention to the customized mobile phone operating system and the Windows application to implement an operating environment that can be used to manage and drive an executable object. Then, the service provider can provide an installation module 10 in the customized mobile phone operating system and the Windows application. The installation module 10 is a software module that can be provided in the customized mobile phone operating system in the form of an application program or a software agent program, or the installation module 10 is integrated into the Windows application in the form of a class library, a software component or an executable program block. The implementation of the installation module 10 can be referred to the contents of the present invention associated with various embodiments of the “trigger” and the “data transmission connection”. Some implementation examples will be described as follows. Firstly, an application programming interface is provided to receive a function call from a software module and/or an executable program block of the same software system. Secondly, an additional application programming interface is provided to receive a remote procedure call from a software module and/or an executable program block of another machine. Thirdly, an interprocess communication technology is used to provide an interprocess communication service, or a socket connection technology is used to provide a socket connection service to receive events from different OS processes or different network services. The application programming interface, the additional application programming interface, the interprocess communication service and the socket connection service are used to allow the installation module to receive “triggers” from other software modules, OS processes, network services or executable blocks and thus acquires a dynamic installation request from the “data transmission connections” followed by the “triggers”. For example, dynamic installation request is obtained from the parameter content of the application programming interface or the event content transmitted from different network services. The implementation method of “trigger” and “data transmission connection” can be referred to the various embodiments of the present invention but not limited thereto. Those skilled in the art can make any equal design changes based on actual application requirements after referring to the technologies of the present invention.

In an embodiment, whenever the installation module 10 receives a trigger and receives a dynamic installation request, the installation module 10 can install an executable object of a volatile application program to the customized mobile phone operating system or the Windows application according to the content of the dynamic installation request. After the installation of the executable object is complete, the executable object becomes an executable entity on the user interface of the customized mobile phone operating system or the Windows application. When the user clicks the executable entity on the user interface, a corresponding execution request will be sent to a startup module, and the startup module will dynamically load and run the volatile application program 5. For the customized mobile phone operating system, the installation module and the startup module can be the same application program and be executed in the same OS process, or the installation module and the startup module can also be different application programs and executed in different OS processes. Alternatively, the installation module and the startup module are the same application program. However, when the executable object is executed by the user, the customized mobile phone operating system instantiates a brand-new OS process and drives the startup module in the brand-new OS process. That is, whenever the volatile application program is dynamically loaded to run, the task of dynamically loading and running the volatile application program is completed through an independent OS process. For the Windows application, the installation module and the startup module can be implemented in the same software component or in two different software components, and executed in the same OS process (i.e., the OS process of the Windows application).

In an embodiment, after the service provider completes the design and deployment of the volatile application program 5, the original content of the metadata 7 of the volatile application program 5, the access link of the original content of the metadata 7 (e.g., provided by the external service 4 in this embodiment), the executable object 8 or the access link of the executable object 8 (e.g., provided by the external service 4 in this embodiment) is encapsulated as a dynamic installation request through an auto-provisioning engine 9. Then, through the triggering method provided by the installation module 10, the auto-provisioning engine 9 executes a trigger T2 on the installation module 10. The purpose of the trigger T2 is to submit a request 5012. The purpose of the request 5012 is to transmit the dynamic installation request to the installation module 10. Consequently, the installation module 10 is driven to complete an auto-provision task for the volatile application program 5 in order to expand the functions of the customized mobile phone operating system and the Windows application. After receiving the dynamic installation request, the installation module 10 can execute a trigger T3 to drive an introducing flow 11. Consequently, the executable object of the volatile application program 5 is acquired according to the content of the dynamic installation request, and the executable object of the volatile application program 5 is installed or introduced to the customized mobile phone operating system or the Windows application. The method of generating an executable object according to the metadata of the volatile application program and/or its access link can be referred to the various embodiments in FIG. 9 of the present invention and implemented accordingly, but not limited thereto. Those skilled in the art can make any equal design changes based on actual application requirements after referring to the technologies of the present invention. In case of the executable object 8 of the volatile application program 5 compatible with the operating environment of the customized mobile phone operating system and the Windows application. After the installation module 10 reads the executable object 8 from the content of the dynamic installation request or obtains the executable object 8 through the access link of the executable object 8, the installation module 10 can directly complete the installing and introducing tasks. In case of the executable object 8 incompatible with the operating environment of the customized mobile phone operating system and the Windows application. The installation module 10 can acquire the content of the executable object 8 first, then regenerate a compatible executable object according to the metadata 7 of the volatile application program 5 or its access link that bound to the content of the executable object 8, and finally complete the installing and introducing tasks.

In an embodiment, the metadata content of a volatile application program and the relevant executable program block of the volatile application program are pointed by the same network address. That is, the “access link” used to query and/or acquire the metadata content of the volatile application program is the “network address” used to dynamically load and run the volatile application program. For example, after a Web front-end application as a volatile application program is deployed, the service provider of the Web front-end application can set a network address for the Web front-end application on a Web server. The network address is the network address that is used when the Web front-end application is dynamically loaded to run. The engineering developer can provide at least one content of the metadata of the volatile application program in the HTTP Response Headers of the network address. Any software system can obtain the relevant executable program block of the Web front-end application by issuing an HTTP GET request to the network address, or the software system can also obtain all HTTP Response Headers related to the network address (i.e., at least one content containing the metadata of the Web front-end application) by issuing a HTTP HEAD request to the network address. In this way, the access link of the metadata of the Web front-end application (i.e., the volatile application program) and the dynamic loading location of the Web front-end application can be the same network address. The response of the HTTP GET request can also contain the metadata content of the Web front-end application in its HTTP Response Headers. The methods of using the same or equal network address as the access link for the metadata of the volatile application program and the network address for dynamically loading and running the volatile application program are non-limiting examples. Those skilled in the art can make any equal design changes based on actual application requirements after referring to the technologies of the present invention.

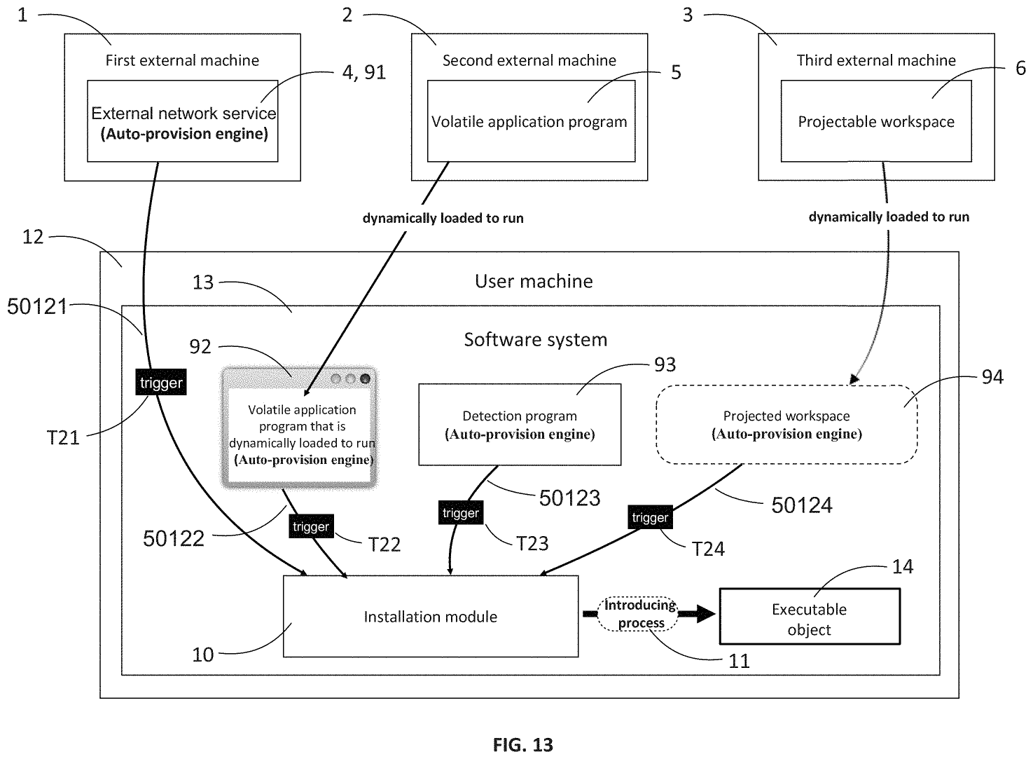

FIG. 13 schematically illustrates the network configuration for dynamically installing a volatile application program. Please also refer to FIGS. 11 and 12. The first external machine 1 as shown in FIG. 13 and the first external machine 1 as shown in FIG. 11 are the same or equal first external machines. The second external machine 2 as shown in FIG. 13 and the second external machine 2 as shown in FIG. 11 are the same or equal second external machines. The third external machine 3 as shown in FIG. 13 and the third external machine 3 as shown in FIG. 11 are the same or equal third external machines. The external network service 4 as shown in FIG. 13 and the external network service 4 as shown in FIG. 11 are the same or equal external network services. The volatile application program 5 as shown in FIG. 13 and the volatile application program 5 as shown in FIG. 11 are the same or equal volatile application programs. The projectable workspace 6 as shown in FIG. 13 and the projectable workspace 6 as shown in FIG. 11 are the same or equal projectable workspaces. The installation module 10 as shown in FIG. 13 and the installation module 10 as shown in FIG. 12 are the same or equal installation modules. The introducing flow 11 as shown in FIG. 13 and the introducing flow 11 as shown in FIG. 12 are the same or equal introducing flows. The triggers T21, T22, T23 and T24 as shown in FIG. 13 and the trigger T2 as shown in FIG. 12 are the same or equal triggers. The requests 50121, 50122, 50123 and 50124 as shown in FIG. 13 and the request 5012 as shown in FIG. 12 are the same or equal requests. The auto-provisioning engines 91, 92, 93 and 94 as shown in FIG. 13 and the auto-provisioning engine 9 as shown in FIG. 12 are the same or equal auto-provisioning engines. The software system 13 as shown in FIG. 13 is the customized mobile phone operating system or the Windows application that is provided for the global employees from the service provider. The dynamically-loaded volatile application program 92, which has been dynamically loaded and run, represents the operating environment that is generated by the volatile application program 5 after the volatile application program 5 is dynamically loaded to run on the software system 13.

In an embodiment, the auto-provisioning engine 9 can be implemented through a network service, a detection program, an application program or a projected workspace. The network service is an external network service 4 or 91 running on a different machine from the software system 13. The detection program 93 is a software module or an executable program block that is executed in the software system 13. The application program is a dynamically-loaded volatile application program 92 that has been dynamically loaded and run in the software system 13. The projected workspace 94 is an operating environment. The operating environment is the operating environment generated in the user interface of the software system 13 after the projectable workspace 6 is dynamically loaded to run on the software system 13.

In an embodiment, after the service provider registers the metadata 7 of the volatile application program 5 or the executable object 8 to the external network service 4 or 91, basically, the external network service 4 or 91 has completely mastered all the necessary information that can be used to generate a dynamic installation request. Consequently, the external network service 4 or 91 can be implemented as an auto-provisioning engine. When the service provider completes the registration of the volatile application program 5 in the external network service 4 or 91, the external network service 4 or 91 can directly generate a dynamic installation request, and the original content of the metadata 7, the access link of the metadata 7, the executable object 8 and/or the access link of the executable object 8 are encapsulated in the dynamic installation request. In addition, the external network service 4 or 91 executes a trigger T21 on the installation module 10 through the triggering method provided by the installation module 10, and transmits the dynamic installation request to the installation module 10 through the trigger T21 so as to drive the installation module 10 to install a corresponding executable object 14 to the software system 13 for the volatile application program 5. In the implementation of trigger T21, a network connection (TCP/IP socket connection) connected to the installation module 10 can be established by the external network service 4 or 91, and the dynamic installation request is transmitted to the installation module 10 through the network connection. In a preferred embodiment, when the installation module 10 is activated on the computing device of each employee, the IP address of the computing device and the port number used by the installation module 10 will be updated to a database that can be accessed by the external network service 4 or 91. Consequently, the external network service 4 or 91 can obtain the IP addresses of the computing devices used by the global employees and the port numbers used by the installation module 10 after querying the database to establish the network connection (TCP/IP socket connection) and create the network connection to connect the installation module 10 in each employee's computing device. Then, the triggering work of the dynamic installation request can be executed for each computing device, and the auto-provision task can be completed. The installation module 10 is a network server (e.g., a socket server) that receives the connection request through the network connection by publishing an IP address and a port number and receives the dynamic installation request through the network connection.

In an embodiment, after the service provider registers the metadata 7 of the volatile application program 5 or the executable object 8 to the external network service 4 or 91, the original content of the metadata 7, the executable object 8, the access link of the metadata 7 and/or the access link of the executable object 8 are all set in a storage space that the volatile application program 5 can be connected to during the runt time. Consequently, after the volatile application program 5 is dynamically loaded to run, the necessary information for generating a dynamic installation request can be retrieved from the storage space. In this way, the dynamically-loaded volatile application program 92 itself is implemented as an auto-provisioning engine. When the volatile application program 5 is dynamically loaded to run in a browser in the form of a Web front-end application or the volatile application program 5 is dynamically loaded to run on an Android mobile phone operating system in the form of an Android instant application, the dynamically-loaded volatile application program 92 generates a dynamic installation request during the runt time. Then, through the triggering method provided by the installation module 10, the dynamically-loaded volatile application program 92 executes a trigger T22 on the installation module 10 and transmits the dynamic installation request to the installation module 10 through the trigger T22. Consequently, the installation module 10 is driven to install a corresponding executable object 14 to the software system 13 for the volatile application program 5. The implementation of trigger T22 can be completed through the data transmission connection of the internal system. Since the dynamically-loaded volatile application program 92 and the installation module 10 are operated in the same computing device, the volatile application program 92 can execute the trigger T22 through the function call of the internal system or the communication between OS processes. The dynamic installation request is transmitted to the installation module 10 through the trigger T22. Consequently, the installation module 10 is driven to install a corresponding executable object 14 to the software system 13 for the volatile application program 5. In an implementation example of the trigger T22, the installation module 10 can be implemented as a Web server, and an HTTP API for receiving the dynamic installation request is published. Consequently, even if the volatile application program 92 runs on a sandbox environment of a browser, a network connection can still be established to connect the local (IP 127.0.0.1) Web server. Then, the dynamic installation request is issued to the installation module 10. In this way, even if the volatile application program 5 deployed in the second external machine 2 has never been technically integrated with the software system 13 and no executable object for activating the volatile application program 5 has been installed in the software system 13. As long as the user can execute the volatile application program 5 in the user machine 12 that is operated by the user after the service provider completes the deployment of the volatile application program 5 in the second external machine 2. During the runt time of the volatile application program 5, the volatile application program 5 can automatically provision itself in the software system 13.

In an embodiment, the service provider can provide a detection program 93 to the software system 13. The detection program 93 can periodically inquire the external network service 4 or 91 in a polling manner to inquire whether any new volatile application program is registered and needed to be automatically provisioned in the software system 13. For example, after the volatile application program 5 is registered in the external network service 4 or 91 and found by the detection program 93 in the polling manner, the detection program 93 can issue a request to the external network service 4 or 91 to acquire the metadata 7 of the volatile application program 5, the access link of the metadata 7, the executable object 8 and/or the access link of the executable object 8. And then, after the metadata 7 of the volatile application program 5, the access link of the metadata 7, the executable object 8 and/or the access link of the executable object 8 are encapsulated as a dynamic installation request by the detection program 93, the detection program 93 can execute a trigger T23 through the triggering method provided by the installation module 10 with the function call of the internal system or the communication between OS processes. The dynamic installation request is transmitted to the installation module 10 through the trigger T23. Consequently, the installation module 10 is driven to install a corresponding executable object 14 to the software system 13 for the volatile application program 5. In a preferred embodiment, the detection program 93 can immediately issue a dynamic installation request for a volatile application program when detecting the volatile application program. Alternatively, after the detection program 93 detects at least one volatile application program, at least one attribute of the at least one volatile application program (e.g., the at least one attribute is obtained from the content of its metadata) is displayed on the user interface for the user to select or for the user to decide whether to perform dynamic installation. Then, according to the user's operation instruction, a corresponding dynamic installation request is issued for at least one volatile application program required by the user. If the software system 13 is a mobile phone operating system, the detection program 93 and the installation module 10 can be software modules that are operated independently and executed in different OS processes. The detection program 93 can transmit the dynamic installation request to the installation module 10 by triggering between OS processes. If the software system 13 is a Windows application, the detection program 93 and the installation module 10 will be executed in the same OS process. Consequently, the detection program 93 can execute the trigger T23 through a function call. In an embodiment, the detection program 93 can periodically inquire the external network service 4 or 91 in a polling manner. Alternatively, the detection program 93 can search different connected devices in the network through a multicast method. Due to the interaction between different connected devices, the volatile application program, for managing, controlling, monitoring and/or operating the services of these connected devices can be inquired. The technical methods of providing a software module (e.g., the detection program 93) to search or detect various connected devices and/or software services in the network and obtain its metadata are very popular. The polling method and the multicast method are only non-limiting examples. That is, those skilled in the art can make any equal design changes based on actual application requirements.

In an embodiment, the service provider can install the executable object 8 of the volatile application 5 into a projectable workspace 6 in the third external machine 3. When the projectable workspace 6 is dynamically loaded to run on the software system 13, the projected workspace 94 (i.e., the operating environment generated according to the physical content of the projectable workspace 6 after the projectable workspace 6 is dynamically loaded to run) is an auto-provisioning engine. An export program may be provided in the projected workspace 94. By the export program, the complete content of the executable object 8 installed in the workspace or the metadata 7 bound to the executable object 8 is encapsulated as a dynamic installation request. Then, the triggering method provided by the installation module 10 can be used for executing a trigger T24 through the function call of the internal system or the communication between OS processes. The dynamic installation request is transmitted to the installation module 10 through the trigger T24. Consequently, the installation module 10 is driven to install a corresponding executable object 14 to the software system 13 for the volatile application program 5.

In an embodiment, when the installation module 10 runs on the software system 13, the installation module 10 itself or another software module in the software system 13 can also provide a user interface for the user to operate. In the user interface, the user actively inputs the metadata 7 of the volatile application program 5, the access link of the metadata 7, the executable object 8 and/or the access link of the executable object 8. Then, the relevant information inputted by the user through the user interface is encapsulated as a dynamic installation request. The dynamic installation request is transmitted to the installation module 10. Consequently, the installation module 10 is driven to install a corresponding executable object 14 to the software system 13 for the volatile application program 5.

In an embodiment, the executable object 8 is compatible with the operating environment that is provided by the software system 13. In the introducing flow 11, the executable object 8 can be directly installed in the software system 13 by the installation module 10. That is, in this situation, the executable object 8 and the executable object 14 are the same entity. For example, the executable object 8 and the executable object 14 are the same App configuration file. However, in case that the executable object 8 is incompatible with the software system or the auto-provisioning engine 91, 92, 93 or 94 is unable to effectively obtain the complete content and the access link of the executable object 8 when encapsulated in a dynamic installation request, the executable object 14 compatible with the software system 13 can be generated by the auto-provisioning engine 91, 92, 93 or 94 through a metadata conversion program. Then, the executable object 14 generated through the metadata conversion program is encapsulated into the dynamic installation request. Then, the dynamic installation request is transmitted to the installation module 10. B y referring to the above embodiments of the metadata conversion program, the executable object 14 compatible with the software system 13 can be generated by the auto-provisioning engine 91, 92, 93 or 94 through the metadata conversion program according to the content of the metadata 7 and/or the access link of the metadata 7. In another embodiment, after the metadata 7 of the volatile application program 5 and/or its access link is encapsulated into the dynamic installation request, the dynamic installation request is transmitted to the installation module 10. Then, the installation module 10 generates the executable object 14 through the metadata conversion program and install the executable object 14 into the software system 13. By referring to the above embodiments of the metadata conversion program, the metadata conversion program generates the executable object 14 compatible with the software system 13 according to the technical standards of the software system 13 and the content of the metadata 7. Consequently, the executable object 14 compatible with the software system 13 can be generated by the installation module 10 through the metadata conversion program according to the content of the metadata 7 and/or the access link of the metadata 7.

It is noted that the implementation examples of the triggers T21, T22, T23 and T24 are not restricted. The technologies about data transmission connection and data interaction are very popular. Those skilled in the art can make any equal design changes based on actual application requirements.

Through the various methods mentioned above, the service provider only needs to introduce one universal installation module 10 into the software system 13 on the user machines 12 of its employees around the world, and then can automatically install any kind of client software into the computing device (i.e., the user machine 12) operated by each employee in the form of volatile application programs. The service provider can open the auto-provisioning engine that it uses to business partners in the supply chain. For example, the service provider can open the external network service 4, 91 for the business partners to use. Consequently, any client software deployed by different companies in different computer rooms and different domains, as long as the client software is a volatile application program, the following procedures can be performed. That is, after the client software is deployed, there is no need to do any system integration with the software system 13 on the user machine 12, and an executable object that can be used to drive the client software can be automatically provisioned into the software system 13 through the external network service 4, 91. If the software system 13 is the operating system in the user machine 12, the software system 13 becomes an operating system that can install and activate volatile application programs from different sources. If the software system 13 is a native application on the user machine 12, the software system 13 becomes a super application that can install and activate volatile application programs from different sources.

In an embodiment, the software system 13 is a volatile application program provided by the external network service 4,91. For example, the volatile application program is a Web front-end application, a progressive web application or an instant application. Consequently, the software system 13 can be provided to the user machine 12 in a dynamic loading and running manner. The software system 13 that is used as the volatile application program provided by the external network service 4,91, the executable object 14 can be stored in a database that is accessed by the external network service 4, 91 in the form of an App configuration object. After the software system 13 is dynamically loaded to run on the user machine 12, all App configuration objects (including the executable object 14) in the database can be queried and the corresponding executable entity for each App configuration object (i.e., the executable object) is generated on a user interface for the user to operate. The user can click each executable entity on the user interface to launch the volatile application program corresponding to each executable entity. Due to this design model, a super app in the form of a volatile application program can be implemented.

In an embodiment, through the method of the present invention, the software system 13 does not need to be integrated with the volatile application program 5 (e.g., the VoIP application). However, after the volatile application program 5 is dynamically loaded to run, software system 13 can provide the life cycle management on the execution of the OS process of the volatile application program 5. For example, when the user pushes the OS process from the foreground to the background, the software system 13 can issue an event to notify the volatile application program 5 to suspend all computing services. When the user closes the OS process, the software system 13 can issue an additional event to notify the volatile application program 5 to release all system resources. However, the way that the volatile application program 5 handles the event and the additional event is determined by the volatile application program 5 on its own.

In an embodiment, when the user clicks on the executable entity corresponding to the executable object 14 on the user interface of the software system 13, the software system 13 issues an execution request to a startup module through a trigger. Consequently, the startup module dynamically loads and runs the volatile application program 5. While the startup module dynamically loads and runs the volatile application program 5, a state setting is transmitted to the volatile application program 5 in the form of parameters. The state setting may contain the system environment configuration of the user machine 12 (e.g., the associated hardware information of the computing device), the application configuration required for executing the volatile application program (e.g., the account information of the user) or the application state (e.g., the default state when the volatile application program 5 is executed). Consequently, during the runt time, the volatile application program 5 can adjust the internal application state according to the state setting. In a preferred embodiment, the account information required for executing the volatile application program can be acquired from the system environment configuration of the user machine 12. In the dynamic loading process, the startup module issues a request to the operating system environment of the user machine 12 to acquire an account information that is enabled, registered or bound in the operating system environment. In addition, the account information is used as the application configuration for executing the volatile application program. Consequently, the single sign-on function can be achieved.

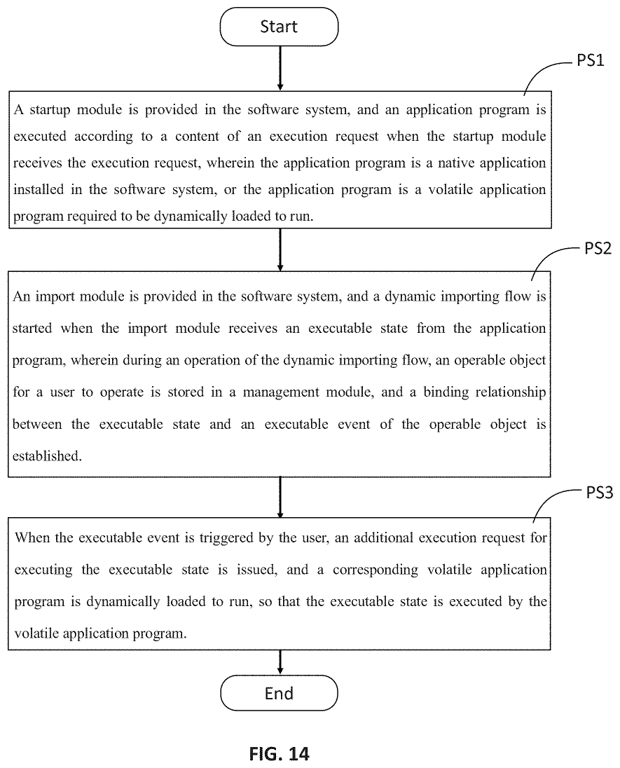

FIG. 14 is a flowchart of a method of dynamically importing an operation process in a software system according to an embodiment of the present invention. The method of dynamically importing the operation process comprises the following steps:

Step PS1: providing a startup module in the software system, and executing an application program according to a content of an execution request when the startup module receives the execution request, wherein the application program is a native application installed in the software system, or the application program is a volatile application program required to be dynamically loaded to run;

Step PS2: providing an import module in the software system, and starting a dynamic importing flow when the import module receives an executable state from the application program, wherein during an operation of the dynamic importing flow, an operable object for a user to operate is stored in a management module, and a binding relationship between the executable state and an executable event of the operable object is established; and

Step PS3: when the executable event is triggered by the user, an additional execution request for executing the executable state is issued, and a corresponding volatile application program is dynamically loaded to run, so that the executable state is executed by the volatile application program.

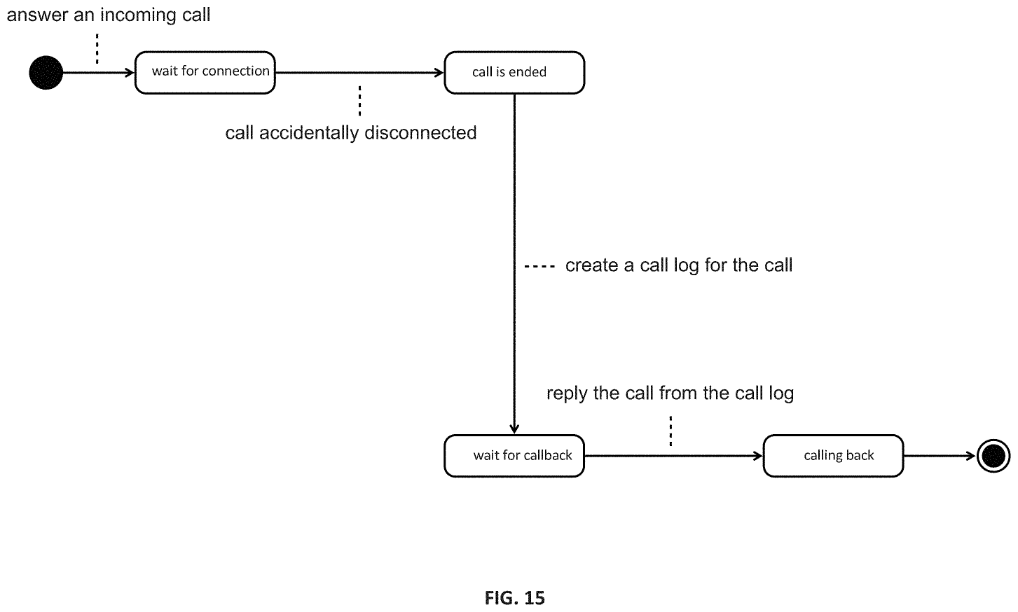

FIG. 15 is a flowchart of an operation process of a voice communication according to an embodiment of the present invention. In the voice communication process, a callee of a voice call receives a voice call, then the incoming call is connected, then the voice call is ended, and then the callee calls back the caller through the call log of the voice call. An implementation example of the operation process will be described as follows. Firstly, the mobile phone operated by the callee receives an incoming call notification of a voice call from the caller. The caller initiates the voice call through an application program, and the incoming call notification of the voice call is delivered to the callee's mobile phone through the telecommunication network or the notification channel of the internet. After receiving the incoming call notification, the application program will be driven to generate an incoming call screen for the voice call on the user interface of the mobile phone. After the user performs the “answer” action on the voice call, the in-call screen of the voice call will be displayed on the user interface of the mobile phone, and then the operation process will enter the “waiting for connection” state to wait for the connection of the voice call. In this state, if the signal of the telecommunications network or the internet is poor, the connection of the voice call will fail, and the operation process will enter a “call ended” state. Whenever the call is ended, the application program will generate a call log in the management tool (i.e., a call log management tool) of the mobile phone, and the operation process will immediately enter the “waiting for callback” state. The callee can execute the management tool on the mobile phone to view the call log and call back to the caller on the call log info screen. On the user interface of the mobile phone, a dialer screen will be executed. Consequently, the operation process will enter the “calling back” state.

In an embodiment, the call log info screen is provided by the management tool.

In an embodiment, the incoming call screen, the in-call screen and the dialer screen are provided by different application programs. For example, when the use presses down the “answer” button on the incoming call screen, the incoming call screen drives the second application program to generate the in-call screen through an event triggering operation. In addition, the second application program executes the task of answering the voice call. When the user presses down the “callback” button on the call log info screen, the call log info screen drives a third application program to generate the dialer screen through another event triggering operation. In addition, the third application program executes the callback task. In the above scenario, various states in the operation process are executed by different application programs.

In an embodiment, the incoming call screen, the in-call screen and the dialer screen are provided by the same application program. For example, each state in the operation process and its corresponding computing task are implemented into the project of the same application program. That is, the same application program in the mobile phone provides the incoming call screen, the in-call screen and the dialer screen.

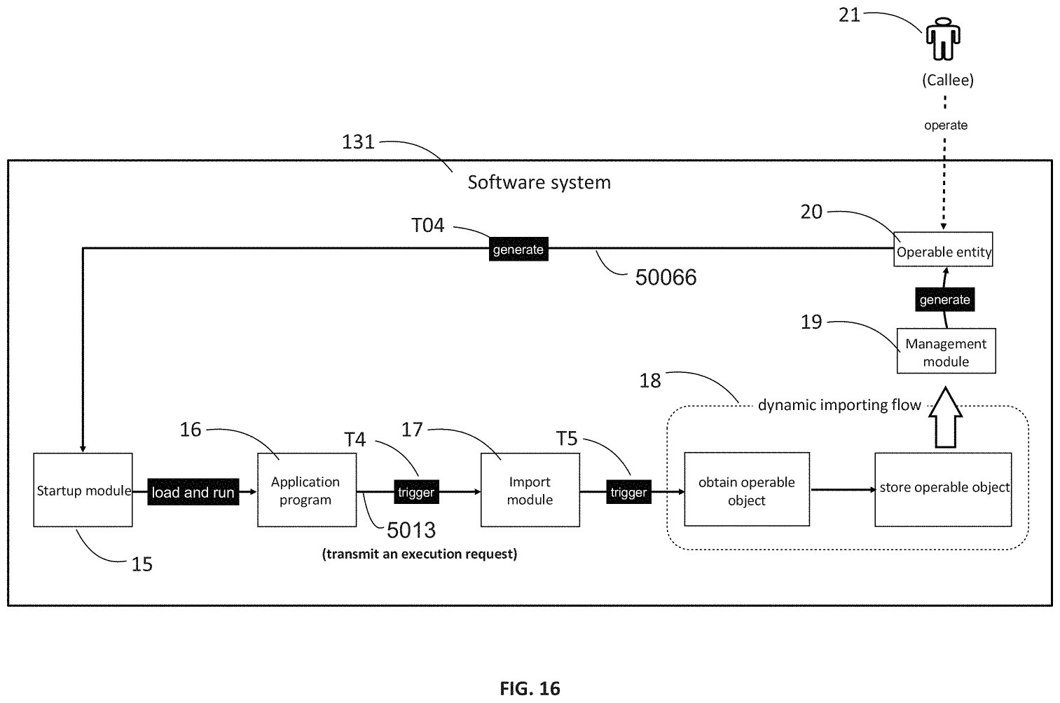

FIG. 16 schematically illustrates the concept of the operating path of a dynamic importing flow of an operation process according to an embodiment of the present invention. The software system 131 as shown in FIG. 16 and the software system 13 as shown in FIG. 13 are the same or equal software systems. The trigger T04 as shown in FIG. 16 and the trigger T0 as shown in FIG. 3 are the same or equal triggers. The request 50066 as shown in FIG. 16 and the request 50065 as shown in FIG. 8 are the same or equal requests. In this context, the term “dynamic importing flow” used herein is an operation process. Moreover, the operation process is started from “the procedure of triggering the execution of a program block to dynamically import an executable state by an import module” and ended by performing “a procedure of binding the executable state to an operable object and storing the operable object into a storage space connected with a management tool”. By using the method of the present invention, the system vendor of the software system can dynamically import the operation process of an application program into the software system it provides, and make the operating environment of the software system become the driving environment of an application state engine. The software system is an operating system, a super app and/or a software platform.

Take the dynamic importing flow of FIG. 16 and the voice communication of FIG. 15 for example. Firstly, the system vendor can provide a software system 131 in the mobile phone of the callee 21 and provide a startup module 15 of an application program, an import module 17 of an executable state and a management module of an operable object 19 in the software system 131. The application program is an application program that can be used to answer a voice call. The executable state is the executable state of a volatile application program. In addition, the content of the executable state contains a state setting that is used to call back to the caller of the voice call (e.g., the user ID of the caller). When the executable state is triggered and activated, the volatile application program will be dynamically loaded to run. After the internal application state be adjusted according to the state setting during the runt time, the volatile application program will dial the caller. The operable object is a call log of a network voice call.

In an embodiment, when the software system 131 receives an incoming call notification of a voice call in the runt time, the incoming call notification is transmitted to the startup module 15, and the startup module 15 loads and runs an application program 16 in the mobile phone. Then, according to the content of the incoming call notification, the application program 16 generates an incoming call screen for the callee 21 to operate. After the callee 21 presses down the “answer” button in the incoming call screen, the application program 16 itself can execute the task of connecting the voice call. In addition, the application program 16 generates the in-call screen on the screen of the mobile phone, so that the callee 21 can further handle the connection state of the voice call and perform operations on the voice call. At the end of the voice call, the application program 16 will generate an executable state, and write the metadata of a volatile application program and a state setting into the executable state. The volatile application program is an application program that can be used to make voice calls, and the metadata of the volatile application program is written in the executable state in the form of the original content, the partial content or the access link. The state setting contains relevant information (e.g., the user ID of the caller) required to control the volatile application program to dial. Consequently, after the volatile application program is dynamically loaded to run, the volatile application program can adjust the internal application state according to the content of the state setting and dial the user ID of the caller. After the executable state is generated, the application program 16 submits a request 5013 through a trigger T4. The purpose of the request 5013 is to transmit the relevant information of the voice call and an executable state for dialing (calling back) the caller to an import module 17. The executable state is one of at least one executable state used to link to an operation flow. The voice communication callback process of this embodiment is a non-limiting example of the operation process. The operation process is not restricted. After the import module 17 receives the relevant information of the voice call and the executable state, a dynamic importing flow 18 can be started. In the operation process of the dynamic importing flow 18, the import module 17 can trigger a program block to execute the dynamic importing task of the executable state through the trigger T5. After the program block obtains the relevant information of the voice call and the executable state from the trigger T5, a call log corresponding to the voice call is generated, and a binding relationship between an executable event for “callback” and the executable state is established in the call log. Then, the call log and the executable state are used as an operable object, which is stored into a file system or a database linked to a management module 19. In an embodiment, the executable state is stored into the file system or the database linked to the management module 19 in the form of an Event configuration file or an Event configuration object. When the callee 21 executes the management module 19 in the software system, the call log can be found through its user interface, and the management module 19 can instantiate an operable entity 20 for the callee 21 to operate. The call log I2 as shown in FIG. 5 is an example of an executable entity of a call log. Then, the callee 21 can press down the “callback” button through the executable entity 20 of the call log in order to call back to the caller of the call log. The implementation examples of the triggers T4 and T5 and the technologies about data transmission connection and data interaction are very popular. Those skilled in the art can make any equal design changes based on actual application requirements.

In an embodiment, the content of the metadata of the volatile application program can be written into the Response Headers of the network address that is used for dynamically loading and running the volatile application program (i.e., the application program for making voice calls). That is, the network address and the access link for obtaining the at least one content of the metadata of the volatile application program can be the identical network address.

In an embodiment, the data model of the executable state is compatible with the operable objects of the management module 19. In the dynamic importing flow 18, the program block triggered by the import module 17 through the trigger T5 can directly bind the executable state to the operable object and stores the operable object into the storage space that is connected to the management module 19. That is, in this situation, the executable state itself is the Event configuration file or the Event configuration object bound to the operable object. However, in case that the data model of the executable state is not compatible with the operable objects of the management module 19, a compatible executable state will be generated by the import module 17 through a metadata conversion program. In the dynamic importing flow 18, the program block triggered by the import module 17 through the trigger T5 will bind the compatible executable state (i.e., an executable state generated accordance to a data model compatible with the operable object) to the operable object. In another embodiment, regardless of whether the data model is compatible with the operable objects of the management module 19, the import module 17 directly sends the executable state to the program block of the management module 19 through the trigger T5 after the executable state is received. The management module 19 uses a metadata conversion program to generate a compatible executable state. After the compatible executable state is bound to an operable object, the operable object is stored into in the storage space that is connected to the management module 19. By referring to the above embodiments of the metadata conversion program, the incompatible executable object can be rearranged and converted into the compatible executable state through the metadata conversion program according to the data model of the operable object.

In an embodiment, when the callee 21 presses down the “callback” button, the execution of the executable event (i.e., callback) is triggered. In the management module 19, the executable state (Event configuration) that is bound to the executable event can be encapsulated into an execution request by a program block responsible for processing the executable event. The execution request is transmitted to the startup module 15 through a trigger T04. The startup module 15 determines (locates) a network address that can be used to dynamically load and run a volatile application program according to the content of the executable state in the execution request. Then, the volatile application program can be dynamically loaded to run in the mobile phone via the network address.

In an embodiment, when the management tool generates the executable entity 20 for the call log, the “callback” button in the user interface of the executable entity 20 is dynamically added according to the content of the executable state. The implementation method of dynamically adding an executable event to an executable entity through the content of the executable state can be described with an embodiment on the basis of FIG. 7. In FIG. 7, D21 is the executable state of a volatile application program. In the content of the executable state, a type and/or a style can be specified for the visualization element that is used to drive the executable state, and an operable event provided by the visualization element can be used as the executable event used to drive the executable state. For example, in the content of D21 as shown in FIG. 7, an “event” content can be added specify that the executable state is driven by a button (i.e., a visualization element). In addition, the driving action is triggered when the user performs an onClick on the button. After reading the content of the executable state, any management tool can dynamically add a button on the user interface according to the “event” content in the executable state, and a text prompt “callback” is displayed on the button (i.e., displayed according to the text content specified by “label”) for the user to operate. When the user clicks the button, the management tool can drive the executable state. That is, the management tool generates an execution request for the executable state. After the execution request is transmitted to a startup module, a volatile application program corresponding to the executable state is dynamically loaded to run, and the volatile application program executes the callback service.

{
“app_location”: “https://a.b.c/app”,
“state”: “account=U8796&params=...”,
“event”:
“<button><label>callback</label><submit>onClick</submit></button>”
}

In an embodiment, when the management tool generates the executable entity 20 for the call log, the executable event used to drive the executable state can be a startup event of the executable entity 20. For example, I2 in FIG. 5 is an operable entity of a call log (i.e., an operable object). The user can click the “callback” button of the operable entity to trigger an executable event to perform the callback action. The management tool can also connect the executable event for “callback” with the startup event of the operable entity. Consequently, after the user finds the call log in the list of call logs, the user can directly click the call log to drive the executable state to call back. The startup event refers to an event that is preset to be triggered by the visualization element of the executable entity 20 when the user clicks or operates the visualization element of the executable entity 20.

In an embodiment, the executable state is one of at least one executable state used to link an operation process. After an additional voice call that is called back by the volatile application program is ended, through a trigger T4, the volatile application program can store the call log and the executable state generated by the additional voice call into the storage space connected to the management module 19 again. By this method, the operation process driven and supported by the voice communication is linked through the at least one executable state and dynamically imported into the software system 131.

In an embodiment, the software system 131 is provided in the mobile phone in the form of a mobile phone operating system. In the software system 131, the startup module 15, the import module 17 and/or the management module 19 can be implemented as independent application programs. That is, the startup module 15, the import module 17 and/or the management module 19 can be different software modules. During the runt time of the software system 131, the startup module 15, the import module 17 and/or the management module 19 are executed in different OS processes.

In an embodiment, the software system 131 is provided in the operating system of the mobile phone in the form of an application program, a super application and/or a software platform. In the software system 131, the startup module 15, the import module 17 and/or the management module 19 can be implemented in the same software module. That is, the startup module 15, the import module 17 and the management module 19 can be directly integrated into the software module in the form of a software component or an executable program block. During the runt time of the software system 131, the startup module 15, the import module 17 and the management module 19 are executed in the same OS process. The software system 131 is developed according to the technical framework of a native application, which is built in the operating system by the system vendor or installed in the operating system by the callee 21. Alternatively, the software system 131 is developed according to the technical framework of a progressive Web application (i.e., an implementation example of a volatile application program), which is automatically provisioned to the operating system by the system vendor or actively installed in the operating system by the callee 21.

In an embodiment, the application program 16 for receiving the incoming call notification is a native application that is pre-installed in the software system, or the application program is a volatile application program that is pre-installed or dynamically installed in the software system in the form of an executable object, or the application program is an uninstalled volatile application program.

In an embodiment, the application program 16 used to receive the incoming call notification and the volatile application program used to call back are the same application program. Alternatively, the application program 16 used to receive the incoming call notification and the volatile application program used to call back are different application programs. After the voice call of the incoming call notification is ended, the application program used to receive the incoming call notification can designate other volatile application programs to provide callback communication services in the executable state.

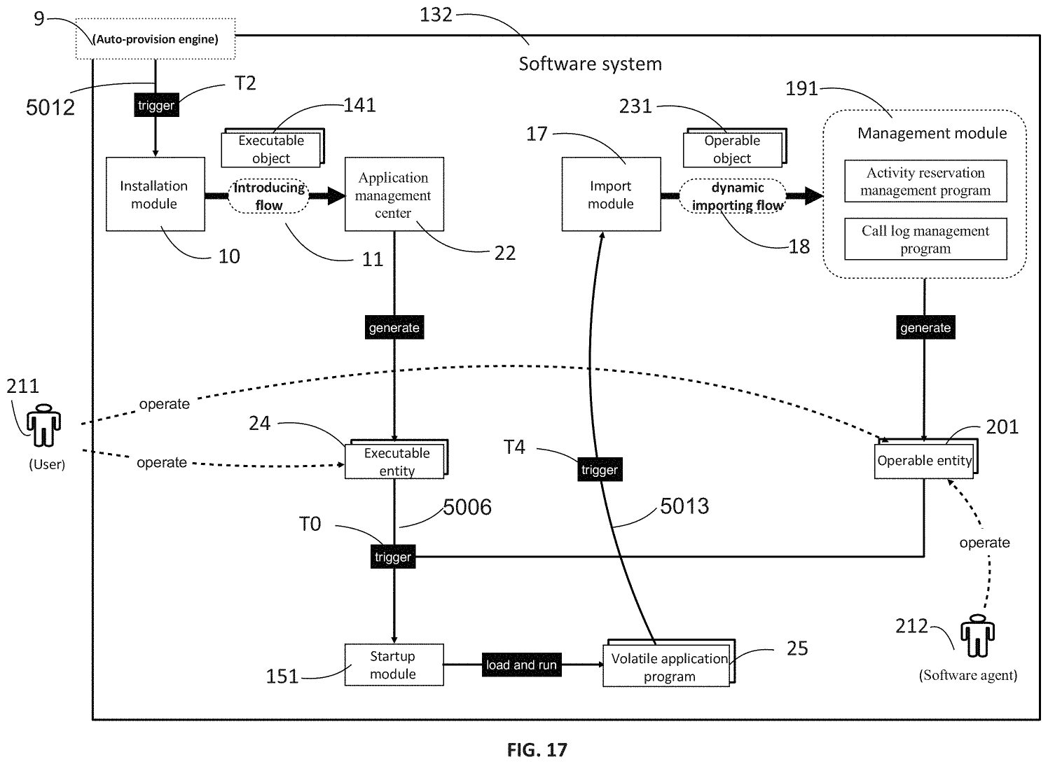

In an embodiment, the user 211 as shown in FIG. 17 is a software program. For example, if the end of the voice call of the incoming call is caused by network abnormality, after the call log is generated, a network monitoring program can be activated by the management module 19. When the network monitoring program detects that the network signal restores to normal, the network monitoring program automatically executes the executable event (i.e., callback) in the call log. Consequently, the executable state bound to the executable event is automatically driven to call back the caller of the voice call.

It is noted that the above method of dynamically importing the operation process is not limited to the operation process of the voice communication. The system vendor can provide corresponding import modules and management modules in the operating systems, super applications, and/or software platforms that provided by them according to various operable objects suitable for different application scenarios. Consequently, various operation processes can be dynamically loaded to run. Those skilled in the art can make any equal design changes based on actual application requirements after referring to the technologies of the present invention.

In accordance with another aspect of the present invention, a software system is provided. The software system uses a method of dynamically integrating application programs to allow volatile application programs from plural different information sources and operation processes supported by the volatile application programs from plural different information sources to be dynamically installed and dynamically imported in the software system. The software system comprises:

an installation module, wherein when the installation module receives a dynamic installation request from an auto-provisioning engine, an executable object for a user to execute is installed in the software system; and/or

an import module, wherein when the import module receives an executable state from an application program, an operable object bound to the executable state is stored in a management module, wherein when the executable object or the executable state is executed or triggered, a corresponding execution request is issued to a startup module, and the startup module dynamically loads and runs a corresponding volatile application program to complete the execution request.

FIG. 17 schematically illustrates an operating concept of a software system for dynamically integrating the volatile application program according to an embodiment of the present invention. The software system 132 as shown in FIG. 17 and the software system 13 as shown in FIG. 13 are the same or equal software systems. The auto-provisioning engine 9 as shown in FIG. 17 and the auto-provisioning engine 9 as shown in FIG. 12 are the same or equal auto-provisioning engines. The installation module 10 as shown in FIG. 17 and the installation module 10 as shown in FIG. 12 are the same or equal installation modules. The introducing flow 11 as shown in FIG. 17 and the introducing flow 11 as shown in FIG. 12 are the same or equal introducing flows. The import module 17 as shown in FIG. 17 and the import module 17 as shown in FIG. 16 are the same or equal import modules. The dynamic importing flow 18 as shown in FIG. 17 and the dynamic importing flow 18 as shown in FIG. 16 are the same or equal dynamic importing flows. The trigger T2 as shown in FIG. 17 and the trigger T2 as shown in FIG. 12 are the same or equal triggers. The request 5012 as shown in FIG. 17 and the request 5012 as shown in FIG. 12 are the same or equal requests. The trigger T4 as shown in FIG. 17 and the trigger T4 as shown in FIG. 16 are the same or equal triggers. The request 5013 as shown in FIG. 16 and the request 5013 as shown in FIG. 16 are the same or equal requests. The trigger T0 as shown in FIG. 17 and the trigger T0 as shown in FIG. 3 are the same or equal triggers. The request 5006 as shown in FIG. 3 and the request 5006 as shown in FIG. 3 are the same or equal requests.

In an embodiment, a system vendor of the software system 132 provides at least one installation module 10 to the software system 132. The at least one installation module 10 can receive at least one dynamic installation request from at least one auto-provisioning engine 9, complete the auto-provisioning task for the volatile application programs from different information sources, dynamically install at least one executable object 141 corresponding to the volatile application programs from different information sources in the software system 132 through the introducing flow 11, and manage the at least one executable object 141 in an application management center 22 to expand the functions of the software system 132. The different information sources refer to different servers, different computer rooms, or different network domains. The volatile application programs from the different information sources can be any client software deployed on different servers, different computer rooms, and/or in different network domains by different companies, as long as the client software itself is a volatile application program. After the client software is deployed, without any system integration with the software system 132, an executable object that can be used to drive the client software can be automatically provisioned in the software system 132 through the at least one auto-provisioning engine 9.

In an embodiment, the system vendor of the software system 132 provides at least one import module 17 and at least one management module 191 to the software system 132. The at least one import module 17 can receive at least one executable state from at least one volatile application program 25 that is dynamically loaded to run, and complete the dynamic importing task for the operation process that is driven by the at least one volatile application program 25 from different information sources. After the binding relationship between the at least one executable state and at least one operable object 231 is established, the at least one operable object 231 used to connect different operation processes is stored in the at least one management module 191 for management through the dynamic importing flow 18. By this method, different operation processes driven and supported by the volatile application programs of different information source are linked through the at least one executable state and dynamically imported into the software system.

In an embodiment, the software system 132 is an operating system, a super application, or a software platform. The application management center 22 is an APP Launcher. The at least one management module 191 may include an activity reservation management application or a call log management application.

In an embodiment, the at least one auto-provisioning engine 9 includes a network service, a detection program, an application program or a projected workspace. The network service is an external network service (e.g., the external network services 4 and 91 as shown in FIG. 13) running in a machine different from the software system 132. The detection program is a software module (e.g., the detection program 93 as shown in FIG. 13) that is executed in the software system 132. The application program is a volatile application program required to be dynamically loaded to run in the software system (e.g., the volatile application program 92 that is shown in FIG. 13 and dynamically loaded to run). The projected workspace is a projected workspace that is dynamically loaded to run in the software system (e.g., the projected workspace 94 as shown in FIG. 13).

In an embodiment, after the software system 132 is activated, the application management center 22 running in the software system 132 will read the at least one executable object 141 that is introduced in the software system 132, and instantiate the corresponding executable entity on a user interface for each executable object. Consequently, the corresponding user 211 can operate on the at least one executable entity 24 (e.g., the executable entity I1 as shown in FIG. 5) on the user interface, where the user interface is the user interface of an APP Launcher.

In an embodiment, after the at least one management module 191 is activated in the software system 132, the at least one management module 191 reads at least one operable object 231 that is imported into the at least one management module 191, and instantiates the corresponding operable entity for each operable object on an additional user interface. Consequently, the user 211 can operate at least one operable entity 201 on the additional user interface. For example, the call log management application can read at least one operable object (i.e., the call log) that is managed by it. Moreover, in the user interface of the call log management application, the corresponding operable entity (e.g., the operable entity I2 as shown in FIG. 5) for each operable object is provided.

In an embodiment, when the user 211 launches an executable entity on a user interface provided by the application management center, the software system 132 or the application program center 22 issues a trigger T0 and transmits an execution request to a startup module 151 through the trigger T0. Consequently, the startup module 151 dynamically loads and runs the volatile application program corresponding to the executable entity.

In an embodiment, when the user 211 launches an executable event of an operable object on a user interface provided by the at least one management module 191, the at least one management module 191 issues a trigger T0 and transmits an execution request to a startup module 151 through the trigger T0. Consequently, the startup module 151 dynamically loads and runs the volatile application program corresponding to the executable event.

In an embodiment, the execution request transmitted to the startup module 151 contains the original content, the partial content, the re-organized content of the metadata of the volatile application program and/or an access link for retrieving the metadata of the volatile application program. The access link and the network address for dynamically loading and running the volatile application program corresponding to the execution request are identical or different network addresses. In case that the network addresses are identical, the content of the metadata of the volatile application program can be written into the Response Headers of the network address for dynamically loading and running the volatile application program. In this way, the network address and the access link can be the identical network address. In case that the network addresses are different, the service provider of the volatile application program can register the content of the metadata in another external server. In addition, the external server provides the access link of the content of the metadata.

In an embodiment, an executable event of an operable entity is driven by a software agent 212. For example, when an operable object (e.g., an activity reservation) is stored in the activity reservation management application, the activity reservation can be set to be automatically started at a specified time, and the software agent 212 can perform a monitoring task for the operable object. When the designated time reaches, the software agent 212 automatically triggers the executable event, and dynamically loads and runs the volatile application program corresponding to the executable event in order to provide the required services for the activity reservation.

In an embodiment, while the startup module 151 dynamically loads and runs the corresponding volatile application program for an execution request, the startup module 151 transmits a state setting to the volatile application program in the form of parameters. The state setting may contain the system environment configuration of the computing device that executes the software system 132 (e.g., the associated hardware information of the computing device), the application configuration required for executing the volatile application program (e.g., the account information of the user 211) or the application state (e.g., the default state when the volatile application program is executed). Consequently, during the runt time, the volatile application program can adjust the internal application state according to the state setting. In a preferred embodiment, the account information for executing the volatile application program can be acquired from the system environment configuration of the software system 132. In the dynamic loading process, the startup module 151 issues a request to the software system 132 to acquire an account information that is enabled, registered or bound in the software system 132. In addition, the account information is used as the application configuration for executing the volatile application program. Consequently, the single sign-on function can be achieved.

In an embodiment, the at least one installation module 10 can be the same installation module. The same installation module dynamically installs different types of volatile application programs (e.g., the Web front-end application, the progressive web application, or the instant application). Alternatively, the at least one installation module 10 is a set of plural installation modules for dynamically installing different types of volatile application programs.

In an embodiment, the at least one installation module 10 can be the same installation module. That is, the same installation module receives dynamic installation requests from different sources and installs and introduces the executable objects in the software system 132 for different types of volatile application programs (e.g., the Web front-end application, the progressive web application, or the instant application) according to the contents of the dynamic installation requests. Alternatively, the at least one installation module 10 may be a set. Different types of volatile application programs can be installed and introduced by different installation modules. The set is a set of plural installation modules that are provided for different types of volatile application programs.

In an embodiment, the at least one startup module 151 is the same startup module. That is, the same startup module receives the executable requests that are triggered by different executable objects and operable objects and dynamically load and run different types of volatile application programs according to the contents of the executable requests. Alternatively, the at least one startup module 151 is a set, i.e., the set of startup modules for dynamically loading and running different types of volatile application programs.

In an embodiment, the at least one startup module 151 is provided to the software module 132 in the form of at least one software module. Alternatively, the at least one startup module 151 is integrated to the at least one executable object 141. The method of integrating the startup module with the executable object is identical or equal to the examples of FIG. 4, 8, 9 and associated embodiments, and not redundantly described herein.

In an embodiment, the at least one import module 17 is the same import module. That is, the same import module receives the executable states from different source and imports the executable states into different management modules. Alternatively, the at least one import module 17 is a set of plural import modules for importing different types of operable objects.

In accordance with another aspect of the present invention, a machine for dynamically integrating application programs is provided. The machine comprises:

an auto-provisioning engine for detecting at least one connected device in a network, and allowing at least one executable object corresponding to the at least one connected device to be deployed to a software system, wherein the software system displays the at least one executable object on a user interface for the user to operate, wherein when the user launches an executable object corresponding to a connected device on the user interface, a volatile application program bound to the executable object is dynamically loaded to run, and services provided by the connected device are managed, operated, monitored and/or controlled by the volatile application program; and/or

an import module for receiving an executable state from an application program, and allowing an operable object bound to the executable state to be stored in a management module, wherein the import module is provided to dynamically import an operation process for at least one application program.

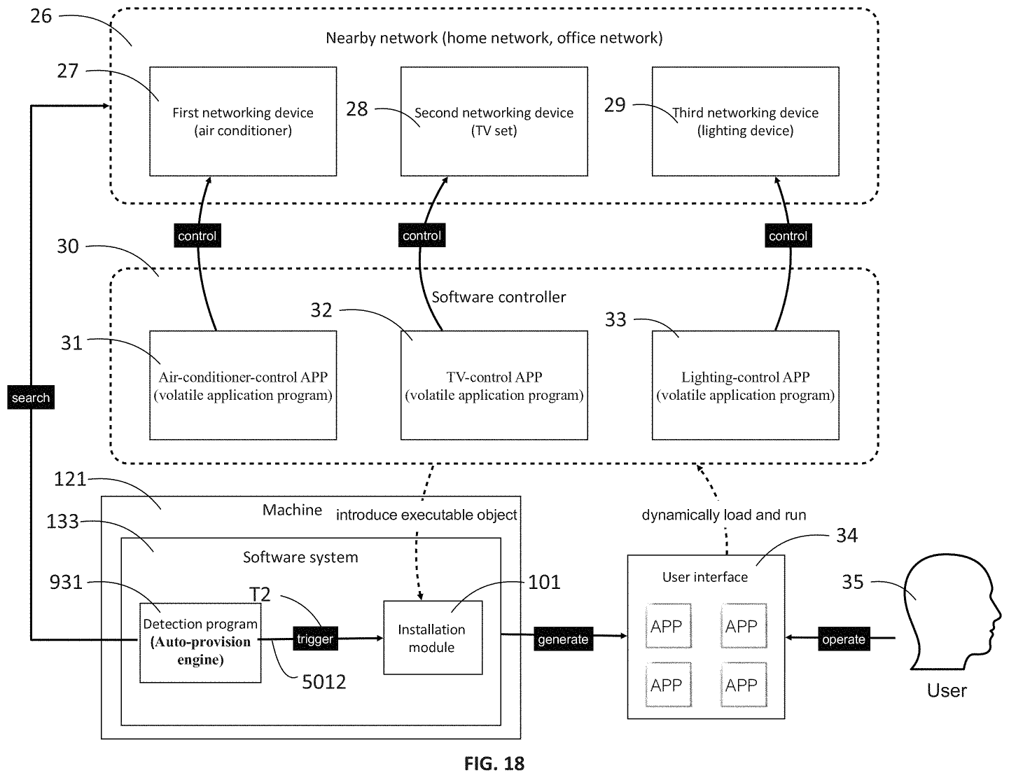

FIG. 18 schematically illustrates the operating concept of a machine for dynamically integrating the software controllers of different connected devices according to an embodiment of the present invention. In FIG. 18, the software controllers 30 include an air-conditioning control APP, a TV-control APP and a lighting-control APP. The software controllers 30 are application programs that are developed and deployed in the form of the “volatile application program” of the present invention. The implementation examples of the “volatile application program” may be referred to the above embodiments of the present invention. The detection program 931 as shown in FIG. 18 and the detection program 93 as shown in FIG. 13 are the same or identical detection programs. The trigger T2 as shown in FIG. 18 and the trigger T2 as shown in FIG. 12 are the same or identical triggers. The request 5012 as shown in FIG. 18 and the request 5012 as shown in FIG. 12 are the same or identical requests. The installation module 101 as shown in FIG. 18 and the installation module 10 as shown in FIG. 13 are the same or identical installation modules. The software system 133 as shown in FIG. 18 and the software system 133 as shown in FIG. 13 are the same or equal software systems. The machine 121 as shown in FIG. 18 and the user machine 12 as shown in FIG. 13 are the same or identical machines.

In an embodiment, the machine 121 and/or the software system 133 are used to build an IoT control center.

In an embodiment, the software system 133 is an operating system of the machine 121, or the software system 133 is an application program running in the operating system of the machine 121.

In an embodiment, the network 26 is a home network, an office network, an enterprise network, a cloud network, and/or any type of network that can be used to connect connected devices.

In an embodiment, the first connected device 27 is an air-conditioner with the networking capabilities, the second connected device 28 is a television with the networking capabilities, and the third connected device 29 is a lighting device with the networking capabilities. The air-conditioner 27, the television 28 and the lighting device 29 are all IoT devices in the network 26. It is noted that the connected devices as shown in FIG. 18 are non-limiting examples. Any software appliance, communication device and/or IoT device with the networking capabilities may be used as the connected device of the present invention.

In an embodiment, the detection program 931 is an auto-provisioning engine. The detection program 931 and the installation module 101 in the software system 133 are provided by the same software module. That is, the detection program 931 and the installation module 101 are integrated into an executable program block of the same software module. Alternatively, the detection program 931 and the installation module 101 in the software system 133 are provided by different software modules.

In an embodiment. during the runt time, the detection program 931 can detect the connected devices in the network 26 through different methods. For example, the detection program 931 can periodically (e.g., once a minute) send a multicast packet to a multicast address in the network 26. The content of the multicast packet is a search request generated according to a standard protocol. The search request is used to allow the connected devices in the network 26 to know that a detection program is searching for the connected devices in the network 26. After any connected device (including the air-conditioner 27, the TV set 28 and the lighting device 29) in the network 26 is enabled, the connected device can monitor the multicast packet that is sent to the multicast address in the network 26. When a connected device receives the search request from the detection program 931, the metadata of the connected device itself and the metadata of a software controller for managing, operating, monitoring and/or controlling the connected device can be encapsulated to an additional multicast packet by the connected device. Then, the additional multicast packet is sent to the multicast address in the network 26. By using this method, the detection program 931 can also monitor the additional multicast packet from the multicast address and read the contents of the metadata of the connected device and the metadata of the software controller. The software controller is a volatile application program that is used to manage, operate, monitor and/or control the service of the connected device. The multicast technologies can be referred to the websites at “https://en.wikipedia.org/wiki/Multicast” and “https://en.wikipedia.org/wiki/Multicast_address”. In an embodiment, the examples of searching the nearby connected devices by the detection program 931 through the multicast technologies are non-limiting examples. The communication technologies including Bluetooth, infrared, Ethernet, WiFi and 4G/5G communication technologies are well-established and popular technologies that can be used to detect, search and/or query the public networks and/or the nearby connected devices. In various network types, the methods of detecting, searching and/or querying the devices between the same or different networks through different communication protocols and/or the combination thereof and performing the data transmission connection on these devices are not restricted. Those skilled in the art can make any equal design changes based on actual application requirements after referring to the technologies of the present invention.

In an embodiment, after the detection program 931 receives the metadata of a connected device and the metadata of the software controller thereof, these metadata are encapsulated as a dynamic installation request. In addition, the dynamic installation request is transmitted to an installation module 101 through a trigger T2. According to the content of the dynamic installation request, the installation module installs an executable object to the software system 133. The detection program 931 and the installation module 101 can be implemented in the same software module and executed in the same OS process. Alternatively, the detection program 931 and the installation module 101 can be implemented in different software modules and executed in different OS processes. The implementation methods of generating a dynamic installation request for a volatile application program through an auto-provisioning engine and the implementation methods of binding the executable object of a volatile application program to a software system are the same or equal to the methods of FIGS. 11, 12 and 13 and various embodiments of the present invention, and not redundantly described herein.

In an embodiment, the content bound to the executable object contains the original content, the partial content and the re-organized content of the metadata of the software controller, and/or an access link that is used to obtain the metadata of the software controller. The access link and the network address for dynamically loading and running the software controller are identical or different network addresses. In case that the network addresses are identical, the content of the metadata of the software controller can be written into the Response Headers of the network address for dynamically loading and running the software controller. In this way, the network address and the access link can be the identical network address. In case that the network addresses are different, the service provider of the software controller can register the content of the metadata in another external server. In addition, the external server provides the access link of the content of the metadata.

In an embodiment, the software system 133 generates a user interface 34 (e.g., an APP Launcher). After the software system 133 generates a corresponding executable entity for each executable object that is installed in the software system 133, these executable entities are displayed on the user interface 34 for a user 35 to operate. When the user 35 clicks an executable entity on the user interface 34, the software controller (i.e., a volatile application program) corresponding to the executable entity is dynamically loaded to run on the user interface of the software system. Consequently, through the software controller, the user 35 can manage, operate, monitor and/or control the connected device corresponding to the software controller. The implementation methods of dynamically loading and running a volatile application program by driving an executable entity are the same or equal to the methods of FIGS. 3, 4 and 5 and various embodiments of the present invention, and not redundantly described herein.

In an embodiment, there is a binding relationship between a connected device, a software controller of the connected device and an executable object of the software controller. The binding relationship is established by binding at least one content of the metadata of the software controller and the connected device to the executable object. For example, when an executable object of the air-conditioner-control APP 31 is generated, the metadata of the air-conditioner 27 and the metadata of the air-conditioner-control APP 31 are written into the App configuration content of the executable object. Consequently, the binding relationship of the air-conditioner 27, the air-conditioner-control APP 31 and the executable object is established. The method of generating the executable object for the air-conditioner-control APP 31 according to the content of the metadata can be referred to FIG. 9 and associated embodiments. It is noted that the method of generating the executable object for the air-conditioner-control APP 31 according to the content of the metadata is not restricted and can be modified according to the practical requirements. The method of generating the executable object and binding the volatile application program to the executable object can be directly imported into the detection program 931 or the installation module 101 for execution. After the method is imported, the executable objects of various connected devices can be dynamically generated by the detection program 931 or the installation module 101 during the runt time. The at least one content of the metadata of the air-conditioner 27 (i.e., a connected device) contains a product name, a product model, a brand name, a domain name of the air-conditioner 27 and/or an IP address of the air-conditioner 27. The at least one content of the metadata of the air-conditioner-control APP 31 contains the APP name of the air-conditioner-control APP 31, the APP function description, the location of the startup program of the air-conditioner control APP 31, the domain name of the air-conditioner control APP 31 and/or the provider information. The corresponding executable objects for other types of connected devices can be dynamically generated during the runt time through the similar methods as mentioned above.

In an embodiment, the executable object can also be pre-provided by the provider of the connected device and pre-published on the network. Consequently, after receiving a dynamic installation request, the detection program 931 or the installation module 101 can download the executable object according to the content of the dynamic installation request. For example, an access link of the executable object is filled into the dynamic installation request, and the executable object is downloaded through the access link.

In an embodiment, the software controller (including the air-conditioner control APP 31, the TV-control APP 32 and the lighting-control APP 33) in the software system 133 is dynamically loaded to run by the drive of a startup module. When the software controller is dynamically loaded to run, the identity data of the user 35 that is used to login the software system 133 is transmitted from the startup module to the software controller in the form of parameters. During the runt time, the software controller identifies (locates) the access authority of the user 35 to the connected device corresponding to the software controller via the identity data. The identity data is a state setting of the software controller. During the runt time, the software controller can adjust the internal application state according to the state setting. Consequently, the access authority of the user 35 can be configured during the runt time of the software controller. In this way, state settings including a system environment configuration, an application configuration and/or an application state can be transmitted from the startup module to the software controller (i.e., a volatile application program). The implementation method of transmitting a state setting to a volatile application program is the same or equal to FIGS. 6, 7 and 8 and associated embodiments.

In an embodiment, the machine 121 is a user device used by the user 35, and the software system 133 runs on the user device. After the detection program 931 detects the connected devices in the network 26 on the user device, the detection program 931 can master the relevant information of each connected device in the network 26. In addition to the IP address of these connected devices to connect to networks and the content of the metadata of software controller (i.e., the volatile application program) to control the connected devices, the relevant information contains a brand of the connected device, a model number of the connected device, and/or any appropriate information. The detection program 931 can also search the public networks to grasp the relevant information of each connected device deployed in the cloud and the software services provided by each connected device. The relevant information contains the service name of the software services, the domain name and the content of the metadata of the software controller for operating these software services. The detection results of the detection program 931 can be collected into a list including at least one connected device and at least one software controller. Then, the detection program 931 can automatically provision the corresponding executable objects to the software system 133 for the software controllers required by each connected device according to the content of the list.

In a preferred embodiment, the detection program 931 can immediately issue a dynamic installation request for the software controller of the at least one connected device when acquiring the list of the at least one connected device. Alternatively, after the detection program 931 acquires the list of the at least one connected device, at least one attribute of the at least one connected device (e.g., the at least one attribute is obtained from the content of its metadata) is displayed on the user interface for the user to select or for the user to decide whether to perform dynamic installation. Then, according to the user's operation instruction, a corresponding dynamic installation request is issued for the software controller of at least one connected device required by the user.

In an embodiment, after a software controller of the connected device is dynamically loaded to run in the user device, at least one control instruction of the software controller for the connected device is directly transmitted from the user device to the connected device. When the executable object corresponding to the connected device is automatically provisioned to the software system 133, the metadata of the connected device and its corresponding software controller can be written into the App configuration content of the executable object during the dynamic installation process. Consequently, when the executable object is driven, the executable object will further cause the software controller to be dynamically loaded to run. When the software controller is dynamically loaded to run, the metadata of the connected device written in the App configuration content of the executable object can also be transferred to the software controller through the method of the state setting. That is, after the software controller is dynamically loaded to run, the software controller can directly confirm the product model of the connected device, its own IP address and related information during the runt time. The software controller can connect to the connected device on the user device according to the communication protocol supported by the connected device. In addition, the software controller issues at least one control instruction to the IoT device through the connection to manage, operate and control the connected device and/or obtain the data of the connected device for monitoring purposes.

In another embodiment, the machine 121 is a server, and the software system 133 runs on a user device. The software system 133 can be regarded as a client software with the ability to send instructions or requests to the server 121. The software system 133 can be installed, introduced and/or deployed in the user device, the server 121 or another server. The software system 133 is a Web front-end application and/or a progressive web application, which is dynamically loaded to run on the user device through a software engine (e.g., an HTML/CSS/Javascript software engine). Alternatively, the software system 133 is an operating system installed in the user device. Alternatively, the software system 133 is a native application that is installed and/or introduced into the user device.

In an embodiment, when the software system 133 is dynamically loaded to run on the user device, the interaction between the software system 133 and the server 121 can be completed through software system 133 itself and/or at least one software module (e.g., a front-end system of the detection program 931) of the software system 133. The software system 133 and/or the at least one software module provides a user interface. The user interface can guide the user 35 to enter the relevant network information of the server 121 (e.g., the IP address of the server 131), so that the software system 133 and/or the at least one software module can grasp the location of the server 131 and correctly connect to the server 121 accordingly. Consequently, the software system 133 and/or the at least one software module can issue instructions or requests to the server 121.

In an embodiment, the software system 133 running on the user device can send a search request to the back-end system of the detection program 931 in the server 121 through the software system 133 and/or the at least one software module, and the back-end system running on the server 121 can search for at least one connected device in the public networks and/or the nearby networks. After the search is finished, the server 121 organizes the search results into a list and sends the list back to the software system 133 and/or the at least one software module. After obtaining the list of the at least one connected device through the search request, the software system 133 and/or the at least one software module can issue at least one corresponding dynamic installation request according to the content of the list. In addition, the at least one software controller corresponding to the at least one connected device is dynamically installed in operating environment of the software system 133.

In an embodiment, the content of the list contains the metadata of the at least one connected device and the corresponding at least one software controller, and the at least one executable object is generated according to the content of the list.

In a preferred embodiment, the software system 133 itself and/or the at least one software module of the software system can immediately issue a dynamic installation request for the software controller of the at least one connected device when acquiring the list of the at least one connected device. Alternatively, after the software system 133 itself and/or the at least one software module of the software system acquires the list of the at least one connected device, at least one attribute of the at least one connected device (e.g., the at least one attribute is obtained from the content of its metadata) is displayed on the user interface for the user to select or for the user to decide whether to perform dynamic installation. Then, according to the user's operation instruction, a corresponding dynamic installation request is issued for the software controller of at least one connected device required by the user.

In an embodiment, the software system 133 itself and/or the at least one software module of the software system obtains a system environment configuration from the server 121, and the content of the system environment configuration contains the domain name and IP address of the server 121 on the intranet and/or extranet.

In an embodiment, after the software controller is dynamically loaded to run in the user device, at least one control instruction for the at least one connected device is transmitted to the server 121 and then the at least one control instruction is forwarded by the server 121 to the at least one connected device according to a communication protocol compatible with the at least one connected device, or the at least one control instruction is directly transmitted from the user device to the at least one connected device. For example, the user device and the at least one connected device are in the same intranet. Generally, the software controller executed in the user device can be connected with the connected device according to the IP address (i.e., the intranet address) in the metadata of the connected device. However, if the user device and the at least one connected device are not in the same intranet, the server 121 can be used as a proxy server. That is, the software controller is connected to the server 121 according to the extranet IP address of the server 121. After the at least one control instruction is transmitted to the server 121, the at least one control instruction is forwarded to the at least one connected device by the server 121.

In an embodiment, the installation module 101 in the software system 133 can receive dynamic installation requests from different machines. The dynamic installation requests for different machines are issued by at least one auto-provisioning engine. The auto-provisioning engine is a network service, a detection program, an application program that is dynamically loaded to run, or a projected workspace. Various implementation examples of the auto-provisioning engine are the same as or equal to the embodiment of FIG. 16 and the related embodiments of the present invention, and not redundantly described herein.

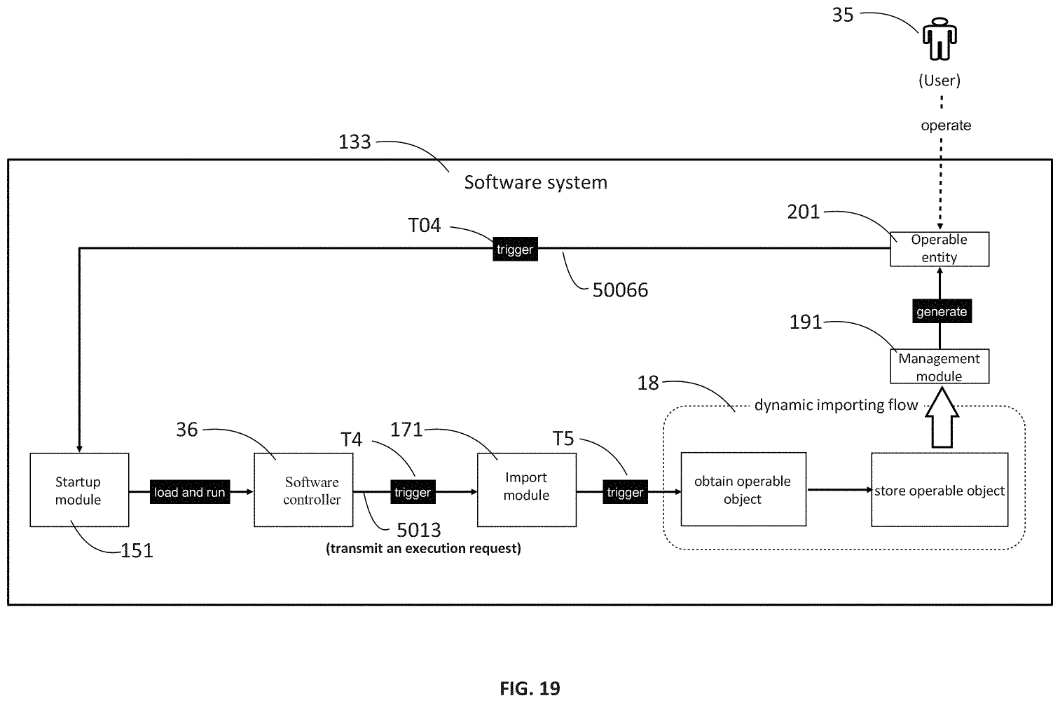

FIG. 19 schematically illustrates the operating concept of the path of dynamically importing an executable state of a connected device according to an embodiment of the present invention. The software system 133 as shown in FIG. 19 and the software system 133 as shown in FIG. 18 are the same or equal software systems. The trigger T04 as shown in FIG. 19 and the trigger T0 as shown in FIG. 3 are the same or equal triggers. The user 35 as shown in FIG. 19 and the user 35 as shown in FIG. 18 are the same or equal users. The startup module 151 as shown in FIG. 19 and the startup module 151 as shown in FIG. 17 are the same or equal execution modules. The trigger T4 as shown in FIG. 19 and the trigger T4 as shown in FIG. 16 are the same or equal triggers. The request 5013 as shown in FIG. 19 and the request as shown in FIG. 16 are the same or equal requests. The import module 171 as shown in FIG. 19 and the import module 17 as shown in FIG. 16 are the same or equal import modules. The trigger T5 as shown in FIG. 19 and the trigger T5 as shown in FIG. 16 are the same or equal triggers. The dynamic importing flow 18 as shown in FIG. 19 and the dynamic importing flow 18 as shown in FIG. 16 are the same or equal dynamic import processes. The management module 191 as shown in FIG. 19 and the management module 191 as shown in FIG. 17 are the same or equal management modules. The operable entity 201 as shown in FIG. 19 and the operable entity 201 as shown in FIG. 17 are the same or equal operable entities.

In an embodiment, an import module 171 is provided in the software system 133. The import module 171 is used to receive the executable state that is issued by a software controller 36 during the runt time. When the import module 171 receives the executable state, the import module 171 is triggered to start the dynamic importing flow 18. During the operation of the dynamic importing flow 18, an operable object for the user 35 to operate is stored in a management module 191, and a binding relationship between the executable state and an executable event of the operable object is established. The implementation methods of dynamically importing the executable state of the software controller 36 through the import module 171 and the operation process connected to it are the same as or equal to the related embodiment of FIG. 16, and not redundantly described herein. The software controller 36 is a volatile application program.

In an embodiment, the software program 133 runs on a mobile phone (i.e., a user device), and the management module 191 comprises a call log management application. When the user 35 launches a software controller 36 for controlling a VoIP Desk Phone on the mobile phone and uses the software controller 36 to complete an network voice dialing action, an executable state provided by the software controller 36 for callback can be transmitted to the import module 171 through a trigger T4 after the software controller 36 ends the call. When the import module 171 receives the executable state, a dynamic importing flow 18 is triggered to start. During the operation of the dynamic importing flow 18, a call log (i.e., an operable object) for the user 35 to operate is stored in the call log management application. When the user 35 operates the call log and clicks the “callback” button, the executable state bound to the call log is encapsulated into an execution request, and the execution request is transmitted to the startup module 151 through a trigger T04. The startup module 151 can dynamically load and run the software controller 36 according to the content of the execution request. In addition, the “callback” task is completed by controlling the VoIP Desk Phone through the software controller 36.

From the above descriptions, the present invention is related to a method for dynamically integrating volatile application programs and a software system and a machine using the method. The method, the software system and the machine have the following advantages:

Firstly, when compared with the existing technologies, the auto-provisioning engine can quickly introduce the volatile application program to all associated user machines in the form of an executable object after it is deployed on the back-end server. Consequently, the service providers can gain autonomous control over the release of volatile application programs and their auto-provisioning tasks from back-end server.

Secondly, when compared with the existing technologies, the technical method of the executable state can be used to dynamically import the operation flows of various applications into an operating system and/or a software platform and allow the operating system and/or the software platform to be used as a driving environment of an application state engine.

Thirdly, by using the technical method of the present invention, any software system and/or machine can dynamically install volatile application programs from different sources and importing the operation process of any volatile application program into the software system and/or machine without the need of pre-installing or importing any volatile application program. Consequently, a super app and/or an operating environment of the Internet of Things control center is generated.

Fourthly, by using the technical method of the present invention, the software system, the installation module, the import module, the management module, the startup module and/or the auto-provisioning engine mentioned in the present invention can also be implemented with the volatile application programs. That is, the software system itself is a volatile application program that is dynamically loaded to run on a user's machine. Whereas, the installation module, the import module, the management module, the startup module and/or the auto-provisioning engine is another volatile application program managed and/or driven by the operating interface of the software system after the software system is dynamically loaded to run. Due to this specific design framework, the software system and its related software module can be deployed, managed and published on an external server, and its overall operating environment is dynamically loaded to run on the user's machine. That is, the system providers will be able to use commercial software appliances and/or software-as-a-service service models to provide users with required operating systems, super apps and/or operating environments IoT control centers.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A method for dynamically integrating application programs, the method comprising steps of:
providing an installation module in a software system, and starting an introducing flow when the installation module receives a dynamic installation request from an auto-provisioning engine, wherein during an operation of the introducing flow, an executable object for a user to execute is installed in the software system, wherein there is a binding relationship between the executable object and the volatile application program, and the binding relationship is established by binding a metadata of the volatile application program and/or an access link of the metadata to the executable object; and
dynamically loading and running the volatile application program in the software system when the software system receives an execution request for the executable object from the user, wherein a location of a startup program of the volatile application program is identified according to at least one content of the metadata.

2. The method according to claim 1, wherein the volatile application program is a Web system, a native application or any software service that can be dynamically loaded to run, wherein a dynamic loading and running operation of the volatile application program is completed by dynamically loading and running a startup program of the volatile application program.

3. The method according to claim 1, wherein the at least one content of the metadata of the volatile application program contains a network address and a content of the network address contains the location of the startup program of the volatile application program, and/or the at least one content of the metadata of the volatile application program contains at least one code that is used to identify the location of the startup program of the volatile application program.

4. The method according to claim 1, wherein a content of the dynamic installation request contains the executable object, an access link of the executable object, the metadata and/or the access link of the metadata, wherein the access link of the executable object and the access link of the metadata are in a form of a uniform resource identifier or an application programming interface.

5. The method according to claim 4, wherein the executable object is a pre-generated executable object, or the executable object is an executable object dynamically generated during a run time of the software system and the installation module.

6. The method according to claim 1, wherein the dynamic installation request is issued by the auto-provisioning engine to drive the installation module to complete an auto-provision task for the volatile application program, wherein the auto-provisioning engine is a network service, a detection program, an application program, or a projected workspace, wherein the network service is an external network service running on a different machine from the software system, the detection program is a software module executed in the software system, the application program is a volatile application program required to be dynamically loaded to run in the software system, and the projected workspace is a projectable workspace that is dynamically loaded to run in the software system.

7. The method according to claim 1, wherein a bound content related to the executable object contains an original content of the metadata, a partial content of the metadata or a content that is obtained after the original content of the metadata is rearranged, wherein the binding relationship is established by binding the bound content and/or an access link of the bound content to the executable object, wherein in the binding relationship, the bound content represents a data reference of the metadata.

8. The method according to claim 7, wherein the executable object is generated according to a data model of an application program unit, wherein after the executable object is installed in the software system, the executable object becomes an executable entity compatible with the software system, wherein during a runt time of the software system, the executable entity is displayed on a user interface for the user to launch, wherein when the user launches the executable entity, the execution request is triggered, so that the volatile application program corresponding to the executable entity is dynamically loaded to run.

9. The method according to claim 8, wherein a content of the execution request contains the bound content and/or the access link of the bound content, and the volatile application program is dynamically loaded to run through a startup module according to the content of the execution request, wherein the startup module is an independently running application program or a software component that can dynamically load and run a heterogeneous system.

10. The method according to claim 9, wherein if the volatile application program is incompatible with an operating environment of the software system, the volatile application program is driven by an adapter, and the adapter provides an interface implementation compatible with the operating environment of the software system, wherein the adapter is provided by the executable object, the startup module, the software system and/or another software module that is triggered and executed by the startup module.

11. The method according to claim 1, wherein when the volatile application program is dynamically loaded to run, a state setting is transmitted to the volatile application program in a form of a parameter, and the volatile application program adjusts an internal application state according to the state setting during a run time, wherein the state setting is a system environment configuration, an application configuration and/or a customized application state.

12. A method for dynamically integrating application programs, the method comprising steps of:
(a) providing a startup module in a software system, and executing an application program according to a content of an execution request when the startup module receives the execution request, wherein the application program is a native application installed in the software system, or the application program is a volatile application program required to be dynamically loaded to run;
(b) providing an import module in the software system, and starting a dynamic importing flow when the import module receives an executable state from the application program, wherein during an operation of the dynamic importing flow, an operable object for a user to operate is stored in a management module, and a binding relationship between the executable state and an executable event of the operable object is established; and
(c) when the executable event is triggered by the user, an additional execution request for executing the executable state is issued, and a corresponding volatile application program is dynamically loaded to run, so that the executable state is executed by the corresponding volatile application program.

13. The method according to claim 12, wherein if the application program is a volatile application program, at least one content of a metadata of the volatile application program contains a network address and a content of the network address contains a location of a startup program of the volatile application program, and/or the at least one content of the metadata of the volatile application program contains at least one code that is used to identify the location of the startup program of the volatile application program.

14. The method according to claim 12, wherein if the execution request is issued when an executable object is launched, the application program is a volatile application program, wherein the executable object is generated according to a data model of an application program unit, wherein during a runt time of the software system, the executable object is in a form of an executable entity that is displayed on a user interface for the user to launch, wherein when the user launches the executable entity, an execution request is triggered, so that the volatile application program corresponding to the executable entity is dynamically loaded to run.

15. The method according to claim 12, wherein if the execution request is issued when an executable state is execution, the application program is a volatile application program, wherein a content of the execution request is generated according to a content of the executable state, and the content of the executable state contains a bound content and/or an access link of the bound content, wherein the bound content contains an original content of a metadata of the volatile application program, a partial content of the metadata or a content that is obtained after the original content of the metadata is rearranged, wherein the startup module identifies a location of the startup program of the volatile application program according to the content of the execution request and dynamically loads and runs the volatile application program according to the location of the startup program.

16. The method according to claim 12, wherein the operable object is generated according to a data model of an information unit, wherein after the operable object is stored in the management module, the operable object becomes an operable entity that is compatible with the software system or at least one software module in the software system, wherein during a run time of the software system or the at least one software module, the operable entity is displayed on a user interface for the user to operate, wherein when the user triggers the executable event that is bound to the executable state, the corresponding volatile application program is dynamically loaded to run, wherein the import module dynamically imports the operation process by importing at least one executable state.

17. The method according to claim 16, wherein the binding relationship between the executable state and the executable event is established by binding at least one content of the executable state to the operable object or executable event, wherein when the executable event is triggered, the additional execution request is issued according to the content of the executable state, so that the corresponding volatile application program is dynamically loaded to execute the executable state, wherein the executable event is dynamically added to the operable entity according to at least one information of the executable state.

18. The method according to claim 12, wherein when the corresponding volatile application program is dynamically loaded to run, a state setting is transmitted to the corresponding volatile application program in a form of a parameter, and the corresponding volatile application program adjusts an internal application state according to the state setting during the run time, wherein the state setting is a system environment configuration, an application configuration and/or a customized application state.

19. A software system for dynamically integrating application programs, the software system comprising:
an installation module, wherein when the installation module receives a dynamic installation request from an auto-provisioning engine, an executable object is installed in the software system; and/or
an import module, wherein when the import module receives an executable state from an application program, an operable object bound to the executable state is stored in a management module,
wherein when the executable object or the executable state is executed or triggered, a corresponding execution request is issued to a startup module, and the startup module dynamically loads and runs a corresponding volatile application program to complete the execution request.

20. The software system according to claim 19, wherein volatile application programs from plural different information sources are dynamically installed in the software system through the installation module, wherein the volatile application programs are dynamically installed through at least one executable object, and the at least one executable object is installed and launched by performing the method according to claim 1.

21. The software system according to claim 19, wherein different operation processes supported by at least one volatile application program are dynamically imported into the software system through the import module, wherein the different operation processes are dynamically imported through a process of importing at least one executable state, and the at least one executable state is imported and executed by performing the method according to claim 12.

22. A machine for dynamically integrating application programs, the machine comprising:
an auto-provisioning engine for detecting at least one connected device in a network, and allowing at least one executable object corresponding to the at least one connected device to be deployed to a software system, wherein the software system displays the at least one executable object on a user interface for the user to operate, wherein when the user launches an executable object corresponding to a connected device on the user interface, a volatile application program bound to the executable object is dynamically loaded to run, and services provided by the connected device are managed, operated, monitored and/or controlled by the volatile application program; and/or
an import module for receiving an executable state from an application program, and allowing an operable object bound to the executable state to be stored in a management module, wherein an operation process supported by at least one application program is dynamically imported into the software system through the import module.

23. The machine according to claim 22, wherein the connected device is an Internet of Things (IoT) device, a commercial software application and/or any hardware appliance or software appliance with capabilities of providing information services.

24. The machine according to claim 22, wherein there is a binding relationship between the connected device and the executable object, and the binding relationship is established by binding at least one content of a metadata of the connected device to the executable object, wherein the at least one content of the metadata of the connected device contains a product name, a brand name, a domain name and/or an IP address of the connected device.

25. The machine according to claim 22, wherein there is a binding relationship between the volatile application program and the executable object, and the binding relationship is established by binding at least one content of a metadata of the volatile application program to the executable object, wherein the at least one content of the metadata of the volatile application program contains an APP name, an APP icon, a function description, a location of the startup program, a domain name and/or a provider information of the volatile application program.

26. The machine according to claim 22, wherein the volatile application program is a software controller in the connected device, and the volatile application program is dynamically installed through a process of installing the executable object, wherein the executable object is installed and launched by performing the method according to claim 1.

27. The machine according to claim 22, wherein the operation process is dynamically imported through a process of importing at least one executable state, and the at least one executable state is imported and executed by performing the method according to claim 12.

28. The machine according to claim 22, wherein the machine is a user device, and the software system runs on the user device.

29. The machine according to claim 28, wherein the volatile application program is a software controller in the connected device, wherein after the software controller is dynamically loaded to run in the user device, at least one control instruction of the software controller for the connected device is directly transmitted from the user device to the connected device.

30. The machine according to claim 22, wherein the machine is a server, the software system runs on a user device, and the software system has ability to connect to the server and send instructions or requests to the server.

31. The machine according to claim 30, wherein the volatile application program is a software controller in the connected device, wherein after the software controller is dynamically loaded to run in the user device, at least one control instruction for the connected device is transmitted to the server and then the at least one control instruction is forwarded by the server to the connected device according to a communication protocol compatible with the connected device, or the at least one control instruction is directly transmitted from the user device to the connected device.
